(19) United States
(12) Patent Application Publication
(10) Pub. No.: US 2026/0289145 A1
(43) Pub. Date: Sep. 24, 2026

(54) SYSTEM

(71) Applicant: SoftBank Group Corp., Tokyo (JP)

(72) Inventor: Koji KURONUMA, Tokyo (JP)

(73) Assignee: SoftBank Group Corp., Tokyo (JP)

(21) Appl. No.: 19/567,064

(22) Filed: Mar. 14, 2026

(30) Foreign Application Priority Data
Mar. 19, 2025 (JP) 2025-045236

(51) Int. Cl. G06F 40/35; G06F 40/284; G06F 40/40; G06N 3/08; G06T 13/20; G06T 13/40; G06V 40/16; G10L 13/027; G10L 13/06; G10L 13/08; G10L 15/04; G10L 15/06; G10L 21/028; G10L 25/24; G10L 25/57; H04L 9/40

(52) U.S. Cl. CPC G06F 40/35; G06F 40/284; G06F 40/40; G06N 3/08; G06T 13/205; G06T 13/40; G06V 40/171; G06V 40/174; G10L 13/027; G10L 13/06; G10L 13/08; G10L 15/04; G10L 15/063; G10L 21/028; G10L 25/24; G10L 25/57; H04L 63/0428

(57) ABSTRACT

A system includes a processor configured to: construct, within an internal environment, a generative artificial intelligence environment including at least one generative AI model; input to the generative AI model a prompt for instructing generation of personal information based on stored personal information; obtain generated personal information output from the generative AI model in response to the prompt and utilize the generated personal information; analyze, by use of a voice synthesis technology, voice data of a deceased person included in video data; generate, based on a result of the analysis of the voice data, a prompt for instructing reproduction of a voice spoken by the deceased person; reproduce, by use of a voice synthesis model and based on the prompt for instructing reproduction of the voice spoken, audio representing the voice spoken; analyze, by use of an image processing technology, image data of the deceased person.

### CROSS-REFERENCE TO RELATED APPLICATION

This application is based on and claims priority under 35 USC 119 from Japanese Patent Application No. 2025-045236 filed on Mar. 19, 2025, the disclosure of which is incorporated by reference herein.

### BACKGROUND

### Technical Field

The present disclosure relates to a system.

### Related Art

Japanese Patent Application Laid-Open (JP-A) No. 2022-180282 discloses a persona chatbot control method executed by at least one processor. The method includes steps of: receiving a user utterance, adding the user utterance to a prompt including a description of a chatbot character and an associated instruction sentence, encoding the prompt, and inputting the encoded prompt to a language model to generate a chatbot utterance responding to the user utterance.

Conventional technologies for preserving memories of deceased persons, such as still images, prerecorded videos, and stored message logs, merely allow a user to passively view or read past records, and do not enable a user to experience an interactive and dynamically generated dialogue that reflects the voice characteristics, facial expressions, and conversation patterns of the deceased person. Even when generative artificial intelligence (AI) technologies are applied, they are typically executed on external cloud environments, raising concerns regarding leakage or misuse of sensitive personal information, including voice data, image data, and conversation histories of the deceased person. Furthermore, known systems generally treat voice synthesis, image processing, and conversation generation as separate and independent functions, and therefore fail to provide an integrated experience in which a user can continuously communicate with a deceased person in a manner that realistically reproduces the deceased person's voice, facial expressions, and conversational habits within a secure internal environment. Accordingly, there is a need for a system that, within an internal generative AI environment, securely stores and utilizes personal information related to a deceased person, and cooperatively performs generation of personal information, reproduction of voice, reproduction of facial expressions, analysis and learning of conversation patterns, and generation of conversations, such that a user can interactively communicate with a realistic representation of the deceased person while ensuring that the underlying personal information is not exposed outside the internal environment.

### SUMMARY

In order to solve the above-described problems, according to one aspect of the present invention, there is provided a system comprising a processor, wherein the processor is configured to construct, within an internal environment, a generative artificial intelligence environment including at least one generative AI model, input, to the generative AI model, a prompt for instructing generation of personal information based on stored personal information, obtain generated personal information output from the generative AI model in response to the prompt, and utilize the generated personal information. The processor is further configured to analyze, by use of a voice synthesis technology, voice data of a deceased person included in video data, generate, based on a result of the analysis of the voice data, a prompt for instructing reproduction of a voice spoken by the deceased person, and reproduce, by use of a voice synthesis model and based on the prompt for instructing reproduction of the voice spoken by the deceased person, audio representing the voice spoken by the deceased person. The processor is also configured to analyze, by use of an image processing technology, image data of the deceased person, generate, based on a result of the analysis of the image data, a prompt for instructing reproduction of a facial expression of the deceased person, and reproduce, by use of an image generation or animation model and based on the prompt for instructing reproduction of the facial expression of the deceased person, the facial expression of the deceased person. In addition, the processor may be configured to analyze, by use of a generative AI technology, conversation content of the deceased person acquired from video data and from a communication application, generate, based on a result of the analysis of the conversation content, a prompt for instructing learning of conversation patterns of the deceased person, and perform, by use of the generative AI model and based on the prompt for instructing learning of the conversation patterns of the deceased person, learning of the conversation patterns of the deceased person. Further, the processor may be configured to receive, from a user, an instruction sentence serving as a prompt, input the instruction sentence as the prompt to the generative AI model, generate, based on the instruction sentence and by use of the generative AI model, a further prompt for instructing generation of a conversation with the deceased person, and generate, based on the further prompt and by use of the generative AI model, a conversation with the deceased person. By these means, the system enables, within a secure internal generative AI environment, integrated and interactive reproduction of the deceased person's voice, facial expressions, and conversation style, thereby allowing a user to continue realistic communication with the deceased person while maintaining protection of personal information.

The term “system” refers to an apparatus or arrangement including at least one processor, memory, and associated hardware and/or software components configured to execute the processing described in the claims.

The term “processor” refers to any hardware circuit, such as a central processing unit (CPU), graphics processing unit (GPU), application-specific integrated circuit (ASIC), field-programmable gate array (FPGA), or a combination thereof, that is capable of executing instructions to perform the functions described in the claims.

The term “internal environment” refers to a computing environment or network that is managed and controlled by an entity operating the system, that is isolated from external public networks such as the internet, and in which access to stored data and models is restricted to authorized components of the system.

The term “generative artificial intelligence environment” refers to a software and hardware environment constructed within the internal environment, the environment including at least one generative AI model, storage for training data and generated data, and execution resources for performing generative processing based on prompts.

The term “generative AI model” refers to a machine learning model configured to generate new data, such as text, audio, or images, in response to an input prompt, based on patterns learned from training data.

The term “personal information” refers to information associated with an identifiable person, including, but not limited to, voice data, image data, video data, conversation logs, message histories, and profile information of the person.

The term “deceased person” refers to an individual who is no longer living, whose personal information, such as voice data, image data, and conversation content, is used by the system to generate or reproduce voice, facial expressions, and conversations.

The term “prompt” refers to input data, typically including text and optionally metadata or control parameters, that is supplied to a generative AI model to instruct or condition the generative AI model to perform a specific generation, analysis, or learning task.

The term “generated personal information” refers to information output by a generative AI model in response to a prompt, the information being derived from and related to stored personal information, such as synthesized text, audio, or images characterizing a specific person.

The term “voice synthesis technology” refers to technology, including algorithms and models, that analyzes voice data and generates or reproduces speech audio, including but not limited to text-to-speech models and voice-cloning models.

The term “voice data” refers to audio data that includes spoken utterances, such as speech segments extracted from video files or audio recordings, associated with a specific person.

The term “voice synthesis model” refers to a trained model used to generate synthetic speech audio, where the synthetic speech is configured to reproduce characteristics such as timbre, pitch, and speaking style of a particular person.

The term “image processing technology” refers to technology, including algorithms and models, for analyzing, recognizing, and transforming image data, including detection of faces, extraction of features, and identification of facial expressions.

The term “image data” refers to data representing still images or frames extracted from video, including photographs and video frames in which a person appears.

The term “facial expression” refers to a visual configuration or change of a person's facial features, such as movement or position of eyes, eyebrows, mouth, and cheeks, that conveys an emotional or communicative state.

The term “image generation or animation model” refers to a model or combination of models configured to generate or modify image data, video frames, or avatar animations so as to depict a person's face or body, including facial expressions and gestures.

The term “video data” refers to time-series image data, optionally including associated audio tracks, in which a person appears and may speak or display facial expressions.

The term “communication application” refers to a software application or service used for exchanging messages between users, including but not limited to messaging apps, chat services, and similar communication platforms.

The term “conversation content” refers to textual or transcribed utterances exchanged between participants, including messages, chat logs, and transcripts of spoken dialogue, that represent what was said by a user or a deceased person.

The term “conversation patterns” refers to characteristic features of how a person converses, including frequently used phrases, typical ways of responding, preferred topics, wording style, and habitual expressions learned from conversation content.

The term “learning of conversation patterns” refers to a process in which a generative AI model analyzes conversation content and adjusts its internal parameters so as to reproduce or imitate the conversation patterns of a specific person.

The term “instruction sentence” refers to a sentence or phrase input by a user that serves as a prompt to the generative AI model, instructing the generative AI model to generate a response, content, or conversation related to a deceased person.

The term “conversation with the deceased person” refers to a sequence of generated utterances output by the generative AI model that are intended to represent or simulate the speech and responses of the deceased person in an interactive dialogue with a user.

### BRIEF DESCRIPTION OF THE DRAWINGS

Exemplary embodiments of the present disclosure will be described in detail based on the following figures, wherein:

FIG. 1 is a schematic diagram illustrating an example of a configuration of a data processing system according to a first exemplary embodiment;

FIG. 2 is a schematic diagram illustrating an example of relevant functions of a data processing device and a smart device according to the first exemplary embodiment;

FIG. 3 is a schematic diagram illustrating an example of a configuration of a data processing system according to a second exemplary embodiment;

FIG. 4 is a schematic diagram illustrating an example of relevant functions of a data processing device and smart glasses according to the second exemplary embodiment;

FIG. 5 is a schematic diagram illustrating an example of a configuration of a data processing system according to a third exemplary embodiment;

FIG. 6 is a schematic diagram illustrating an example of relevant functions of a data processing device and a headset-type terminal according to the third exemplary embodiment;

FIG. 7 is a schematic diagram illustrating an example of a configuration of a data processing system according to a fourth exemplary embodiment;

FIG. 8 is a schematic diagram illustrating an example of relevant functions of a data processing device and a robot according to the fourth exemplary embodiment;

FIG. 9 illustrates an emotion map mapping plural emotions;

FIG. 10 illustrates an emotion map mapping plural emotions;

FIG. 11 is a sequence diagram showing the flow of data processing system processing in Example 1;

FIG. 12 is a sequence diagram showing the flow of data processing system processing in Application Example 1;

FIG. 13 is a sequence diagram showing the flow of data processing system processing in Example 2; and

FIG. 14 is a sequence diagram showing the flow of data processing system processing in Application Example 2.

### DETAILED DESCRIPTION

Description follows regarding an example of exemplary embodiments of a system according to technology disclosed herein, with reference to the appended drawings.

First, explanation follows regarding terminology employed in the following description.

In the following exemplary embodiments, a reference-numeral-appended processor (hereinafter simply referred to as “processor”) may be implemented by a single computation unit, and may be implemented by a combination of plural computation units. The processor may be implemented by a single type of computation unit, or may be implemented by a combination of plural types of computation units. Examples of computation unit include a central processing unit (CPU), a graphics processing unit (GPU), a general-purpose computing on graphics processing units (GPGPU), an accelerated processing unit (APU), and the like.

In the following exemplary embodiments, random access memory (RAM) appended with a reference numeral is memory temporarily stored with information, and is employed as working memory by a processor.

In the following exemplary embodiments, reference-numeral-appended storage is a single or plural non-volatile storage devices for storing various programs and various parameters and the like. Examples of non-volatile storage devices include flash memory (such as a solid state drive (SSD)), a magnetic disk (for example, a hard disk), magnetic tape, and the like.

In the following exemplary embodiments, a reference-numeral-appended communication interface (I/F) is an interface including a communication processor and an antenna or the like. The communication I/F has the role of communicating between plural computers. An example of a communication standard applied for the communication I/F is a wireless communication standard, such as a Fifth Generation Mobile Communication System (5G), Wi-Fi (registered trademark), Bluetooth (registered trademark), and the like.

In the following exemplary embodiments “A and/or B” has the same definition as “at least one out of A or B”. Namely, “A and/or B” may mean A alone, may mean B alone, or may mean a combination of A and B. Moreover, similar logic to “A and/or B” is applied when “and/or” is employed to link three or more items in the present specification.

### First Exemplary Embodiment

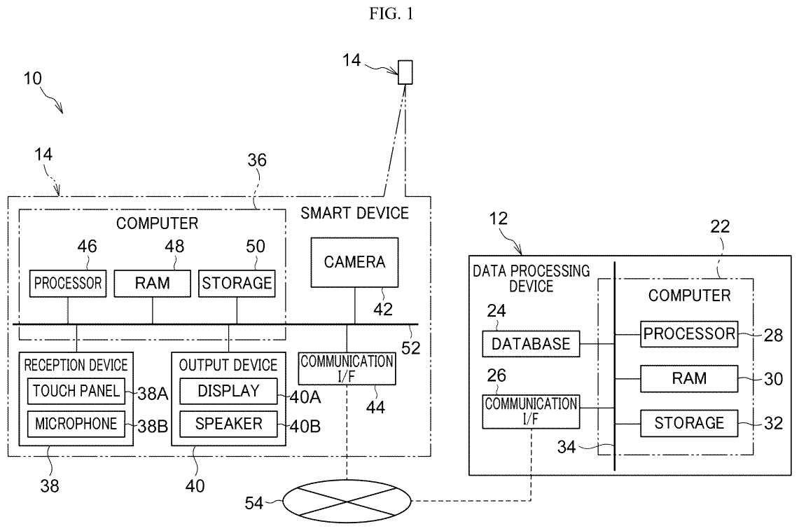

FIG. 1 illustrates an example of a configuration of a data processing system 10 according to a first exemplary embodiment.

As illustrated in FIG. 1, the data processing system 10 includes a data processing device 12 and a smart device 14. A server is an example of the data processing device 12.

The data processing device 12 includes a computer 22, a database 24, and a communication I/F 26. The computer 22 is an example of a “computer” according to technology disclosed herein. The computer 22 includes a processor 28, RAM 30, and storage 32. The processor 28, the RAM 30, and the storage 32 are connected to a bus 34. The database 24 and the communication I/F 26 are also connected to the bus 34. The communication I/F 26 is connected to a network 54. Examples of the network 54 include a Wide Area Network (WAN) and/or a local area network (LAN).

The smart device 14 includes a computer 36, a reception device 38, an output device 40, a camera 42, and a communication I/F 44. The computer 36 includes a processor 46, RAM 48, and storage 50. The processor 46, the RAM 48, and the storage 50 are connected to a bus 52. The reception device 38, the output device 40, the camera 42, and the communication I/F 44 are also connected to the bus 52.

The reception device 38 includes a touch panel 38A, a microphone 38B, and the like for receiving user input. The touch panel 38A receives user input from contact of a pointer (for example, a pen, a finger, or the like) by detecting contact of the pointer. The microphone 38B receives spoken user input by detecting speech of the user. A control unit 46A in the processor 46 transmits data representing the user input received by the touch panel 38A and the microphone 38B to the data processing device 12. A specific processing unit 290 in the data processing device 12 acquires the data indicating the user input.

The output device 40 includes a display 40A, a speaker 40B, and the like for presenting data to a user 20 by outputting the data in an expression format perceivable by the user 20 (for example, audio and/or text). The display 40A displays visual information such as text, images, or the like under instruction from the processor 46. The speaker 40B outputs audio under instruction from the processor 46. The camera 42 is a compact digital camera installed with an optical system such as a lens, an aperture, a shutter, and the like, and with an imaging device such as a complementary metal-oxide semiconductor (CMOS) image sensor or a charge coupled device (CCD) image sensor or the like.

The communication I/F 44 is connected to the network 54. The communication I/F 44 and the communication I/F 26 perform the role of exchanging various information between the processor 46 and the processor 28 over the network 54.

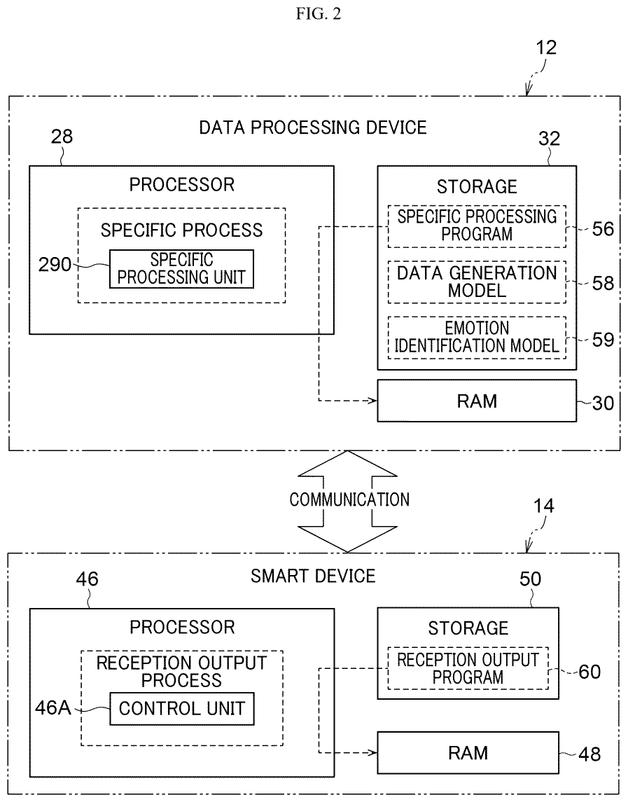

FIG. 2 illustrates an example of relevant functions of the data processing device 12 and the smart device 14.

As illustrated in FIG. 2, specific processing is performed by the processor 28 in the data processing device 12. A specific processing program 56 is stored in the storage 32. The specific processing program 56 is an example of a “program” according to technology disclosed herein. The processor 28 reads the specific processing program 56 from the storage 32, and in the RAM 30 executes the read specific processing program 56. The specific processing is implemented by the processor 28 operating as the specific processing unit 290 according to the specific processing program 56 executed in the RAM 30.

A data generation model 58 and an emotion identification model 59 are stored in the storage 32. The data generation model 58 and the emotion identification model 59 are employed by the specific processing unit 290. The specific processing unit 290 uses the emotion identification model 59 to estimate an emotion of a user, and is able to perform the specific processing using the user emotion. In an emotion estimation function (emotion identification function) that uses the emotion identification model 59, various estimations, predictions, and the like are performed related to emotions of the user, include estimating and predicting the emotion of the user, however, there is no limitation to such examples. Moreover, estimation and prediction of emotion also includes, for example, analyzing (parsing) emotions and the like.

Reception and output processing is performed by the processor 46 in the smart device 14. A reception and output program 60 is stored in the storage 50. The reception and output program 60 is employed by the data processing system 10 in combination with the specific processing program 56. The processor 46 reads the reception and output program 60 from the storage 50, and in the RAM 48 executes the read reception and output program 60. The reception and output processing is implemented by the processor 46 operating as the control unit 46A according to the reception and output program 60 executed in the RAM 48. Note that a configuration may be adopted in which a similar data generation model and emotion identification model to the data generation model 58 and the emotion identification model 59 are included in the smart device 14, and these models are used to perform similar processing to the specific processing unit 290. The reception and output program is implemented by the processor 46 operating as the control unit 46A according to the reception and output program 60 executed in the RAM 48.

Note that devices other than the data processing device 12 may include the data generation model 58. For example, a server device (for example, a generation server) may include the data generation model 58. In such cases, the data processing device 12 performs communication with the server device including the data generation model 58 to obtain a processing result (prediction result or the like) obtained using the data generation model 58. The data processing device 12 may be a server device, and may be a terminal device owned by the user (for example, a mobile phone, a robot, a home electrical appliance, or the like). Next, description follows regarding an example of processing by the data processing system 10 according to the first exemplary embodiment.

### Example 1

Description follows regarding a flow of the specific processing in an Example 1. The units of the system described below are implemented by the data processing device 12 and the smart device 14. The data processing device 12 is called a “server” and the smart device 14 is called a “terminal”.

Conventional computer-implemented dialog systems that attempt to simulate a deceased person generally rely on generic rule-based chat engines or unadapted generative models. Such systems treat user inputs as ordinary text queries and respond with template-based or statistically plausible sentences that are not grounded in the specific personal-related information of the deceased individual. As a result, the output speech, language style, and non-verbal expressions are coarse approximations that fail to reflect individual vocal characteristics, conversational patterns, and integrated multimodal behavior. This leads to a technically limited user experience in which the interaction is perceived as generic and disconnected from the underlying personal data, despite the availability of large volumes of stored media and communication records.

From a computing perspective, existing architectures typically process audio, video, and text data in separate, loosely coupled modules without an integrated training environment. Audio recordings are not systematically converted into speaker-specific acoustic models, text logs are not consistently transformed into dialog-context-aware training data for generative AI models, and visual or expressive behavior is not synchronized with the synthesized audio at the level of phoneme timing and intensity. Furthermore, dialog context is often handled in a stateless or shallow manner, with servers generating responses in isolation without leveraging accumulated session history to construct rich, subject-specific context for a generative AI model. This results in inefficient use of computing resources, suboptimal model adaptation, and a fragmented pipeline that cannot fully exploit the available multimodal personal-related information.

In addition, many conventional systems do not perform effective speaker separation or diarization on heterogeneous input data, such as audio embedded in videos and multi-party text conversations. Consequently, training data for speech synthesis and language generation models is contaminated with utterances and features from multiple speakers, which degrades the accuracy and stability of the models. This contamination introduces noise into the learning process, causing the generative models to produce responses with inconsistent voice characteristics and stylistic artifacts that diverge from the intended subject.

Therefore, there is a need for an improved computer-implemented system that constructs and operates an integrated artificial intelligence environment on a server, in which encrypted personal-related information is ingested, cleaned, and transformed into cohesive training datasets. The system should automatically learn and adapt both a speech synthesis generative model and a language generation generative model that are specific to a subject, manage dialog context on a per-session basis, and generate synchronized audio and expressive behavior data. Such a system should technically improve how servers process multimodal personal information, build subject-specific generative AI models, and provide continuous dialog sessions, thereby enhancing processing efficiency, data quality, and the realism and consistency of the resulting interactive experience.

The specific processing by the specific processing unit 290 of the data processing device 12 in Example 1 is realized by the following means.

The present invention provides a server comprising a processor and a storage device, the processor being configured to store personal-related information in an internal information processing environment of the server, to encrypt and manage the personal-related information, and to construct training datasets for generative model learning based on the personal-related information; to extract subject-specific speech segments from acoustic and video information included in the personal-related information, to convert the speech segments into acoustic feature data, and to learn or adapt a speech synthesis generative model based on the acoustic feature data and corresponding character data so that the speech synthesis generative model is associated with a subject; to extract an utterance history of the subject from character string information included in the personal-related information, to convert the utterance history into token sequences, to generate training data in which dialog-history-inclusive input sequences are associated with subject response sequences, and to learn or adapt a language generation generative model that imitates a conversational style of the subject based on the training data; to receive a prompt sentence from a terminal, to construct an input sequence to the language generation generative model based on dialog history including the prompt sentence and session identification information, and to execute the language generation generative model so as to generate utterance text of the subject in response to the prompt sentence; to normalize the generated utterance text into a speech synthesis input sequence, to generate audio waveform data based on speech characteristics of the subject by using the speech synthesis generative model, to compress the audio waveform data, and to transmit the compressed audio waveform data to the terminal; to extract phoneme timing information and intensity information from the audio waveform data, to generate display motion parameter sequences including mouth-shape information and facial-expression information synchronized with the audio waveform data, and to generate and transmit response data including the audio waveform data and the display motion parameter sequences to the terminal so that the terminal reproduces an interactive dialog experience with the subject; and, in some embodiments, to perform speaker separation processing on the acoustic information, the video information, and the character string information so as to exclude information of speakers other than the subject and to use only subject-specific acoustic feature data and utterance history for training or adapting the speech synthesis generative model and the language generation generative model. This enables an improved computer-implemented architecture in which the server builds and operates an integrated, subject-specific generative AI environment that efficiently transforms encrypted multimodal personal-related information into coordinated speech, language, and expressive behavior models, thereby enhancing data quality, model fidelity, contextual dialog handling, and the realism and consistency of user-perceived interactions compared with conventional systems.

The term “personal-related information” refers to information associated with an individual, including but not limited to acoustic data, video data, still image data, and character string data, from which the individual can be identified or characterized.

The term “information processing environment” refers to a hardware and software configuration within a server or similar computing apparatus in which data is stored, managed, and processed by one or more processors and storage devices.

The term “training dataset” refers to a structured collection of data samples prepared for machine learning, each sample comprising input data and, in some cases, target output data used to train or adapt a generative model.

The term “generative model” refers to a machine learning model configured to generate new data instances, such as text or audio, that are statistically or stylistically consistent with data used during its training.

The term “speech synthesis generative model” refers to a generative model configured to receive linguistic or phonetic input representations and to output audio data representing synthesized speech.

The term “language generation generative model” refers to a generative model configured to receive text or token-based input sequences and to output text representing generated natural language sentences or utterances.

The term “acoustic information” refers to data representing sound, including but not limited to audio tracks of video files and standalone audio recordings, typically encoded as digital audio signals.

The term “video information” refers to data representing moving images, optionally including one or more synchronized audio tracks, and typically stored in a digital video file format.

The term “character string information” refers to data representing text, including but not limited to chat logs, message histories, transcriptions, and other textual records associated with an individual.

The term “speech segment” refers to a continuous portion of acoustic information that contains speech produced by a speaker, as opposed to silence or non-speech sounds.

The term “acoustic feature data” refers to numerical representations of properties of audio signals, such as frequency spectra, mel-spectrograms, pitch, energy, and temporal patterns, derived from speech segments.

The term “character data” refers to symbolic or textual representations associated with audio content, including transcriptions, labels, or other textual information corresponding to speech segments.

The term “utterance history” refers to a collection of past utterances produced by a subject, recorded as textual data, and optionally associated with metadata such as timestamps or dialog partners.

The term “token sequence” refers to an ordered list of discrete elements, such as subword units, words, or symbols, obtained by processing text using a tokenizer for consumption by a generative model.

The term “dialog history” refers to a sequence of interaction records between a user and a subject, including previous prompt sentences and generated responses, used as contextual input to a generative model.

The term “input sequence” refers to an ordered collection of tokens or data elements constructed for input into a generative model in order to generate an output sequence.

The term “response sequence” refers to an ordered collection of tokens or data elements representing the desired or generated output of a generative model in response to an input sequence.

The term “conversational style” refers to characteristic patterns of language use by a subject, including word choice, sentence structure, tone, and typical response behavior in dialog.

The term “prompt sentence” refers to a textual instruction or query input by a user or terminal, which is provided to a generative model as part of the input sequence to elicit a corresponding generated response.

The term “terminal” refers to an end-user computing device, such as a smartphone, tablet, or personal computer, configured to communicate with the server, send prompt sentences, and receive and render response data.

The term “session identification information” refers to data used to uniquely identify an ongoing dialog session between a user and the server, enabling the server to maintain and retrieve associated dialog history.

The term “utterance text” refers to text generated by a language generation generative model that represents the content of a subject's spoken or written response in natural language.

The term “speech synthesis input sequence” refers to a representation of utterance text, including normalized text or phonetic data, that is provided as input to a speech synthesis generative model.

The term “audio waveform data” refers to digital data representing a time-domain audio signal, typically in the form of discrete amplitude samples, from which sound can be reconstructed for playback.

The term “phoneme timing information” refers to data indicating temporal positions and durations of phonemes within an audio waveform, used to align speech sounds with visual or other output modalities.

The term “intensity information” refers to data representing variations in amplitude or energy of an audio waveform over time, which may be used to infer stress, emphasis, or loudness.

The term “mouth-shape information” refers to data representing the configuration and movement of a mouth region corresponding to speech sounds, suitable for controlling visual rendering of mouth motions.

The term “facial-expression information” refers to data representing positions, movements, or states of facial features, such as eyes, eyebrows, and cheeks, used to visually express emotions or attitudes.

The term “display motion parameter sequence” refers to an ordered series of parameters, such as keypoints or blendshape weights, that control visual rendering of mouth shapes and facial expressions over time.

The term “response data” refers to a data package transmitted from the server to the terminal, including at least audio waveform data and display motion parameter sequences, and optionally text or metadata, for providing a dialog experience.

The term “speaker separation processing” refers to processing that analyzes multimodal data to distinguish between different speakers, including diarization or identification, and to separate subject-specific data from data of other speakers.

The term “subject” refers to an individual whose personal-related information is processed by the system and for whom subject-specific generative models are trained or adapted.

The term “dialog experience” refers to an interactive user experience in which a user exchanges prompt sentences and receives corresponding responses, rendered as audio and optionally visual content, that simulate a conversation with a subject.

In one embodiment, a server is implemented as a computing device comprising one or more general-purpose processors, a main memory, a non-volatile storage device, and a network interface. The server is connected via a communication network to one or more terminals operated by users. The server executes an operating system such as a server-class operating system, middleware such as a web server and an application server, and application software implemented in a high-level programming language. The server further executes software libraries and frameworks for multimedia processing, cryptographic processing, and machine learning, including at least one deep learning framework for training and serving generative AI models.

The server stores personal-related information in a storage subsystem such as a database system and an object storage system. The personal-related information includes acoustic information, video information, still image information, and character string information associated with a subject. The server manages the personal-related information in an encrypted form by applying symmetric-key encryption to digital files and records before writing them to persistent storage. The server maintains metadata records in a relational or key-value database, where each record links an encrypted data item to a subject identifier, a data type identifier, and time information.

The terminal is implemented as a user device such as a handheld computing device, a tablet computing device, or a desktop computing device. The terminal executes an application that presents a graphical user interface. The terminal provides user interface elements that allow the user to select personal-related information stored on the terminal and to transmit the selected information to the server via a secure communication protocol. The terminal also provides an input interface for the user to input a prompt sentence in natural language. For example, the user inputs one of the following prompt sentences: “Tell me about the music you used to like.”, “As you, what do you remember about our last family trip?”, “As you, could you share some advice for me starting my new job?”, or “Can you say something encouraging to me today?”.

The user operates the terminal to grant access to multimedia files and text message logs stored locally. The terminal reads the selected files, optionally compresses the files using a multimedia codec and a container format, and divides large files into segments if necessary. The terminal transmits the resulting data to the server over a network connection using an application-layer protocol with transport-layer security. The terminal also transmits metadata indicating file type, approximate duration, and originating application.

The server receives the acoustic information and video information in a binary stream. The server performs format validation, decodes the video information into a sequence of frames and at least one audio track by using a multimedia decoding library, and converts the audio track into a uniform format, such as a single-channel pulse-code-modulated stream with a predetermined sampling frequency. The server then performs acoustic pre-processing by applying a pre-emphasis filter, a framing operation, and a windowing operation to the audio stream, and calculates acoustic feature data such as mel-spectrograms, pitch contours, and energy contours. The server stores the acoustic feature data in a structured feature store that associates each feature matrix with a subject identifier and a time index.

The server performs speaker separation processing on the decoded audio and associated character string information, which may contain multiple speakers. The server uses a speaker diarization algorithm that combines clustering of embedding vectors with temporal segmentation. The server computes speaker embedding vectors by applying a neural network trained for speaker identification to short segments of the acoustic information. The server clusters the speaker embedding vectors and assigns each segment to one of the clusters. The server then identifies which cluster corresponds to the subject, based on correlation with known reference samples or heuristics derived from the personal-related information. The server discards segments that are associated with clusters other than the subject. This nontrivial speaker separation processing improves data purity compared with simple rule-based filtering and reduces contamination in subsequent model training.

The server processes the character string information by parsing logs of conversational sessions, including message content, sender identity, timestamps, and conversation identifiers. The server selects messages authored by the subject by using sender identifiers, and cleans the selected messages by normalizing character encoding, removing control characters, and converting special symbols and emojis into standardized tokens. The server then tokenizes the cleaned text using a subword segmentation algorithm such as byte-pair encoding or sentence-piece segmentation. The server stores the resulting token sequences in a training dataset with structure including a conversation identifier, a turn index, and a token sequence.

The server constructs dialog history sequences by grouping messages from the subject and counterpart messages from conversation partners into windows of predetermined length. For each window, the server designates a sequence of messages as context and designates a subsequent message by the subject as a response. The server builds input sequences that encode the roles (for example, user and subject) and the order of messages, and builds response sequences that encode the subject's reply. The server thus creates a structured training dataset suitable for training or adapting a language generation generative model to emulate the conversational style of the subject.

The server trains a language generation generative model that is implemented as a neural network of the transformer architecture. The server initializes the model with a set of parameters pre-trained on a general corpus, and then performs fine-tuning using the subject-specific dialog dataset. The server configures the model with multiple layers of multi-head self-attention and feedforward networks, defines a vocabulary size consistent with the tokenizer, and sets hyperparameters such as hidden dimension size, number of attention heads, and maximum sequence length. The server uses a cross-entropy loss function computed between the predicted probability distribution over the vocabulary at each time step and the ground truth token in the response sequence. The server updates the model parameters using a gradient-based optimization algorithm, such as an adaptive moment estimation algorithm with weight decay.

The server optionally applies a parameter-efficient fine-tuning technique by introducing additional trainable matrices at specific locations in the transformer layers while keeping the original weights fixed. This reduces memory consumption and speeds up training compared with full-parameter fine-tuning. The server monitors training progress using validation loss and perplexity metrics and implements early stopping criteria. The server periodically generates sample responses for held-out context examples, verifying that the generated utterance text exhibits vocabulary choices, sentence structures, and tone similar to the subject. By structuring the dialog data and training the transformer architecture in this manner, the server improves the capacity of the model to maintain long-range dialog coherence and subject-specific style without unduly increasing computational resource usage.

The server also trains a speech synthesis generative model using the acoustic feature data and corresponding character data. In one embodiment, the server implements a neural network architecture that combines an encoder-decoder network with a vocoder. The server uses a sequence-to-sequence network with attention or a non-autoregressive network to map text or phoneme sequences to mel-spectrograms. The server then uses a neural vocoder, which may be a generative adversarial network that generates time-domain audio waveforms from mel-spectrograms. The server initializes the speech synthesis model with pre-trained parameters and then adapts the model to the subject's voice by training on the subject-specific acoustic feature data.

The server computes a loss function that includes a reconstruction term for mel-spectrograms, a duration prediction term, and, when a generative adversarial vocoder is used, an adversarial loss term that measures the discrepancy between real and generated waveforms as assessed by a discriminator network. The server updates the generator and discriminator networks iteratively using gradient-based optimization and mini-batch training. The server also computes a speaker embedding vector that characterizes the subject's vocal identity, and conditions the speech synthesis model on this embedding. Through this training process, the server produces a speech synthesis generative model that can receive arbitrary textual input and output audio waveform data that reproduces the voice quality and prosody of the subject.

The server maintains a model registry where it stores the trained language generation generative model and the speech synthesis generative model, each associated with a subject identifier. For each subject, the server stores parameters, configuration files, and metadata describing training data statistics and performance metrics. By maintaining this registry, the server can quickly load appropriate models into memory for inference, thereby reducing response latency when processing a prompt sentence.

The terminal sends a prompt sentence input by the user to the server together with a session identifier. The server maintains dialog history per session in a fast-access store such as an in-memory data structure. The server constructs an input sequence for the language generation generative model by concatenating role-tagged dialog turns from the history and appending the new prompt sentence from the user. The server encodes the input sequence into token indices using the tokenizer and feeds the indices into the transformer-based language model.

The server generates output tokens one by one using an autoregressive procedure and a sampling strategy such as nucleus sampling with a specified probability threshold. The server enforces constraints on maximum length and termination tokens to avoid unnecessarily long responses.

The server converts the output token indices into a text string representing utterance text of the subject in natural language. The server then performs text normalization for speech synthesis, expanding numbers, dates, and abbreviations into standardized spoken forms. The server converts the normalized text to a sequence of phonemes or other linguistic units by using a grapheme-to-phoneme conversion algorithm. The server inputs this sequence, together with the subject's speaker embedding, into the speech synthesis generative model.

The server calculates mel-spectrogram frames, and then uses the vocoder network to generate audio waveform data that encodes the subject's voice. The server compresses the audio waveform data using an audio codec to reduce bandwidth requirements and transmits the compressed data to the terminal.

The server further analyzes the generated audio waveform data to extract phoneme timing information and intensity information. The server determines the onset and duration of each phoneme based on alignment information from the text-to-spectrogram stage or by applying forced alignment algorithms. The server derives intensity values from the energy contour of the waveform. The server maps these timing and intensity values to a sequence of display motion parameters, where each element in the sequence defines positions or weights for mouth-shape parameters and facial-expression parameters. The server may use a learned mapping from phoneme and prosody features to facial blendshape weights. The server packages the audio waveform data, the utterance text, and the display motion parameter sequence into response data and transmits the response data to the terminal.

The terminal receives the response data, decodes the compressed audio waveform data, and plays back the audio using an audio output unit. The terminal renders a visual representation of the subject, such as a still portrait, a two-dimensional character, or a three-dimensional avatar, using a graphics subsystem. The terminal applies the display motion parameters in synchronization with audio playback to adjust mouth shape and facial features frame by frame. The terminal thus provides the user with an integrated audio-visual dialog experience with the subject.

In another embodiment, the server performs additional optimization of data structures and communication protocols to improve system performance. For example, the server stores mel-spectrograms and intermediate representations in a compressed tensor format to reduce memory footprint, and reuses shared intermediate buffers across inference requests. The server also caches frequently used model layers in a persistent accelerator to reduce model loading latency. The server compresses dialog history representations rather than raw text when storing session context, thereby reducing storage and retrieval time. These techniques collectively improve processing speed, reduce memory usage, and lower network traffic between the server and the terminal.

The described configuration improves computer technology in several ways. By integrating multimodal personal-related information into coherent training datasets with speaker separation and structured dialog windows, the server reduces noise and improves the accuracy of generative AI models compared to naive use of unfiltered logs. By employing a specialized transformer architecture fine-tuned on subject-specific dialog and a neural speech synthesis architecture adapted to the subject's acoustic feature data, the server generates outputs that more precisely match the subject's conversational style and voice characteristics with fewer artifacts. This improved fidelity reduces the need for post-processing and manual correction, thereby increasing overall computational efficiency.

Moreover, the server's explicit management of session-based dialog history and construction of role-tagged, context-rich input sequences enables the language generation generative model to produce contextually coherent responses with fewer tokens, thereby reducing computation per interaction. The use of parameter-efficient fine-tuning methods reduces the total number of parameters that must be updated, accelerating training and lowering hardware requirements. The derivation of display motion parameter sequences directly from phoneme timing and intensity information produces tightly synchronized lip and facial movements without requiring frame-level manual animation, thus reducing storage and computation associated with pre-rendered video streams.

In contrast to manual or rule-based methods, the system applies specific, non-conventional data structures and training procedures that exploit the capabilities of the underlying computing hardware. Human operators do not feasibly perform the described high-dimensional feature extraction, gradient-based optimization, and multi-layer transformer forward passes with comparable accuracy or speed. The server's architecture therefore does not merely automate human mental processes, but instead realizes an improved technical method for handling, transforming, and serving large-scale multimodal data using generative AI models. This improved method yields higher quality results, reduced latency, and more efficient resource utilization in the context of simulating dialog with a subject.

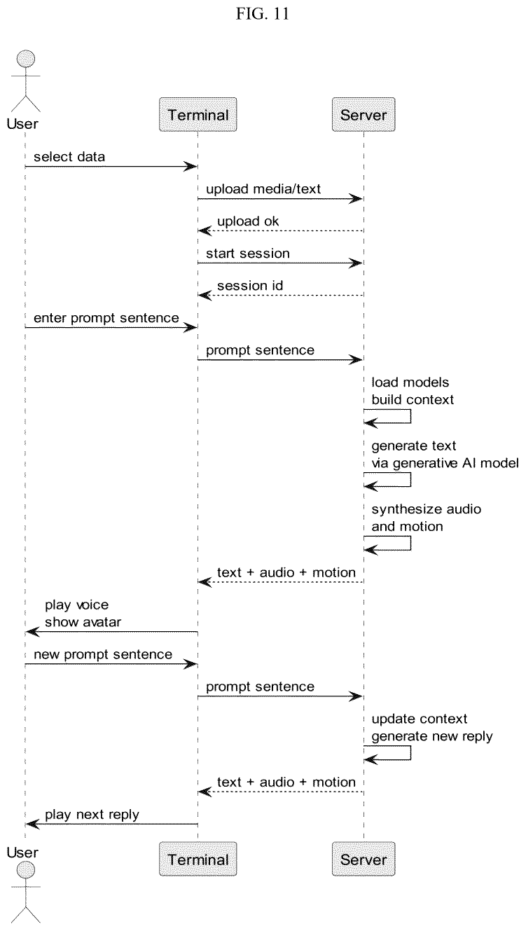

The following describes the processing flow using FIG. 11.

### Step 1:

The user operates the terminal to select personal-related information to be uploaded.

The input to this step is multimedia and text data stored on the terminal, such as audio recordings, video recordings, still images, and message logs.

The terminal reads file metadata (file paths, sizes, formats, and timestamps) from the local file system and presents a list of selectable items on a graphical user interface.

The terminal receives the user's selection and compiles a list of absolute file paths and associated metadata as an internal data structure that will be used as the basis for upload.

### Step 2:

The terminal prepares the selected personal-related information for transmission to the server.

The input to this step is the list of selected files and their metadata constructed in Step 1.

The terminal opens each file in binary mode, performs format inspection to confirm that the file is of a supported type, and, for large video files, optionally performs transcoding and compression using a multimedia library to standardize the codec and reduce size.

The terminal segments oversized files into smaller chunks if the file size exceeds a predetermined threshold.

The terminal then constructs one or more upload payloads that include binary file content and metadata in headers, forming the output for this step.

### Step 3:

The terminal transmits the prepared payloads to the server.

The input to this step is the upload payloads generated in Step 2 and a user authentication token obtained previously.

The terminal establishes a secure connection to the server using a network protocol with transport-layer security and sends HTTP requests containing multipart/form-data or binary streams.

The terminal includes metadata in the request body or headers, such as subject identifier, data type, and approximate duration.

The output of this step is a sequence of network requests that carry the personal-related information to the server.

### Step 4:

The server receives and validates the incoming personal-related information.

The input to this step is the network requests containing multimedia files, text logs, and associated metadata from the terminal.

The server verifies the user authentication token and checks access permissions for the specified subject.

The server reads file headers to confirm that the data conforms to expected formats (for example, audio formats, video formats, or text formats) and rejects files that are malformed or of unsupported type.

The server generates internal identifiers for each incoming file and writes the raw binary content into temporary storage.

The output of this step is a set of validated raw data records, each associated with a new internal identifier and basic metadata.

### Step 5:

The server encrypts and persistently stores the received personal-related information.

The input to this step is the validated raw data records generated in Step 4.

The server applies symmetric-key encryption to each file by running an encryption algorithm over the binary content, using a key managed by a key management system.

The server writes the encrypted binary data to an object storage system and stores metadata in a database, including a pointer to the storage location, subject identifier, data type, and encryption status.

The output of this step is a set of encrypted data objects and corresponding database records that can be retrieved for later processing.

### Step 6:

The server decodes video information and extracts audio tracks.

The input to this step is encrypted video data and associated metadata for records that have been designated for processing.

The server reads the encrypted video objects from storage, decrypts them in memory, and passes the decrypted streams to a multimedia decoding library.

The server decodes each video into a sequence of image frames and one or more audio tracks.

The server converts each audio track to a standardized pulse-code-modulated format by resampling to a fixed sampling rate and converting to a single-channel waveform.

The output of this step is a collection of standardized audio waveforms and, optionally, corresponding frame sequences for each video.

### Step 7:

The server performs acoustic pre-processing and computes acoustic feature data.

The input to this step is the standardized audio waveforms from Step 6 and any standalone audio recordings received from the terminal.

The server splits each waveform into overlapping frames using a fixed frame length and hop length and applies a window function to each frame.

The server computes frequency-domain representations using a fast Fourier transform, maps the spectra to a mel scale, and applies logarithmic compression to obtain mel-spectrograms.

The server also computes additional acoustic features such as pitch contours and energy contours from the waveforms.

The output of this step is a set of acoustic feature matrices and associated timing information for each audio segment.

### Step 8:

The server performs speaker separation processing to isolate segments corresponding to the subject.

The input to this step is the acoustic feature data, the corresponding waveforms, and any available speaker-related metadata.

The server segments the audio into shorter clips and computes speaker embedding vectors from each clip by applying a pre-trained speaker identification network.

The server clusters the embedding vectors and assigns each clip to a cluster, then identifies the cluster that represents the subject based on similarity to known reference samples or other heuristics.

The server discards clips that belong to clusters not associated with the subject.

The output of this step is a filtered set of audio segments and acoustic feature data that correspond only to the subject's voice.

### Step 9:

The server transcribes subject-specific audio segments into character data.

The input to this step is the subject-specific audio segments and corresponding timing information from Step 8.

The server runs an automatic speech recognition engine on each audio segment, producing text transcriptions and confidence scores.

The server aligns each transcription with the segment's timestamps and associates the resulting text with the subject identifier.

The server stores the transcriptions as character string records in a database, linked to their originating audio segments.

The output of this step is a set of text transcriptions that will be used as character data for speech synthesis training and as additional conversational content.

### Step 10:

The server processes message logs and transcribed text to construct utterance history.

The input to this step is character string information from message logs uploaded by the terminal and the transcribed text generated in Step 9.

The server parses structured logs to extract message content, sender identifiers, timestamps, and conversation identifiers.

The server filters messages to keep only those authored by the subject, merges them with transcribed utterances from audio segments, and normalizes the combined text by cleaning control characters and standardizing symbols.

The server assigns each utterance to a conversation session and orders utterances by timestamp.

The output of this step is an ordered utterance history for the subject, organized by conversation and time.

### Step 11:

The server tokenizes the utterance history and constructs dialog-context training examples.

The input to this step is the ordered subject utterance history and associated conversation metadata from Step 10.

The server applies a tokenizer to convert each text utterance into a sequence of tokens, where each token is a subword unit or symbol from a fixed vocabulary.

The server groups tokens from the subject and conversation partners into windows that represent dialog history, marking each utterance with a role tag.

The server designates part of the window as an input sequence (context) and designates the subject's next utterance as a response sequence.

The output of this step is a structured dataset of paired input sequences and response sequences suitable for training a generative AI model.

### Step 12:

The server trains or adapts a language generation generative model using the structured dialog dataset.

The input to this step is the paired input and response sequences from Step 11 and an initial set of model parameters for a transformer-based neural network.

The server feeds batches of input sequences into the model, computes predicted probability distributions over tokens for each position in the response, and calculates cross-entropy loss between predictions and ground truth tokens.

The server computes gradients of the loss with respect to model parameters and updates the parameters using an optimization algorithm, iterating over multiple epochs.

The server evaluates performance on a validation subset and may stop training early when performance converges.

The output of this step is a fine-tuned language generation generative model that is specialized for the subject's conversational style.

### Step 13:

The server constructs training pairs for speech synthesis based on acoustic feature data and transcriptions.

The input to this step is the subject-specific acoustic feature matrices from Step 8 and the corresponding character data from Step 9.

The server splits long utterances into manageable segments, aligns each segment's text with its acoustic frames, and verifies that alignment lengths are consistent with timing constraints.

The server records each training pair as a combination of text or phoneme sequence and the corresponding mel-spectrogram, along with a label indicating the subject identifier.

The output of this step is a dataset of text-acoustic feature pairs that will be used for training or adapting a speech synthesis generative model.

### Step 14:

The server trains or adapts the speech synthesis generative model.

The input to this step is the dataset of text-acoustic feature pairs from Step 13 and an initial parameter set for a speech synthesis model and a vocoder model.

The server feeds batches of text or phoneme sequences into the model, generates predicted mel-spectrograms, and compares the predictions with reference mel-spectrograms using a loss function that measures differences in amplitude and other attributes.

The server backpropagates the error through the network and updates model parameters using a gradient-based optimizer.

When a vocoder is used, the server also trains or adapts the vocoder by comparing generated waveforms with real waveforms and updating the generator and discriminator networks.

The output of this step is a trained speech synthesis generative model and, optionally, an updated vocoder model associated with the subject.

### Step 15:

The server registers and stores the subject-specific generative AI models.

The input to this step is the fine-tuned language generation generative model from Step 12 and the trained speech synthesis generative model from Step 14.

The server assigns version identifiers to each model, associates the models with the subject identifier, and stores model parameters, configuration files, and performance metrics in a model registry.

The server may also store a compact representation of model metadata to enable quick lookup of available models for each subject.

The output of this step is a set of registered subject-specific generative models ready for inference.

### Step 16:

The terminal initiates a dialog session with the server.

The input to this step is a user action selecting a subject and a request to start a conversation.

The terminal sends a session start request to the server including the user identifier, the subject identifier, and device settings such as language and region.

The terminal displays an input field for the user to enter a prompt sentence.

The output of this step is a new session identifier received from the server and a ready state on the terminal for user input.

### Step 17:

The user inputs a prompt sentence through the terminal.

The input to this step is the user's natural language text entered into the terminal's input field.

The terminal performs basic validation, such as ensuring that the string is non-empty and trimming leading and trailing whitespace.

The terminal constructs a request message that includes the prompt sentence, the session identifier, and relevant configuration options such as desired response length.

The output of this step is a structured request that will be sent to the server to trigger generative processing.

### Step 18:

The terminal transmits the prompt sentence request to the server.

The input to this step is the structured request produced in Step 17 and an active network connection.

The terminal encodes the request in a message format, attaches authentication credentials, and sends it to a designated server endpoint using a secure communication protocol.

The terminal records the prompt sentence in its local display as a new message entry in the dialog view.

The output of this step is a network request that reaches the server and a locally updated dialog history on the terminal.

### Step 19:

The server retrieves dialog history and constructs a model input sequence.

The input to this step is the prompt sentence request containing the session identifier and the new user prompt.

The server queries its session store to retrieve prior exchanges for the session, including past prompt sentences and previously generated responses.

The server formats the dialog history as a sequence of role-tagged utterances, appends the new prompt sentence at the end, and converts the entire sequence to tokens using the tokenizer associated with the language generation generative model.

The output of this step is a tokenized input sequence that encodes dialog context and the new prompt sentence.

### Step 20:

The server generates a text response using the language generation generative model.

The input to this step is the tokenized context and prompt sequence from Step 19 and the subject-specific language generation generative model.

The server feeds the token sequence into the transformer model, computes internal activations, and begins autoregressive generation of output tokens.

The server uses a decoding strategy such as nucleus sampling or top-k sampling to select each new token based on the predicted probabilities, while enforcing constraints on maximum sequence length and stop tokens.

The server converts the resulting sequence of output tokens back into characters and strings to form utterance text representing the subject's reply.

The output of this step is the generated utterance text in natural language.

### Step 21:

The server prepares the generated utterance text for speech synthesis.

The input to this step is the utterance text from Step 20.

The server performs text normalization, expanding numeric expressions, abbreviations, and symbols into their spoken forms and resolving ambiguous tokens according to pronunciation rules.

The server passes the normalized text through a grapheme-to-phoneme converter to obtain a sequence of phonemes or other linguistic units, and may annotate the sequence with prosodic markers.

The output of this step is a speech synthesis input sequence suitable for processing by the speech synthesis generative model.

### Step 22:

The server synthesizes audio waveform data corresponding to the subject's voice.

The input to this step is the speech synthesis input sequence from Step 21 and the subject-specific speech synthesis generative model and vocoder.

The server feeds the input sequence, along with the subject's speaker embedding, into the speech synthesis model to generate a mel-spectrogram sequence.

The server passes the mel-spectrogram sequence to the vocoder, which computes a time-domain audio waveform by iteratively or directly generating sample values that correspond to the desired speech signal.

The server encodes the waveform into a compressed audio format to reduce data size for transmission.

The output of this step is compressed audio waveform data that reproduces the subject's speech corresponding to the utterance text.

### Step 23:

The server derives display motion parameters from the synthesized audio.

The input to this step is the generated audio waveform and, optionally, alignment information from the speech synthesis model.

The server analyzes the waveform to determine the onset and duration of each phoneme and computes energy values over time to estimate intensity.

The server maps phoneme identities and timing, together with intensity data, to a sequence of parameter vectors that represent mouth shapes and facial expressions at discrete time steps, using a predefined mapping or a trained regression model.

The output of this step is a display motion parameter sequence synchronized with the synthesized audio.

### Step 24:

The server packages and transmits response data to the terminal.

The input to this step is the utterance text from Step 20, the compressed audio waveform data from Step 22, and the display motion parameter sequence from Step 23.

The server constructs a response message that includes these elements along with timing information and any necessary metadata.

The server sends the response message to the terminal using the existing secure communication channel.

The output of this step is a network response that carries all components required for the terminal to render the dialog response.

### Step 25:

The terminal renders the audio-visual response for the user.

The input to this step is the response message received from the server in Step 24.

The terminal decodes the compressed audio data to reconstruct the audio waveform and plays the audio through an audio output device.

The terminal selects a visual representation of the subject and applies the display motion parameter sequence in sync with the audio playback, updating the mouth shape and facial features according to the parameters at each time step.

The terminal also appends the utterance text to the dialog view as a new message.

The output of this step is a rendered audio-visual presentation that the user perceives as a response from the subject.

### Step 26:

The user optionally continues the dialog by entering another prompt sentence.

The input to this step is the user's decision after experiencing the rendered response in Step 25.

The user may type a new prompt sentence, such as “What did you think about our last family trip?” or “Could you share some advice for me starting my new job?”.

The terminal captures the new input and repeats the process from Step 17 onward, allowing the conversation to continue across multiple turns.

The output of this step is a new prompt sentence that initiates another cycle of generative processing.

### Application Example 1

Description follows regarding a flow of the specific processing in an Application Example 1. The units of the system described below are implemented by the data processing device 12 and the smart device 14. The data processing device 12 is called a “server” and the smart device 14 is called a “terminal”.

Conventional systems for recreating conversations with a deceased person largely rely on simple playback of prerecorded audio or video segments, or on generic conversational agents that are not adapted to the specific linguistic and behavioral characteristics of the deceased person. As a result, such systems fail to provide coherent, contextually grounded, and technically robust virtual dialogues that reflect the deceased person's actual conversation patterns, facial expressions, and voice characteristics.

In particular, existing computer-implemented dialogue systems lack an integrated architecture that (i) structures and stores personal-related information of a deceased person in a form suitable for efficient retrieval and conditioning of a generative AI model, (ii) dynamically retrieves semantically relevant past dialogue content in response to a user's prompt sentence, (iii) combines such retrieved content with the prompt sentence as context for a generative AI model, and (iv) synthesizes synchronized audio and motion image information that consistently imitates the deceased person's voice and expressions. Without such an integrated architecture, a processor is required to perform ad hoc processing across heterogeneous modules for text generation, speech synthesis, and image processing, leading to poor context continuity, increased latency, and degraded user experience.

Furthermore, conventional approaches do not sufficiently improve core computer technology related to data representation and retrieval for personalized generative dialogue. For example, past dialogue content is often stored as unstructured text or media files without embedding into a semantic representation space, making it difficult for a processor to efficiently locate and reuse relevant historical content in response to a new prompt sentence. The absence of a structured similarity search mechanism for past dialogue content forces the system to either ignore most historical data or perform computationally expensive full-text searches, which are unsuitable for real-time interactive applications.

In addition, conventional systems typically treat speech synthesis and facial animation as loosely coupled, independent post-processing steps. This separation causes misalignment between synthesized audio and motion image information and imposes additional synchronization burdens on computing resources. The lack of a unified control flow, from user prompt sentence to generative AI model output to audio and image synthesis, prevents the system from exploiting shared timing information, such as phoneme or viseme timing, that could otherwise be used to optimize both quality and efficiency of synchronized audiovisual generation.

Accordingly, there is a need for a computer-implemented system that improves computer technology by introducing a unified processing architecture in which a processor: constructs a generative information processing environment; manages personal-related information of a deceased person in a structured manner; converts past dialogue content into embedding vectors stored in a similarity search mechanism; retrieves semantically relevant content based on user prompt sentences; and orchestrates generative AI model inference, speech synthesis, and facial animation in an integrated pipeline. Such a system should reduce processing overhead, improve retrieval accuracy, and generate technically consistent audiovisual dialogue outputs that better leverage computing resources.

The specific processing by the specific processing unit 290 of the data processing device 12 in Application Example 1 is realized by the following means.

The present invention provides a server comprising a processor configured to construct, by using data processing resources, a generative information processing environment including a generative AI model; to input a training information set including personal-related information associated with a deceased person and a control prompt sentence into the generative AI model so as to generate and store structured personal-related information for use as reference information in dialogue generation; to generate embedding vectors that map past dialogue content information obtained from visual information or communication applications into a semantic representation space and register the embedding vectors in a similarity search mechanism; to receive, from a user terminal, a prompt sentence, generate an embedding vector corresponding to the prompt sentence, and retrieve, based on similarity between embedding vectors, past dialogue content information semantically related to the prompt sentence; to construct model input context by integrating the retrieved dialogue content information with the prompt sentence and to cause the generative AI model to generate response text data that imitates a conversation style of the deceased person; to analyze audio information associated with the deceased person, generate speaker characteristic information, and synthesize audio data reproducing speech of the deceased person based on the response text data and the speaker characteristic information; to analyze image information associated with the deceased person, calculate face contour point information based on phoneme or viseme information associated with the audio data, and generate motion image information including expression changes corresponding to the face contour point information; and to transmit the response text data, the synthesized audio data, and the motion image information to the user terminal via a communication interface. This enables an improvement in computer functionality by providing an integrated, processor-controlled pipeline that efficiently manages personal-related data representations, performs context-aware retrieval using embedding-based similarity search, and coordinates generative AI inference with synchronized audio and image synthesis, thereby allowing a computing system to generate technically coherent, contextually grounded virtual dialogues with reduced latency and enhanced resource utilization.

The term “system” refers to an arrangement of one or more information processing apparatuses, including at least one processor, memory, storage, and communication interface, that cooperate to perform the claimed functions.

The term “processor” refers to one or more hardware processing units, such as a central processing unit, graphics processing unit, or dedicated accelerator, capable of executing instructions to perform arithmetic, logic, control, and input/output operations.

The term “data processing resources” refers to hardware and software components, including processing units, memory, storage, and operating system functions, that are available to perform computation and data manipulation.

The term “information processing apparatus” refers to an electronic device or combination of devices including at least a processor, memory, storage, and communication interface, configured to execute programs for processing information.

The term “generative information processing environment” refers to a software and hardware environment configured to execute one or more generative models, manage model parameters and inputs, and perform generation of new information based on learned patterns.

The term “generative AI model” refers to a machine learning model trained on data to generate new data, such as text, audio, or images, in response to input information including prompts and context.

The term “generative information generation mechanism” refers to a functional component implemented by a generative AI model and associated processing that produces generated data from input data and control parameters.

The term “training information set” refers to a collection of data, including text, audio, image, or other digital content, that is supplied to a generative AI model for learning or fine-tuning its parameters.

The term “personal-related information” refers to data associated with an individual person, including but not limited to text, audio, image, video, or metadata, from which characteristics, preferences, or behaviors of the person can be inferred.

The term “deceased person” refers to a specific individual who is no longer living and whose personal-related information is used as a basis for generation of virtual dialogue, audio, and image content.

The term “control prompt sentence” refers to a text input, including instructions, questions, or other natural language content, that is provided to a generative AI model to control or guide the content and style of generated outputs.

The term “storage apparatus for recorded information” refers to one or more storage devices, such as a magnetic disk, solid-state drive, or non-volatile memory, configured to store digital information persistently.

The term “reference information for dialogue generation processing” refers to stored data, including personal-related information and past dialogue content, that is consulted or incorporated as context when generating new dialogue.

The term “audio information” refers to digital data representing sound, including recorded speech signals or derived acoustic features.

The term “visual information” refers to digital data representing images or video, including frames or sequences that depict persons, scenes, or objects.

The term “speaker characteristic information” refers to parameters, embeddings, or feature representations derived from audio information of a specific person, which characterize that person's voice, such as timbre, pitch patterns, and speaking style.

The term “dialogue text data” refers to textual data representing utterances or messages in a conversation, including questions, responses, and statements.

The term “audio data” refers to digital waveform data or encoded audio content suitable for playback by an audio output device.

The term “image information” refers to digital data representing static images, such as bitmaps or encoded picture formats, including facial images of a person.

The term “face contour point information” refers to coordinate data or feature points indicating positions of facial components, such as eyes, nose, mouth, and jawline, used to control or describe facial shape and movement.

The term “phoneme information” refers to data representing phonetic units of speech, such as phoneme labels, timing, or alignment information associated with audio data.

The term “viseme information” refers to data representing visual units of speech, such as mouth shapes or facial configurations corresponding to phonemes, including timing and sequence information.

The term “motion image information” refers to digital data representing a sequence of images or video frames, including animated changes of facial expressions and movements over time.

The term “expression change” refers to a variation in facial features, such as movement of eyes, eyebrows, mouth, or cheeks, that conveys emotion or speech articulation.

The term “dialogue management mechanism” refers to a functional component implemented by software and hardware that controls the flow of conversation, including analysis of prompts, retrieval of context, and organization of model inputs and outputs.

The term “instruction text data” refers to text data input by a user, including commands, questions, or statements, which function as prompts to control system behavior.

The term “user terminal” refers to an electronic device operated by a user, such as a mobile device, personal computer, or head-mounted display, that sends prompts to the system and receives generated outputs.

The term “prompt sentence” refers to a sentence or text string input by a user or system that is provided as a prompt to a generative AI model for generating a response.

The term “past dialogue content information” refers to stored text, transcripts, or structured data representing previous conversations involving the deceased person, whether derived from visual information, communication applications, or other sources.

The term “context information” refers to data that provides background or supporting information for a generative AI model input, including past dialogue content, personal-related information, or system instructions combined with a current prompt.

The term “response text data” refers to text data generated by a generative AI model in response to a prompt sentence and context information, representing a system-generated utterance.

The term “conversation style of the deceased person” refers to characteristic patterns of language use, including vocabulary, phrasing, tone, and typical expressions, associated with the deceased person.

The term “communication processing mechanism” refers to hardware and software components configured to send and receive data over a communication network between the server and a user terminal.

The term “virtual dialogue” refers to an interaction presented to a user as if conversing with a person, including generated text, audio, and image content, even though the interaction is produced by a computing system.

The term “visual information and auditory information” refers to, respectively, image or video data and audio data presented to a user through display and sound output devices.

The term “semantic representation space” refers to a mathematical space, such as a vector space, in which semantically similar pieces of information are represented by nearby points or vectors.

The term “embedding vector” refers to a numerical vector representing text or other data in a semantic representation space, produced by an embedding model or similar transformation.

The term “similarity search mechanism” refers to a software and hardware component configured to index embedding vectors and retrieve vectors or associated data items based on similarity metrics.

The term “dialogue history information” refers to information describing prior exchanges in a conversation, including previously generated responses and user prompts.

The term “conversation patterns of the deceased person” refers to recurring structures and tendencies in the deceased person's dialogues, including typical response forms, topics, and interaction styles.

The term “mobile information processing apparatus” refers to a portable electronic device, such as a smartphone or tablet, that includes a processor, memory, storage, and communication functions.

The term “head-mounted display apparatus” refers to a wearable display device configured to be mounted on a user's head and to present visual information in a virtual or augmented reality format.

The term “network communication” refers to the exchange of digital data over a communication network using one or more communication protocols.

The term “continuous virtual dialogue” refers to a sequence of virtual dialogue exchanges that proceed over multiple prompt sentence inputs, maintaining contextual consistency across turns.

In one embodiment, a system includes a server and one or more terminals. The server includes at least one processor, a main memory, a non-volatile storage device, and a network interface. The terminal includes a processor, a display, an audio output device, an input device, and a network interface. The server and the terminal are connected via a communication network such as the Internet.

The server executes an operating system such as a general-purpose server operating system on hardware such as an x86-compatible central processing unit and a graphics processing unit. The server uses a software stack including a container platform, an application framework such as a web application framework, and machine-learning frameworks such as PyTorch or TensorFlow. The server stores personal-related information, model parameters, and dialogue logs in a storage device such as a relational database management system and an object storage.

The terminal executes a mobile operating system or a head-mounted display operating system on a system-on-chip including a central processing unit, a graphics processing unit, and multimedia accelerators. The terminal uses a native application or a browser-based application to provide a user interface for entering a prompt sentence and for presenting audio and visual information. The terminal uses a system multimedia framework such as an audio/video playback library to decode audio and video streams received from the server.

The server constructs a generative information processing environment by loading a generative AI model into the memory of the server and allocating computation to the processor and the graphics processing unit. The generative AI model is implemented as a neural network, for example a transformer-based architecture including multiple self-attention layers, feed-forward layers, and normalization layers. The server stores model parameters such as weight matrices and bias vectors in a parameter store and transfers the parameters to the graphics processing unit memory for high-throughput matrix multiplication.

The server configures the generative AI model to accept a token sequence as input and to output a token probability distribution at each decoding step. The server uses a tokenizer based on subword encoding, such as byte-pair encoding or a similar segmentation algorithm, to map characters of a prompt sentence and context text into integer token identifiers. The server uses a positional encoding scheme to embed token positions and passes the embedded tokens through the transformer layers.

The server prepares a training information set including personal-related information associated with a deceased person. The personal-related information includes transcribed speech from recorded videos, messages from communication applications, e-mail texts, and user notes. The server pre-processes this information by normalizing character encoding, removing noise, and segmenting the information into utterance-level units. The server stores each utterance together with metadata such as a timestamp, a conversation counterpart identifier, and a topic label in a structured database.

The server performs a fine-tuning or adaptation process on the generative AI model by using the personal-related information. The server uses a supervised learning procedure in which an input context window and a target continuation are defined for each training sample. The server computes a loss value such as cross-entropy loss between the model output distribution and the target token distribution. The server uses an optimization algorithm such as Adam to update the weight matrices and bias vectors of the transformer network. The server applies gradient clipping and learning-rate scheduling to stabilize training. The server optionally performs data augmentation such as random masking of tokens or reordering of non-critical segments to improve generalization.

The server constructs a semantic representation space for past dialogue content. The server uses an embedding model such as a sentence-level transformer encoder to convert each utterance of the deceased person and related context into an embedding vector in a multi-dimensional real-valued space. The server stores the embedding vectors in a similarity search mechanism such as a vector index data structure using approximate nearest neighbor algorithms. The server associates each embedding vector with a reference to the original utterance and metadata in a key-value store.

The server thereby creates a data structure in which semantically similar utterances are located near each other in the embedding space. This structure allows the server to perform vector comparisons using a similarity metric such as cosine similarity or inner product. The server uses a specialized approximate nearest neighbor indexing algorithm such as a hierarchical navigable small-world graph or an inverted file structure to efficiently search the embedding space. This configuration reduces time complexity for retrieval compared to naive full-text search, which improves response latency and resource utilization.

The server uses a dialogue management mechanism to construct context information for each prompt sentence. The server receives, from the terminal, a prompt sentence such as “Grandpa, please tell me about the old days.” The server converts this prompt sentence into an embedding vector using the same or a compatible embedding model employed for past dialogue content. The server queries the similarity search mechanism with this embedding vector and obtains a set of past utterances that have high similarity scores. The server filters the retrieved utterances according to rules, for example removing redundant content, limiting the time span, or excluding sensitive topics.

The server formats the retrieved content into a context block including the deceased person's past statements, typical phrases, and relevant events. The server separates system-level instructions, context text, and the current prompt sentence. For example, the server may construct a combined input that includes sections such as: “System instructions,” “Background information,” “Previous examples,” and “User prompt: Grandpa, please tell me about the old days.” The server tokenizes this combined input and checks that the token length is within the maximum sequence length of the generative AI model. If necessary, the server applies a summarization or truncation algorithm to reduce earlier segments, preserving those with the highest semantic relevance.

The server then performs inference using the generative AI model. The server passes the tokenized combined input through the transformer layers of the generative AI model on the graphics processing unit. The server obtains a probability distribution for the next token at each step. The server applies a decoding strategy such as nucleus sampling, top-k sampling, or a temperature-scaled softmax to select the next token. The server includes a repetition penalty term in the sampling algorithm to reduce undesirable looping behavior. The server continues token generation until a termination condition such as an end-of-sequence token or a maximum length is reached. The server then maps the output token sequence back into a text string, which becomes the response text data.

The server improves computing technology by linking the embedding-based retrieval, the transformer-based generation, and the downstream synthesis modules in a tightly integrated pipeline. The server reduces the size of the prompt fed to the generative AI model by selecting only high-relevance context via similarity search, thereby reducing computation time and memory usage in the transformer layers. The server also stores dialogue history and derived embeddings, enabling reuse of previously computed vectors and avoiding redundant computation in later turns.

The server further comprises a voice synthesis mechanism for reproducing the deceased person's voice. The server uses a neural text-to-speech model such as a sequence-to-sequence acoustic model combined with a neural vocoder. The server trains or adapts a speaker encoding module to generate a speaker embedding from recorded audio samples of the deceased person. The server uses pre-processing stages such as noise reduction, voice activity detection, and segmentation to obtain clean speech segments. The server computes acoustic features such as mel-frequency spectrograms and uses these features with a speaker encoder network to derive a fixed-dimensional vector representing the vocal characteristics of the deceased person.

The server configures the acoustic text-to-speech model to receive a sequence of phonemes or characters and the speaker embedding. The server uses an attention-based decoder or a duration-based model to generate a sequence of mel-spectrogram frames. The server then passes the mel-spectrogram to a neural vocoder such as a generative adversarial network-based vocoder or an autoregressive vocoder to synthesize a waveform. The server performs normalization, dynamic range compression, and optional equalization on the synthesized waveform. The server encodes the waveform into a standard audio format such as a compressed audio stream.

The server enhances technical performance by reusing phoneme-level alignment from the text-to-speech model for facial animation. The server extracts phoneme timing information from the alignment mechanism used in the acoustic model, instead of performing a separate alignment process. This reduces duplicated computation and ensures consistent timing between synthesized audio and visual mouth movements.

The server includes an image processing mechanism for generating motion image information. The server stores one or more base images of the deceased person's face in a high-resolution format. The server uses a face detection and landmark detection algorithm such as a convolutional neural network-based detector to identify facial features including eye corners, nose tip, lip boundaries, and jawline. The server stores landmark coordinates as a facial template for the base image.

The server uses a talking-head generation model that converts audio-derived features into corresponding facial motion. The server may use a model that maps sequences of phonemes or mel-spectrogram frames to sequences of facial landmark displacements or viseme labels.

The server trains this model with paired datasets of audio and facial motion or uses a pre-trained model adapted to the facial geometry of the deceased person. The server then applies the model to the phoneme or mel-spectrogram sequence of the synthesized speech to obtain frame-wise viseme or landmark positions.

The server applies a warping or rendering procedure to the base face image to create a sequence of frames in which the mouth shape, jaw position, and other facial features move according to the computed landmark displacements. The server optionally uses an image-to-image generative model to refine each frame and improve realism, for example by hallucinating intermediate textures and correcting artifacts. The server assembles the frames into a video stream and aligns the frame timestamps with the audio waveform.

The server improves computer technology by using shared internal timing and phoneme alignment between the text-to-speech model and the facial animation model. The server avoids the need for separate and inconsistent alignment steps, which reduces processing time and synchronization errors. The server's control over the internal data structures such as phoneme alignment matrices and landmark displacement vectors allows precise synchronization, resulting in reduced misalignment artifacts and improved user perception of lip-sync accuracy.

The server uses a communication processing mechanism to exchange data with the terminal.

The server exposes an application programming interface over a network protocol such as HTTPS. The server receives a prompt sentence from the terminal in a request message and returns response text data, audio data, and motion image information in a response message or streaming protocol. The server uses a streaming protocol for large media content to avoid blocking interactions and enables the terminal to start playback before the entire content is transmitted.

The terminal provides a user interface for entering prompt sentences and for presenting outputs. The terminal displays a text input field and optionally a microphone icon. The user inputs a prompt sentence such as “Grandpa, do you remember our trip to the mountains?”, “Grandma, what was your favorite recipe to cook for our family?”, “Dad, how did you feel on the day I was born?”, or “Mom, give me some advice about starting a new job.” The terminal encodes the prompt sentence as text data and sends it to the server.

The terminal receives from the server the response text data, audio data, and motion image information. The terminal decodes the video stream using a hardware-accelerated decoder integrated in the system-on-chip and decodes the audio stream using an audio codec. The terminal synchronizes the audio and video streams using timestamp information. The terminal renders the video on the display and outputs the audio through the speakers or headphones. When the terminal is a head-mounted display, the terminal may place the video in a virtual environment or overlay the animated face in an augmented reality scene.

The server and the terminal cooperate to produce a virtual dialogue that could not be easily achieved with manual operations. The server's embedding-based retrieval and transformer-based generation operate on numerical vectors and large parameter matrices in a way that is qualitatively different from human recall and language production. The server's use of high-dimensional semantic representation space and approximate nearest neighbor search enables retrieval of relevant context within strict latency constraints, which improves the technical performance of the dialogue generation pipeline.

The system as a whole improves computing technology by reducing redundant computation, compressing large unstructured dialogue corpora into compact embedding vectors, and orchestrating multiple neural models in a way that exploits shared intermediate features. The embedding vectors stored in the similarity search mechanism avoid repeated full-sequence passes through a language model for each retrieval. The reuse of phoneme alignment for both audio synthesis and facial animation reduces the number of alignment computations and the amount of intermediate data, which reduces power consumption and computing time on the server hardware.

In one alternative embodiment, the server uses a different generative AI model architecture, such as a recurrent neural network with attention or a mixture-of-experts transformer. In another embodiment, the server uses a different embedding model for semantic representation, such as a convolutional network-based encoder. In another embodiment, the server uses a non-neural approximate nearest neighbor index such as a tree-based data structure. In each case, the server maintains the core architecture of mapping prompt sentences and past dialogue content into an embedding space, performing similarity search, and constructing a context input for the generative AI model.

In another embodiment, the terminal performs some pre-processing, such as speech recognition or local embedding computation, to reduce network load and server computation.

The terminal may compute an embedding vector for the prompt sentence and send only the vector and an identifier to the server. The server then uses the vector directly in the similarity search mechanism. This reduces transmission size and may reduce latency in constrained network environments.

In yet another embodiment, the server uses multiple tiers of storage, such as an in-memory cache for frequently accessed embeddings and a slower persistent store for infrequent data.

The server thereby reduces average retrieval time and further improves responsiveness. The server may also adjust model parameters or retrieval thresholds based on measured latency to adapt performance to current load conditions.

The described embodiments thus provide detailed configurations of hardware, software, data structures, and algorithms. The server controls internal data flows and neural network processing steps to achieve technically improved performance in generating personalized, synchronized audiovisual dialogues from prompt sentences, and the terminal converts these outputs into perceptible audio and visual signals, thereby linking the abstract processing to concrete machine operations.

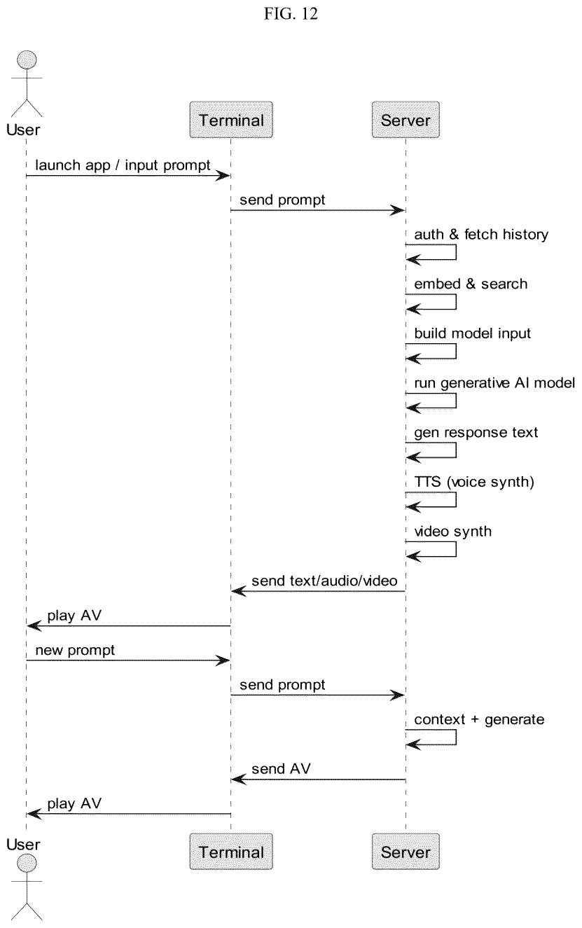

The following describes the processing flow using FIG. 12.

### Step 1:

The user operates the terminal to launch an application for virtual dialogue.

The terminal, as input, receives a user action such as tapping an application icon or selecting a menu entry, and the terminal loads application resources from local storage into memory.

The terminal initializes graphical user interface components, an audio subsystem, and a network communication module, and as output, the terminal displays an initial screen that includes a text field for a prompt sentence and optional buttons for sending and recording voice.

### Step 2:

The user operates the terminal to input a prompt sentence.

The terminal, as input, receives characters typed by the user or speech captured by a microphone. When the input is speech, the terminal converts the audio waveform into text using a speech recognition module, and the terminal normalizes the text by applying lowercasing, punctuation correction, and character encoding normalization. As output, the terminal stores the normalized prompt sentence in memory and displays it in the text field.

### Step 3:

The terminal constructs a request message including the prompt sentence and identification information.

The terminal, as input, reads the prompt sentence from its user interface state and reads user identification data and terminal metadata from local storage. The terminal assembles these data into a structured object, for example including fields such as “prompt,” “user_id,” and “session_id,” and serializes the object into a message format suitable for network transmission. As output, the terminal produces a request payload that encapsulates the prompt sentence and context for the server.

### Step 4:

The terminal transmits the request payload containing the prompt sentence to the server.

The terminal, as input, takes the request payload and a destination address of the server. The terminal establishes a secure communication channel using a network protocol such as Transport Layer Security over Hypertext Transfer Protocol and sends the payload as the body of a request. As output, the terminal generates a network data stream that carries the prompt sentence and associated information to the server.

### Step 5:

The server receives the request and parses the prompt sentence.

The server, as input, receives the network data stream from the terminal via a network interface and forwards it to an application program. The server decapsulates the communication protocol headers, obtains the request payload, and parses the structured data to extract the prompt sentence, user identifier, and other fields. As output, the server stores these extracted values in working memory as internal variables for subsequent processing.

### Step 6:

The server authenticates the user and validates access to personal-related information.

The server, as input, receives the user identifier and authentication tokens from the parsed request. The server performs database lookups or calls an authentication service to verify that the credentials are valid and that the user is authorized to access information associated with a specific deceased person. The server applies comparison operations on stored credential hashes and access-control lists. As output, the server produces an authorization result, and if access is permitted, the server maintains an association between the user and the deceased person's personal-related information in memory.

### Step 7:

The server retrieves candidate dialogue records associated with the deceased person.

The server, as input, uses the deceased person identifier and access permissions to query a data store that holds personal-related information, including past dialogue texts, message logs, and transcribed speech. The server executes database queries with conditions on identifiers and time ranges and obtains a set of text records and associated metadata. As output, the server constructs an intermediate collection of past dialogue content items, each including text and attributes such as timestamp and topic labels.

### Step 8:

The server computes an embedding vector for the prompt sentence.

The server, as input, receives the prompt sentence as a string. The server applies a tokenizer to split the sentence into tokens and maps each token to an integer identifier. The server then passes the sequence of identifiers through an embedding model, such as a neural encoder, that performs matrix multiplications and non-linear activations to translate the token sequence into a fixed-dimensional numeric vector. As output, the server obtains a prompt embedding vector in a semantic representation space.

### Step 9:

The server performs similarity search to select relevant past dialogue content.

The server, as input, uses the prompt embedding vector and a pre-built index of embedding vectors for past dialogue content. The server computes similarity scores between the prompt embedding and stored embeddings using a metric such as cosine similarity, and uses a search algorithm such as approximate nearest neighbor search to rank stored items. As output, the server obtains a subset of past dialogue records ordered by similarity to the prompt sentence, and the server stores this ranked subset as candidate context.

### Step 10:

The server filters and formats retrieved past dialogue content for context.

The server, as input, takes the ranked subset of past dialogue records. The server applies rule-based filters, such as discarding records older than a specified threshold, records with low similarity scores, or records containing sensitive topics based on keyword matching. The server then concatenates the remaining records into formatted text segments, inserting markers to indicate speaker, time, or topic. As output, the server generates a context text block representing historically relevant statements by the deceased person.

### Step 11:

The server constructs a combined model input including system instructions, context, and the prompt sentence.

The server, as input, uses predefined system instruction text, the context text block, and the prompt sentence. The server concatenates these strings with delimiters and labels, such as “System:”, “Context:”, and “User:”. The server then applies a subword tokenizer to convert the entire combined text into a sequence of token identifiers, and calculates the length of the resulting sequence. If the length exceeds a threshold, the server truncates or summarizes earlier context segments while preserving the prompt sentence. As output, the server produces a tokenized model input sequence for the generative AI model.

### Step 12:

The server executes the generative AI model to generate response text tokens.

The server, as input, receives the tokenized model input sequence and loader configuration for the generative AI model. The server transfers the input sequence to the graphics processing unit memory and performs forward passes through the model's transformer layers, computing attention weights, activations, and output logits. The server initializes a decoding buffer and repeatedly applies a sampling algorithm, such as nucleus sampling, on the output logits to select the next token identifier at each step. As output, the server accumulates a sequence of output token identifiers representing the generated response in token form.

### Step 13:

The server converts the generated token sequence into response text data.

The server, as input, reads the output token identifier sequence from the decoding buffer. The server applies a detokenizer that maps token identifiers back to subword strings and concatenates them into a coherent text, removing special tokens and adjusting spacing and punctuation. The server optionally runs a post-processing module that corrects minor formatting issues and replaces undesired phrases according to predefined rules. As output, the server produces response text data representing a virtual reply of the deceased person.

### Step 14:

The server prepares normalized text and phoneme sequence for speech synthesis.

The server, as input, takes the response text data. The server applies text normalization rules to expand numerals, abbreviations, and dates into spoken forms, and uses a grapheme-to-phoneme converter to map characters to phoneme symbols. The server calculates phoneme durations based on linguistic rules or a duration prediction model and assembles a timed phoneme sequence. As output, the server generates normalized text and a sequence of phonemes with timing information to be used by the voice synthesis mechanism.

### Step 15:

The server generates speaker characteristic information for the deceased person.

The server, as input, retrieves stored audio recordings of the deceased person and precomputed acoustic features such as mel-spectrograms. The server passes these features through a speaker encoder network, which performs convolutional or recurrent computations to aggregate frame-level features into a fixed-dimensional speaker embedding vector. The server may reuse a stored speaker embedding if it has been computed previously. As output, the server holds a speaker characteristic vector that characterizes the voice of the deceased person.

### Step 16:

The server synthesizes audio data that reproduces the deceased person's voice.

The server, as input, uses the phoneme sequence with timing and the speaker characteristic vector. The server feeds this input into an acoustic model that converts phonemes and speaker embedding into mel-spectrogram frames by performing neural network computations, including attention or duration-based alignment and non-linear transformations. The server then passes the mel-spectrogram to a neural vocoder, which performs iterative or convolutional processing to produce a time-domain waveform. As output, the server obtains audio data in waveform form and encodes it into an audio file or stream format suitable for transmission.

### Step 17:

The server generates facial motion data based on phoneme or audio features.

The server, as input, takes the phoneme sequence and timing, or the mel-spectrogram associated with the synthesized audio. The server applies a talking-head model that transforms sequences of audio features into sequences of facial landmark positions or viseme labels. This model executes neural computations, producing per-frame displacement vectors for facial key points. As output, the server generates facial motion data describing how each facial landmark should move over time to match the speech content.

### Step 18:

The server synthesizes motion image information of the deceased person's face.

The server, as input, uses a base facial image of the deceased person and the facial motion data. The server warps the base image by moving facial regions according to landmark displacement vectors for each frame, or by conditioning an image-to-image network on the base image and motion representation. The server assembles the generated frames into a sequence with timestamps aligned to the audio. As output, the server produces motion image information in the form of a video stream or a set of encoded video frames representing the deceased person speaking.

### Step 19:

The server packages response text data, audio data, and motion image information into a response message.

The server, as input, has access to the generated response text, encoded audio stream, and encoded video stream. The server constructs a structured response object, inserting references or binary segments for each media type and adding metadata such as duration and synchronization markers. The server serializes the response object into a transmission format. As output, the server produces a response payload that encapsulates all components needed by the terminal.

### Step 20:

The server transmits the response payload to the terminal.

The server, as input, uses the response payload and session information that associates the response with the requesting terminal. The server sends the payload over the established secure communication channel, potentially using streaming protocols for large media content. As output, the server generates a network data stream directed to the terminal, carrying the response text, audio, and motion image data.

### Step 21:

The terminal receives and decodes the response payload.

The terminal, as input, obtains the network data stream from the server through its network interface. The terminal removes protocol headers, parses the structured payload, and separates the response text, audio data, and video data. The terminal initializes decoders for the audio and video formats and writes the encoded streams into decoding buffers. As output, the terminal prepares decoded frames or ready-to-decode streams and stores the response text for possible display.

### Step 22:

The terminal presents the virtual dialogue to the user.

The terminal, as input, uses the decoded or decodable audio and video streams and any associated synchronization metadata. The terminal synchronizes playback timestamps, renders the video frames on the display, and outputs the audio through the speakers or headphones. In the case of a head-mounted display, the terminal positions the video plane within a virtual or augmented scene. As output, the terminal produces visual and auditory signals that allow the user to experience the deceased person's synthesized voice and facial expressions as a coherent virtual dialogue.

### Step 23:

The user optionally continues the interaction by providing a new prompt sentence.

The user, as input, observes and listens to the virtual dialogue presented by the terminal. Based on this experience, the user decides to continue the conversation and operates the terminal to input another prompt sentence, such as “Grandpa, tell me about the time we went fishing together.” As output, the user provides a new prompt sentence to the terminal, and the terminal restarts the sequence from the earlier steps using the new input.

It is also possible to incorporate an emotion engine for estimating the user's emotions. That is, the specific processing unit 290 may estimate the user's emotions using an emotion identification model 59, and perform specific processing based on the estimated emotions.

### Example 2

Description follows regarding a flow of the specific processing in an Example 2. The units of the system described below are implemented by the data processing device 12 and the smart device 14. The data processing device 12 is called a “server” and the smart device 14 is called a “terminal”.

Conventional dialogue systems and voice synthesis systems are typically configured to generate generic responses based on large, heterogeneous datasets. Such systems often fail to reproduce individualized conversation patterns, vocal characteristics, and facial expressions of a specific person, especially a deceased person, in a consistent and realistic manner. In existing architectures, text generation, voice synthesis, and expression control are usually implemented as loosely coupled components, each optimized independently. As a result, contextual coherence between generated text, synthesized voice, and visual expression is insufficient, latency can be high due to redundant processing, and it is difficult to maintain a stable, person-specific style over multiple dialogue turns.

Furthermore, known machine learning pipelines generally treat preprocessing, model training, and inference as distinct offline and online stages. These pipelines are not designed to dynamically integrate user-provided prompt sentences with a fine-tuned generative AI model that has been trained on individual-specific conversation data, nor to jointly utilize learned speaker feature data and expression feature data at inference time. Consequently, there is a technical limitation in how efficiently and accurately a computing system can transform heterogeneous personal data (text, audio, image) into a unified, interactive experience that reproduces a particular individual's communication style.

Additionally, existing systems often rely on generic speaker models and generic avatar animation, which are not tightly conditioned on the same individual-specific linguistic model. This leads to a mismatch between the style of generated text and the style of synthesized voice and expressions. The absence of an integrated control flow in the processor also results in unnecessary data conversions and repeated feature extraction, thereby degrading computational efficiency and responsiveness of the system in real-time interactive scenarios. Accordingly, there is a need for an improved computer-implemented system and processing technique that: (i) constructs, from personal multimodal data, a coherent generative AI model, speech synthesis model, and expression reproduction model that are all conditioned on the same individual-specific features; (ii) efficiently processes prompt sentences and dialogue histories to generate person-specific response text information; and (iii) synchronously generates response audio data and expression control information in a way that improves computational efficiency, maintains style consistency across modalities, and enhances the realism and continuity of person-specific interactive communication.

The specific processing by the specific processing unit 290 of the data processing device 12 in Example 2 is realized by the following means.

The present invention provides a server comprising a processor configured to acquire individual information of a subject individual in an internal storage, construct a generative artificial intelligence environment based on the individual information, and execute a natural language processing program to generate a text information set from the individual information; perform, by using a language processing library, word segmentation processing, irrelevant term removal processing, and word form normalization processing on the text information set to generate a training text information set as preprocessed text information; input the training text information set to a generative AI model, fine-tune the generative AI model so as to reproduce a phrase pattern and a writing style pattern specific to the subject individual, and store the fine-tuned generative AI model and corresponding encoding information in a storage unit; acquire audio data of the subject individual from video information or audio information, execute an audio processing program to extract acoustic feature data from the audio data, generate speaker feature data representing a speaker characteristic of the subject individual, and construct a speech synthesis model configured to generate an audio waveform from text information by using the speaker feature data; acquire face image data of the subject individual from image information or moving image information, execute an image processing program to extract facial feature position data from the face image data, generate expression feature data indicating an expression state, and construct an expression reproduction model configured to control an expression state of a face image or a virtual image by using the expression feature data; receive, from a user terminal, a prompt sentence including an instruction sentence input by a user, generate model input information by combining the prompt sentence with dialogue history information, and input the model input information to the generative AI model to generate response text information that imitates a conversation style of the subject individual; input the response text information and the speaker feature data to the speech synthesis model to generate response audio data that imitates an audio style of the subject individual; control the expression reproduction model based on an emotional state or a content type of the response text information to generate expression control information or virtual image data that imitates an expression style of the subject individual; and transmit the response text information, the response audio data, and the expression control information or the virtual image data to the user terminal so that the user terminal reproduces a dialogue with the subject individual. This enables an integrated computer system to efficiently transform multimodal personal data into a unified, person-specific dialogue experience, in which the generated text, synthesized voice, and visual expressions are coherently conditioned on shared individual-specific features, thereby improving computational efficiency, style consistency, and realism of interactive communication compared with conventional dialogue and synthesis systems.

The term “individual information” refers to information related to a specific person, including text data, audio data, image data, video data, communication history data, and other digital records that characterize linguistic, vocal, and visual behaviors of the person.

The term “subject individual” refers to the particular person whose communication style, including language usage, voice characteristics, and facial expressions, is intended to be reproduced by the system.

The term “generative artificial intelligence environment” refers to a computing environment, including hardware resources and software components, that is configured to train, fine-tune, and execute one or more generative AI models based on input data.

The term “natural language processing program” refers to software configured to analyze, transform, and generate human language text by performing operations such as tokenization, part-of-speech tagging, lemmatization, and syntactic or semantic analysis.

The term “text information set” refers to a collection of text data derived from the individual information, including sentences, phrases, and words that represent the linguistic content produced by or associated with the subject individual.

The term “language processing library” refers to a software library that provides functions for processing natural language text, including word segmentation, stop-word removal, word form normalization, and other preprocessing operations.

The term “training text information set” refers to a subset of the text information set that has been preprocessed and is formatted for use as training data for a generative AI model.

The term “preprocessed text information” refers to text data that has undergone one or more normalization operations, including tokenization, removal of irrelevant terms, and word form normalization, to prepare the text for machine learning.

The term “generative AI model” refers to a machine learning model that is trained to generate new data, such as text, conditioned on input data, and that is capable of producing sequences of tokens or symbols representing natural language.

The term “fine-tune” refers to the process of adjusting parameters of a pre-trained generative AI model using additional training data specific to the subject individual so that the model reproduces the subject individual's characteristic patterns.

The term “phrase pattern” refers to a characteristic arrangement of words and expressions frequently used by the subject individual in conversation or writing.

The term “writing style pattern” refers to a set of stylistic features, such as word choice, sentence structure, formality level, and rhetorical habits, that consistently appear in text produced by the subject individual.

The term “encoding information” refers to data structures, including tokenization rules, vocabulary mappings, and configuration parameters, that specify how text information is converted into numerical representations for processing by a generative AI model.

The term “storage unit” refers to a hardware or software component, such as a memory device or database system, configured to store data and program code, including models and feature data.

The term “audio data” refers to digital representations of sound signals, including recorded speech of the subject individual obtained from video files, audio files, or communication records.

The term “audio processing program” refers to software configured to analyze audio data by performing operations such as filtering, feature extraction, segmentation, and normalization.

The term “acoustic feature data” refers to numerical descriptors of audio signals, such as frequency components, spectral coefficients, pitch, and energy, which characterize the sound of the subject individual's voice.

The term “speaker feature data” refers to data representing speaker-specific characteristics, such as timbre, pitch range, and speaking style, that are extracted from audio data and used to model the subject individual's voice.

The term “speech synthesis model” refers to a computational model configured to generate an audio waveform representing speech from input text information and, optionally, speaker feature data.

The term “audio waveform” refers to a time-domain representation of an audio signal that can be converted into sound by playback devices.

The term “text information” refers to data composed of characters, symbols, or tokens that represent human language content, including sentences or words generated by or input to the system.

The term “face image data” refers to image data that includes at least a facial region of the subject individual, obtained from still images or frames of moving images.

The term “image processing program” refers to software configured to analyze image or video data by performing operations such as detection, segmentation, feature extraction, and tracking of visual elements.

The term “facial feature position data” refers to data indicating positions of facial landmarks, such as eyes, mouth, nose, and eyebrows, within a face image.

The term “expression feature data” refers to data representing an expression state, such as happiness, sadness, surprise, or neutrality, inferred from facial feature positions or other visual cues.

The term “expression reproduction model” refers to a computational model configured to control or generate facial expressions of a face image or a virtual image based on expression feature data.

The term “virtual image” refers to a computer-generated visual representation, such as an avatar or synthetic face, that can be controlled to display different facial expressions.

The term “user terminal” refers to an electronic device operated by a user, such as a smartphone, tablet, or personal computer, configured to send input to and receive output from the server.

The term “prompt sentence” refers to a text string including at least one instruction sentence or query input by the user, used as input to a generative AI model to guide generation of a response.

The term “instruction sentence” refers to a sentence entered by the user that specifies a request, topic, or directive for generating a response by the system.

The term “model input information” refers to data constructed from a prompt sentence and additional context information, such as dialogue history, formatted for input to a generative AI model.

The term “dialogue history information” refers to stored data representing previous exchanges between the user and the system, including past prompt sentences and responses.

The term “response text information” refers to text generated by the generative AI model in response to model input information, intended to imitate the conversation style of the subject individual.

The term “audio style” refers to a set of characteristics of speech audio, such as voice quality, intonation, rhythm, and speaking tempo, associated with the subject individual.

The term “emotional state” refers to an inferred or designated affective condition, such as positive, negative, neutral, or specific emotions, associated with the content of response text information.

The term “content type” refers to a classification of the semantic or functional category of response text information, such as factual explanation, advice, reminiscence, or greeting.

The term “expression style” refers to a characteristic manner of facial expression and non-verbal cues, including typical patterns of smiling, frowning, or eyebrow movement, associated with the subject individual.

The term “expression control information” refers to control data that specifies how a face image or virtual image should be modified over time to display a desired facial expression corresponding to the response text information.

The term “multimodal personal data” refers to a combination of different types of data related to a person, including at least text, audio, and image or video data.

The term “person-specific dialogue experience” refers to an interactive communication session in which generated text, synthesized voice, and visual expressions are tailored to reproduce the style of a particular subject individual.

In one embodiment, a server implements a system that reproduces a subject individual's conversation style, voice characteristics, and facial expressions by executing a set of specialized software modules on general-purpose computing hardware. The server uses a processor, a main memory, a non-volatile storage device, and one or more accelerators such as graphics processing units (GPUs). The server runs an operating system, a programming language runtime such as a Python environment, and machine learning frameworks such as a tensor computation framework implementing a transformer-based generative AI model. The server communicates with at least one terminal operated by a user via a network such as the Internet.

The server acquires individual information of a subject individual from various data sources.

The server obtains text-based communication history, including email logs, social messaging logs, and social network posts, from external storage or application interfaces. The server also obtains audio data including speech of the subject individual from stored audio files or from video files by extracting audio tracks. The server further obtains face image data from still images and video frames containing the subject individual. The server stores the acquired data into structured data repositories, for example, a relational database and a file system with directory structures organized by data type (text, audio, image) and by time or source.

The server executes a natural language processing program implemented in a scripting language environment. The server loads the text information from the repository and performs tokenization, stop-word removal, and word form normalization using language processing libraries such as commonly available natural language toolkits. The server represents each sentence as a sequence of tokens, and stores the sequences along with metadata, such as timestamp and conversation participant identifiers, in a training text information set. The server normalizes character encodings, converts characters to a unified representation (for example, lowercasing in certain languages and normalizing punctuation), and removes non-informative elements such as standalone URLs or emoticons that do not contribute to language modeling.

The server constructs a generative AI model based on a transformer neural network architecture, such as an autoregressive language model with multiple attention layers, feed-forward sublayers, and residual connections. The server initializes the model with pre-trained parameters obtained from large-scale language training on generic corpora. The server then fine-tunes this model using the training text information set derived from the subject individual's past communications. The server encodes tokens using a fixed vocabulary and a positional encoding scheme, and computes a loss function such as cross-entropy between predicted token distributions and actual tokens for each position in the sequence.

The server executes an optimization algorithm such as stochastic gradient descent or an adaptive gradient method to update model parameters. The server distributes the computation across one or more GPUs, where matrix multiplications and attention computations are executed in parallel. The server monitors validation loss on a held-out subset of the training text information set to prevent overfitting. By constraining the training to the subject individual's text samples and by using the same tokenizer and encoding information throughout, the server generates a fine-tuned generative AI model that encodes phrase patterns and writing style patterns characteristic of the subject individual.

The server thereby improves computational efficiency and style consistency compared with naive approaches. Instead of repeatedly re-processing generic models or requiring manual rule encoding, the server reuses shared parameterization and encoding structures for all inference runs. The integration of preprocessing, fine-tuning, and inference in a unified pipeline reduces memory transfers and redundant computations, which leads to faster processing of prompt sentences and lower energy consumption on the server hardware.

The server also constructs a speech synthesis model that is specific to the subject individual.

The server executes an audio processing program that segments and analyzes audio data of the subject individual. The server uses signal processing algorithms to perform operations such as noise reduction, trimming of silence segments, and normalization of audio amplitude.

The server extracts acoustic feature data such as mel-frequency cepstral coefficients, pitch contours, and energy profiles. The server then computes speaker feature data representing a speaker embedding that captures timbre, speaking rate, and other voice characteristics.

The server uses the speaker feature data to condition a text-to-speech neural network, such as a sequence-to-sequence model that maps character or phoneme sequences to spectrogram representations. The server couples this model with a neural vocoder that converts spectrograms to waveform audio samples. During training or adaptation, the server uses loss functions such as L1 or L2 distance on spectrograms and adversarial or perceptual losses for waveform quality. The server computes gradients and updates speech synthesis model parameters so that the model reconstructs waveforms that closely approximate the subject individual's original recordings. This process yields a speech synthesis model that can generate new audio from arbitrary text while preserving the subject individual's audio style.

The server further constructs an expression reproduction model to control facial expressions of a face image or a virtual image. The server executes an image processing program that detects facial regions, extracts facial landmarks such as eye corners, mouth corners, and eyebrow positions, and estimates expression feature data such as smile intensity, mouth openness, and eyebrow raise. The server encodes sequences of expression feature data over time into a state representation usable by a facial animation module. The server may train a neural network model that maps input text and emotion labels to expression control parameters for a virtual avatar.

The server thereby creates a shared representation among the fine-tuned generative AI model, the speech synthesis model, and the expression reproduction model. The server uses consistent speaker feature data and expression feature data so that text, audio, and visual outputs are all conditioned on common individual-specific features. This joint conditioning leads to improved coherence and reduces the need for separate, manually curated rules to synchronize mouth movements, voice tone, and textual content. The tight coupling of models also improves computational efficiency, since the server can compute shared features once and reuse them across subsystems.

The user operates a terminal, such as a smartphone, a tablet, or a personal computer, to interact with the server. The terminal executes an application or a web browser that provides a graphical user interface. The user inputs a prompt sentence, for example:

“I want to talk about traveling.”

“Can you give me some advice about my new job?” “Do you remember the trip we took to the seaside?”

“I feel lonely today. Can you talk with me for a while?”

“What kind of books do you think I should read next?”

The terminal converts the user's input into a text string and sends it to the server, optionally with additional context such as a conversation identifier. The terminal receives from the server response text information, response audio data, and, where applicable, expression control information or virtual image data, and the terminal displays the response text, plays the synthesized voice, and animates a face image or avatar according to the expression control information.

The server processes prompt sentences by constructing model input information that combines the current prompt sentence with dialogue history information. The server may represent dialogue history as a sequence of speaker-tagged utterances, truncated to a fixed token length for efficient processing. The server prefixes or inserts control tokens indicating the role (“subject individual” versus “user”), style constraints, and emotional guidance. By encoding these elements as explicit tokens in the same embedding space, the server allows the generative AI model to condition its outputs on dialogue context and style constraints without additional rule-based systems.

During inference, the server feeds the model input information through the attention-based layers of the fine-tuned generative AI model. The server uses decoding strategies such as top-k sampling or nucleus sampling with threshold parameters to balance diversity and adherence to the subject individual's learned style. This is a non-conventional decoding regime compared to purely deterministic greedy decoding, because it is parameterized to preserve idiosyncratic expressions while reducing generation of out-of-character outputs. The server posts processes the generated token sequence by applying filters that check for maximum length, remove incomplete sentence fragments, and optionally insert known phrase patterns that the subject individual frequently used, based on a phrase statistics table computed during training.

The server then uses the response text information as input to the speech synthesis model and the expression reproduction model. The server applies a text analysis step to segment the response text into phoneme sequences and clauses. The server assigns emotional state labels or content type labels, for example by computing sentiment scores or matching keyword patterns. These labels are used to adjust prosody in the speech synthesis model and expression intensity in the expression reproduction model. The server generates the response audio data as a waveform array and the expression control information as a time-aligned sequence of facial parameter vectors, each indicating mouth shape, eye openness, and other facial attributes.

The server's internal data structures and processing order bring several technical advantages. Because the server unifies data representations for text tokens, speaker feature data, and expression feature data, the server reduces conversion overhead between modules. The server stores preprocessed data and model parameters in optimized formats that reduce memory footprint and cache misses during inference. The server's use of hardware accelerators for both the generative AI model and the speech synthesis model allows the system to generate coherent multi-modal responses with low latency, which is critical for interactive use over networks with variable latency.

From a computer technology standpoint, the system improves not only the automation of a human communication task but also the underlying computational processes. By designing the generative AI model, speech synthesis model, and expression reproduction model to share individual-specific conditioning vectors and by coordinating their inference pipelines, the server reduces redundant computations that would otherwise occur in separate, loosely coupled systems. This reduction manifests as fewer passes through separate feature extractors, fewer memory copies, and better utilization of vectorized operations on GPUs. The result is faster processing of each prompt sentence, lower network bandwidth usage due to compact representation of expression control information rather than raw video, and improved consistency of outputs across successive dialogue turns.

In additional embodiments, the server may implement alternative model architectures. For example, the generative AI model can be a decoder-only transformer or an encoder-decoder transformer, with adjustable numbers of layers and attention heads. The server can use different tokenization schemes such as byte-pair encoding or unigram language models, with vocabulary sizes tuned for the subject individual's language mix. The speech synthesis model can be replaced by different neural architectures that map text or phonemes to spectrograms, and the vocoder can employ different generative models. The expression reproduction model may be implemented as a graph-based neural network that directly predicts facial vertex displacements for a 3D avatar mesh, or as a parameter generator for a pre-defined blendshape system.

In further variants, the server may perform data augmentation on the training text information set by generating paraphrases, augmenting punctuation, or injecting controlled noise, and then fine-tuning the generative AI model with these augmented samples. This strengthens the model's robustness to diverse prompt sentence formulations and reduces the risk of overfitting. Similarly, the server may augment audio data by pitch shifting or time stretching within ranges that preserve perceived identity, thus improving the generalization of the speech synthesis model. These data augmentation processes are algorithmically controlled and executed internally by the server, not by human operators, and are optimized for machine learning performance measured by objective metrics such as word error rates or spectral distances.

The system is thus not limited to a particular user interface or a particular business process. The technical contribution resides in the internal configuration and cooperation of the server-side modules and data structures that transform multimodal personal data into coherent multimodal outputs conditioned on learned individual-specific features. The tight integration of natural language processing, model fine-tuning, neural network inference, audio feature extraction, speech synthesis, facial feature extraction, and expression control improves the computational performance, precision, and resource utilization of the computing platform itself. As a result, the server executes a sequence of machine-implemented operations that could not be feasibly replicated by manual human processes and that go beyond the mere automation of known mental steps, thereby providing a concrete improvement in computer technology.

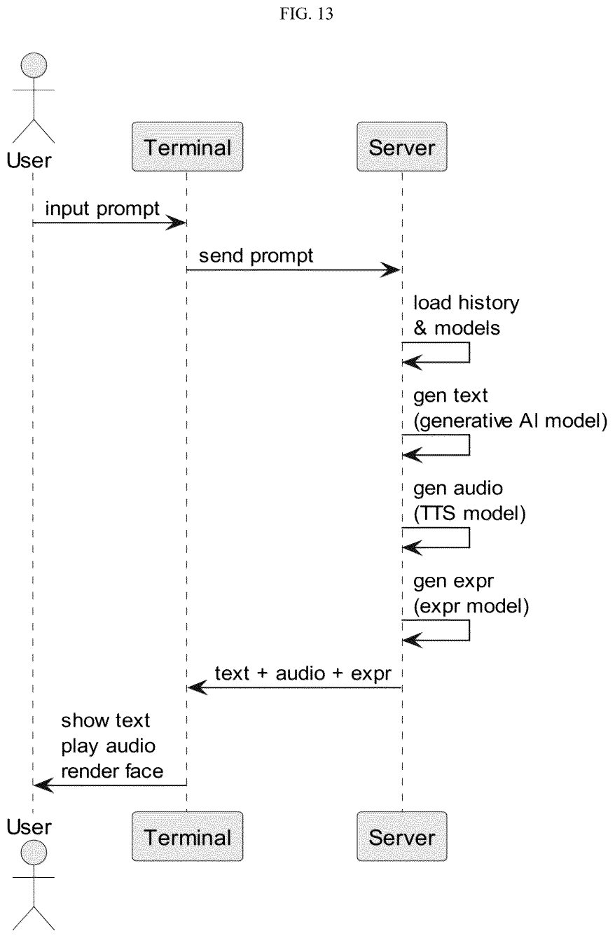

The following describes the processing flow using FIG. 13.

### Step 1:

The server acquires individual information of a subject individual.

The server receives, as input, raw data including text logs (emails, messages, posts), audio files or video files containing the subject individual's speech, and images or video frames containing the subject individual's face.

The server parses the raw files, extracts text segments, audio tracks, and image frames, and stores them in separate repositories in a structured format, such as a text table for sentences, an audio file list with metadata, and an image table for face images.

The server outputs structured individual information organized by modality (text, audio, image) and linked with identifiers and timestamps.

### Step 2:

The server preprocesses textual data to generate a training text information set.

The server uses the stored text segments as input and executes a natural language processing program.

The server performs tokenization, stop-word removal, and word form normalization on each sentence using a language processing library.

The server converts each sentence into a sequence of normalized tokens, removes noise such as URLs and emojis, and filters out extremely short or empty sentences.

The server outputs a training text information set that consists of token sequences and corresponding original sentences with associated metadata.

### Step 3:

The server constructs and fine-tunes a generative AI model based on the training text information set.

The server uses, as input, the token sequences from the training text information set and a pre-trained transformer-based language model with initial parameters and a predefined tokenizer.

The server encodes each token sequence into integer token IDs, applies positional encodings, and feeds them into the neural network to compute predicted token distributions at each position.

The server calculates a loss value such as cross-entropy between the predicted distributions and the actual tokens, and updates model weights using an optimization algorithm such as stochastic gradient descent or an adaptive gradient method executed on a GPU.

The server iteratively repeats this training process over multiple epochs, monitors validation loss on a held-out subset, and stops training when performance stabilizes or degrades.

The server outputs a fine-tuned generative AI model and associated encoding information (tokenizer configuration and vocabulary) stored in a model repository.

### Step 4:

The server preprocesses audio data to generate speaker feature data and to construct a speech synthesis model.

The server uses, as input, audio tracks containing the subject individual's speech extracted from audio or video files.

The server executes an audio processing program to perform noise reduction, silence trimming, and amplitude normalization on each audio segment.

The server computes acoustic features such as mel-spectrograms, pitch contours, and energy profiles from the processed waveforms.

The server aggregates these acoustic features and applies a speaker embedding algorithm to derive speaker feature data that captures voice characteristics such as timbre and speaking style.

The server trains or adapts a text-to-speech neural network and a vocoder, using pairs of text transcriptions and corresponding acoustic features, and optimizes model parameters so that generated speech waveforms approximate the original recordings.

The server outputs speaker feature data and a speech synthesis model capable of generating waveforms from text and the speaker feature data.

### Step 5:

The server preprocesses face image data to generate expression feature data and to construct an expression reproduction model.

The server uses, as input, face image data or video frames containing the subject individual's face.

The server executes an image processing program to detect the face region in each image and to extract facial landmark positions such as eyes, nose, mouth, and eyebrows.

The server computes expression feature data by mapping landmark configurations to expression parameters, including mouth openness, smile intensity, eyebrow raise, and eye openness.

The server associates these parameters with emotion labels or expression categories and trains an expression reproduction model that maps text-related or emotion-related inputs to expression control parameters.

The server outputs expression feature data and an expression reproduction model capable of generating expression control information or virtual image data.

### Step 6:

The server constructs and maintains dialogue history information for each user session.

The server uses, as input, previously generated response text information and previously received prompt sentences associated with a session identifier.

The server stores each utterance with speaker tags (user or subject individual), timestamps, and tokenized representations in a dialogue history store.

The server applies truncation or summarization algorithms to limit the length of the stored history while preserving key context such as topics and emotional tone.

The server outputs updated dialogue history information that is ready to be combined with a new prompt sentence.

### Step 7:

The user operates a terminal to input a prompt sentence.

The user sees a user interface on the terminal and types or speaks an instruction sentence, such as “I want to talk about traveling.” or “Can you give me some advice about my new job?”

The terminal converts speech input to text if needed, encodes the text as a prompt sentence, and attaches session and user identifiers.

The terminal outputs a request containing the prompt sentence and context identifiers and sends this request to the server via a network connection.

### Step 8:

The server constructs model input information from the prompt sentence and dialogue history.

The server uses, as input, the received prompt sentence and the corresponding dialogue history information retrieved by the session identifier.

The server concatenates the latest dialogue turns and the current prompt sentence into a single text sequence, inserting special role tokens to distinguish user utterances from subject individual utterances.

The server may prepend system-level control tokens that specify generation constraints such as politeness, emotional tone, or topic focus.

The server tokenizes the combined sequence using the tokenizer associated with the fine-tuned generative AI model and produces a sequence of token IDs.

The server outputs model input information consisting of token IDs, role markers, and optional control tokens for use in inference.

### Step 9:

The server generates response text information using the generative AI model.

The server uses, as input, the model input information (token IDs and control tokens) and the fine-tuned generative AI model parameters.

The server computes hidden states through the transformer layers, applying self-attention and feed-forward operations for each token position.

The server uses a decoding strategy such as top-k sampling or nucleus sampling to select output tokens step-by-step, thereby generating a continuation of the text in the style of the subject individual.

The server stops generation when an end-of-sequence token or a maximum length is reached and converts the generated token IDs back into a text string.

The server may perform post-processing, including trimming incomplete sentences, enforcing consistent punctuation, and optionally injecting characteristic phrases frequently used by the subject individual based on stored phrase statistics.

The server outputs response text information representing the subject individual's simulated reply.

### Step 10:

The server generates response audio data using the speech synthesis model.

The server uses, as input, the response text information and the speaker feature data specific to the subject individual.

The server performs text analysis to convert the response text into phoneme or character sequences and associates prosody markers based on punctuation and emotional cues.

The server feeds the phoneme sequences and speaker feature data into the speech synthesis model to generate intermediate acoustic representations, such as mel-spectrograms, and then uses a vocoder to synthesize time-domain audio waveform samples.

The server normalizes loudness and optionally encodes the waveform into a compressed audio format suitable for transmission.

The server outputs response audio data that acoustically resembles the subject individual's voice.

### Step 11:

The server generates expression control information or virtual image data using the expression reproduction model.

The server uses, as input, the response text information and, optionally, an inferred emotional state or content type derived from the text.

The server computes emotion scores or content categories based on sentiment analysis or keyword matching and provides these as control inputs to the expression reproduction model.

The server generates a time-aligned sequence of facial control parameters that specify mouth movements, eye blinks, eyebrow motions, and other facial expressions synchronized with the expected speech timing.

The server may apply these parameters to a base face image or a 2D/3D avatar model to generate virtual image data frames.

The server outputs expression control information or virtual image data suitable for rendering at the terminal.

### Step 12:

The server transmits multimodal response data to the terminal.

The server uses, as input, the response text information, response audio data, and expression control information or virtual image data.

The server packages these elements into a response message, attaching identifiers for synchronization and any necessary metadata such as audio format and frame timing.

The server sends the response message over a network protocol to the terminal associated with the user session.

The server outputs transmitted data that enable the terminal to reconstruct and present the subject individual's simulated response.

### Step 13:

The terminal presents the response to the user.

The terminal uses, as input, the received response text information, response audio data, and expression control information or virtual image data.

The terminal displays the response text in a chat or dialogue view, appends it to the conversation history, and parses the audio and expression data.

The terminal plays the response audio through a speaker or headphones and renders a face image or avatar, updating facial expressions and lip movements according to the expression control information or virtual image frames.

The terminal outputs a multimodal presentation that allows the user to experience a dialogue with the subject individual.

### Step 14:

The user continues the interaction based on the presented response.

The user observes the displayed text, listens to the synthesized voice, and watches the facial expressions on the terminal.

The user decides on a follow-up prompt sentence, such as “Do you remember the trip we took to the seaside?” or “What kind of books do you think I should read next?”, and inputs it via the terminal interface.

The user thereby initiates a new cycle of processing, and the terminal again outputs a new request with the prompt sentence to the server, leading back to the server-side steps for generating a subsequent response.

### Application Example 2

Description follows regarding a flow of the specific processing in an Application Example 2. The units of the system described below are implemented by the data processing device 12 and the smart device 14. The data processing device 12 is called a “server” and the smart device 14 is called a “terminal”.

Conventional dialogue systems and media playback systems are typically configured as a loose combination of independent components such as a speech synthesizer, a text chatbot, and a simple avatar renderer. These systems mainly operate in a request-response manner, where user input is directly mapped to an output sentence or media clip. Such architectures suffer from several technical limitations.

First, conventional systems do not deeply integrate a generative AI model with a structured prompt design mechanism and a persistent dialogue history management mechanism. As a result, the systems are unable to maintain long-term conversational coherence or to adapt the generative behavior of the model based on accumulated interaction data. The generative model is usually invoked with shallow, stateless input, which leads to inconsistent persona reproduction and unstable response quality.

Second, existing systems generally handle voice, text, and facial expression generation as separate pipelines without a common context representation. There is no unified control logic that uses a single context, including user emotion, subject attributes, and dialogue history, to jointly drive a language model, a voice generation model, and an image generation model. Consequently, the synthesized voice prosody, the generated facial expression, and the textual content are often not synchronized in timing or affect, which deteriorates the realism and usability of the human-computer interaction.

Third, many systems treat user emotion recognition as an optional, external analytics function rather than as a first-class control signal in the core generation loop. Emotion estimates, if collected at all, are not systematically fed back into the generative AI model through carefully constructed prompt sentences, nor are they used to dynamically adjust parameters of the voice and image generation models. This results in a static interaction style that does not respond to user state, and fails to leverage emotion as a control dimension to improve the responsiveness and stability of the overall pipeline.

Fourth, typical architectures do not provide a feedback-driven improvement loop at the system level. User evaluations and real interaction data are not effectively used to select high-quality outputs and incrementally fine-tune the underlying models. Each component is often retrained offline in isolation, without exploiting structured dialogue histories and explicit user ratings as training signals. This leads to slow adaptation, persistent model errors, and inefficient use of computational resources.

Accordingly, there is a need for a computer-implemented system that improves the internal information processing architecture for multimodal dialogue generation. In particular, there is a need for: (i) a processor-controlled generative environment in which prompt sentences, context information, and dialogue histories are managed as first-class data structures; (ii) integrated control over a generative AI model, a voice generation model, and an image generation model based on common context and emotion signals; and (iii) a feedback loop that uses recorded dialogue histories and user evaluation information to continuously refine the models. By addressing these issues, the invention aims to improve the technical performance of computer-based dialogue systems, including stability and consistency of generated outputs, synchronization between modalities, and adaptability of generation behavior to user state, thereby providing a concrete improvement in computer technology rather than a mere automation of human conversation.

The specific processing by the specific processing unit 290 of the data processing device 12 in Application Example 2 is realized by the following means.

The present invention provides a server comprising a processor configured to manage an internal generative processing environment that stores person-related information and learning information, to generate and input structured prompt sentences to a generative AI model based on context information including subject attributes, dialogue history, and user emotion state, to coordinate operation of the generative AI model, a voice generation model, and an image generation model so as to generate, in an integrated manner, response text, corresponding audio information, and corresponding expression information, to dynamically adjust prosody parameters and visual expression parameters according to an estimated user emotion state obtained from user audio and image information, and to record dialogue history information including user utterance information, response sentences, emotion states, and generated multimodal output so that the recorded dialogue history information and user evaluation information are used to selectively update parameters of the generative AI model, the voice generation model, and the image generation model. This enables a computer system to improve internal control of generative models by using context-rich prompt sentences, to maintain coherent and synchronized multimodal dialogue behavior over successive interactions, and to continuously enhance reproduction accuracy and responsiveness of the models through feedback-driven learning, thereby achieving a concrete improvement in the functioning of dialogue-oriented information processing systems.

The term “server” refers to an information processing apparatus including at least one processor and at least one memory, configured to execute programs for performing generative processing, dialogue control, and multimodal content generation and distribution.

The term “processor” refers to a hardware computation unit, such as a central processing unit or an accelerator, that executes instructions to implement the functions of the generative processing environment, model control, and data management described in the system.

The term “person-related information” refers to data associated with a particular individual, including, but not limited to, text data, audio data, image data, video data, and metadata that describe attributes, behavior, or communication content of the individual.

The term “generative processing environment” refers to a software and hardware execution environment in which a generative AI model, a voice generation model, and an image generation model are deployed, managed, and supplied with learning information, prompt sentences, and context information for generating new data.

The term “generative AI model” refers to a machine learning model, such as a probabilistic or neural network model, configured to generate new text, audio, or image data based on input data including prompt sentences and context information.

The term “voice generation model” refers to a machine learning model or signal processing model configured to generate audio information imitating a voice style of a subject based on input text, feature information, or control parameters.

The term “image generation model” refers to a machine learning model configured to generate static image information or video information representing a face or expression of a subject based on input feature information, expression-state information, or control parameters.

The term “learning information” refers to processed data, feature data, model parameters, and auxiliary data that are used to train, fine-tune, or update a generative AI model, a voice generation model, or an image generation model.

The term “prompt sentence” refers to structured textual input provided to a generative AI model, the voice generation model, or the image generation model, which specifies an instruction, context, or condition for controlling a generation operation of the model.

The term “recorded media” refers to a storage medium or stored data that includes at least one of audio information, image information, or video information of a subject, such as a digital audio file, a digital image file, or a digital video file.

The term “subject” refers to an individual whose conversation style, voice style, and expression style are to be reproduced by the system, and for whom person-related information is stored and processed.

The term “subject voice information” refers to audio data representing the voice of the subject, including speech segments extracted from recorded media.

The term “subject image information” refers to image data or video frame data representing the appearance of the subject, including face regions, head regions, and associated visual features.

The term “feature information” refers to numerical or symbolic data representing characteristics extracted from raw data, such as acoustic features derived from audio information or visual features derived from image information.

The term “character-string information” refers to textual data, such as character sequences or tokens, representing words, phrases, or sentences corresponding to speech content of the subject.

The term “audio information” refers to digital data representing sound, including synthesized speech waveforms generated by a voice generation model.

The term “image information” refers to digital data representing a static visual frame, such as a single image of a face or an expression generated by an image generation model.

The term “video information” refers to digital data representing a temporal sequence of visual frames, including animated facial expressions or avatar movements synchronized to audio information.

The term “image processing technology” refers to algorithms and software operations used to analyze or transform image data or video data, including face detection, landmark extraction, alignment, and expression classification.

The term “audio processing technology” refers to algorithms and software operations used to analyze or transform audio data, including speech recognition, feature extraction, voice activity detection, and prosody analysis.

The term “expression-state information” refers to data indicating a facial expression or emotional state of a subject, such as smiling, neutral, surprised, or sad, and may be represented as labels, probabilities, or continuous parameters.

The term “face portion” refers to a region of an image or video frame that includes at least the subject's eyes, nose, and mouth, and is used for analysis and generation of facial expressions.

The term “user terminal” refers to an electronic apparatus, such as a portable information terminal or a head-mounted display, through which a user inputs information and receives audio information and expression information from the server.

The term “user utterance information” refers to data representing a user's spoken or written input, including transcribed text obtained from speech recognition or text directly input through an interface.

The term “dialogue process” refers to a sequence of operations in which user utterance information and system responses are exchanged, and in which context information is updated and used to control generative models.

The term “context information” refers to a data structure that includes at least subject attribute information, dialogue history information, and user emotion-state information, and that is used to condition generation by the generative AI model, the voice generation model, and the image generation model.

The term “subject attribute information” refers to data describing characteristics of the subject, such as age, relationship to the user, typical speaking style, or typical expression style.

The term “dialogue history information” refers to stored data representing past user utterance information, system response sentences, emotion states, and generated audio and expression outputs in one or more dialogue sessions.

The term “response sentence” refers to textual data generated by the generative AI model as a reply to user utterance information, conditioned on context information and configured to impersonate the subject.

The term “expression information” refers to data defining a facial expression or visual state associated with a response sentence, including static expression labels, image data, or animation parameters for a visual representation.

The term “user audio information” refers to audio data acquired from the user, including speech signals that can be used for emotion estimation and interaction control.

The term “user image information” refers to image or video data capturing the user, including facial images used for emotion estimation and interaction control.

The term “emotion determination model” refers to a computational model configured to estimate an emotion state of a user based on input data such as user audio information, user image information, or user text.

The term “user emotion state” refers to a classification or representation of the user's emotional condition, such as happiness, sadness, calmness, fatigue, or excitement, derived by the emotion determination model.

The term “prosody” refers to temporal and acoustic characteristics of speech, including pitch, speaking rate, intonation contour, and emphasis, which can be adjusted in the voice generation model.

The term “expression type” refers to a category or specification of a facial expression, such as smiling, frowning, or neutral, selected or generated by the image generation model.

The term “motion parameters” refers to numerical values controlling dynamic aspects of a visual representation, such as lip movement, eye blinking, head nodding, and other gesture-related variables.

The term “dialogue session” refers to a period of interaction between a user and the system, including one or more turns of user utterances and system responses, for which dialogue history information is recorded.

The term “evaluation information” refers to data obtained from a user that indicates a quality assessment of generated outputs, such as ratings, feedback labels, or annotations specifying whether a response is appropriate.

The term “additional learning information” refers to newly provided person-related information, interaction data, or annotated data that is used, in addition to existing learning information, to further train or fine-tune one or more models.

The term “portable information terminal” refers to a handheld or wearable electronic device capable of wireless communication and user interaction, such as a smartphone, a tablet, or a similar device.

The term “head-mounted display” refers to a display apparatus configured to be worn on a user's head and to present visual information, including virtual or augmented reality, in synchronization with audio information.

The term “virtual dialogue presentation” refers to a user-perceived representation of a dialogue with the subject, including at least synthesized audio information and associated facial expression or avatar imagery displayed on a user terminal.

In one embodiment, a server includes at least one processor, at least one memory, a non-transitory storage device, and one or more hardware accelerators such as graphics processing units. The server executes a program that configures a generative processing environment. The server stores person-related information, learning information, model parameters, and dialogue history information in a structured data store implemented by a relational database system and an object storage system.

The server uses a software stack comprising an operating system, a database management system, and a machine learning framework such as a tensor-based neural network library.

The server further uses auxiliary libraries for audio processing, image processing, and natural language processing. Examples of such auxiliary libraries include a generic multimedia processing library for decoding media files, an image processing library for face detection and landmark extraction, and a natural language toolkit for tokenization and parsing.

The server stores person-related information including text logs, audio recordings, image files, and video files. The server generates and maintains learning information in the form of feature matrices, token sequences, and labeled datasets derived from the person-related information. The server encodes the learning information into numerical tensors that are suitable for input to a generative AI model, a voice generation model, and an image generation model.

The server implements the generative AI model as a neural network having a transformer architecture. The server configures the transformer to include multiple self-attention layers, feed-forward layers, and normalization layers. The server represents tokens of text as dense vectors using an embedding matrix and applies positional encodings to represent token order.

The server uses this generative AI model to map a prompt sentence and context information to a probability distribution over output tokens, and generates a response sentence by iterative sampling or beam search.

The server implements the voice generation model as a sequence-to-sequence network that converts text tokens into an acoustic representation, such as a mel-spectrogram, and a separate neural vocoder that converts the acoustic representation into a waveform. The server configures the sequence-to-sequence network with an encoder that processes input text embeddings and a decoder that predicts acoustic frames while attending to encoder states.

The server configures the vocoder as an autoregressive or flow-based network that generates waveforms conditioned on acoustic frames and speaker-specific embeddings.

The server implements the image generation model as a generative adversarial network or a diffusion-based network. The server configures a generator network to produce image tensors representing facial regions and an associated discriminator or denoising network to enforce realism and consistency with conditioning information. The server supplies expression-state information and subject identity embeddings as conditioning inputs to the image generation model so that the model generates facial images or sequences of frames that reflect specific expressions and subject characteristics.

The server executes a feature extraction pipeline for audio data. The server decodes audio streams from uploaded video files, converts them to a uniform sampling rate, and segments them into speech regions. The server computes acoustic features including mel-frequency cepstral coefficients, pitch contours, and energy values. The server stores these features together with aligned text transcripts so that the voice generation model can be trained and later adapted to the subject's voice style.

The server executes a feature extraction pipeline for image and video data. The server decodes video frames, detects faces using a convolutional classifier, and computes facial landmarks. The server aligns facial images by rotation and scaling so that eyes and mouth occupy consistent positions. The server computes expression-state information as labels or vectors by applying an expression classifier over the aligned faces. The server uses these aligned faces and expression labels as training data for the image generation model.

The server executes a text processing pipeline for conversation data. The server reads message logs and speech transcripts, normalizes character encodings, removes non-speech markup, and segments the data into utterances. The server assigns speaker labels to utterances and constructs dialogue history entries that represent sequences of user utterances and subject responses. The server tokenizes each utterance using a subword tokenizer and stores token sequences in the learning information.

The server trains or fine-tunes the generative AI model using the tokenized dialogue histories.

The server defines a loss function based on cross-entropy between predicted token distributions and actual next tokens. The server performs gradient-based optimization, such as stochastic gradient descent with adaptive learning rates, to update model parameters. The server periodically evaluates the model on held-out dialogues and retains model checkpoints that yield improved perplexity and stylistic similarity to the subject's conversation style.

The server trains or fine-tunes the voice generation model using aligned text and acoustic features. The server defines a loss function that includes a reconstruction term for acoustic frames and, optionally, auxiliary losses for pitch and duration prediction. The server updates the network weights to minimize the loss using gradient descent. The server embeds speaker identity as a trainable vector and constrains the training so that the generated acoustic representations maintain the subject's timbre, intonation patterns, and rhythm.

The server trains or fine-tunes the image generation model using aligned face images and expression-state information. The server defines an adversarial loss, a reconstruction loss, and a conditional consistency loss that encourages the generator to produce faces with the specified expression state. The server updates generator and discriminator parameters in alternating steps. In a diffusion-based alternative, the server defines a denoising objective that reconstructs clean images from noisy inputs conditioned on subject identity and expression-state vectors.

The server implements an emotion determination model to estimate a user emotion state. The server receives user audio information and user image information from the terminal. The server extracts prosodic features from audio, such as pitch variance and speaking rate, and visual features from images, such as facial action unit intensities. The server inputs these features to a classifier network, such as a recurrent network or a convolutional network, trained to output emotion labels or continuous affect scores. The server stores the estimated user emotion state together with a time stamp and the associated user utterance information.

The server constructs context information for each turn of a dialogue. The server aggregates subject attribute information, recent dialogue history information, and the current user emotion state into a structured data object. The server serializes this context information into a prompt sentence that conditions the generative AI model. For example, the server may construct a prompt sentence such as:

“Act as the deceased grandfather. The user is currently sad. Use his characteristic warm, gentle tone and recall a shared memory from past family trips. User just said: ‘I feel tired today and I miss you.’ Respond in one or two sentences.”

The server inputs this prompt sentence and prior dialogue tokens to the generative AI model and generates a response sentence that is statistically consistent with the subject's learned style and the given context.

The server converts the response sentence into audio information by supplying the text and control parameters to the voice generation model. The server uses the user emotion state to modify prosody parameters such as speaking rate, pitch range, and amplitude. For example, in response to a detected sad emotion, the server decreases the speaking rate and pitch variability and increases the duration of pauses. The server thereby generates a waveform that not only imitates the subject's vocal characteristics but also reflects an affective response appropriate to the user's state.

The server generates expression information associated with the response sentence. The server selects or predicts an expression type, such as a gentle smile or a concerned expression, aligned with both the response semantics and the user emotion state. The server inputs the subject identity vector and the expression-state vector to the image generation model, which outputs either a static face image or a sequence of frames. Alternatively, the server computes motion parameters including lip synchronization coefficients, eye-blink schedules, and head motion trajectories for an existing avatar rig.

The terminal operates as the user interface device. The terminal includes a display, a microphone, a camera, and a communication interface. The terminal executes an application that sends user utterance information and user image and audio streams to the server and receives generated audio information and expression information in return. The terminal presents the audio through speakers or headphones and renders the facial image, video, or avatar animation on the display or a head-mounted display.

The user interacts with the system by speaking or typing messages addressed to the subject. The user may, for example, utter “Grandpa, please tell me about our old trip to Hokkaido” or “I am very happy today because something good happened.” The terminal captures the utterance, displays it to the user, and forwards the utterance and corresponding media to the server. The user can also explicitly input prompt sentences for specific operations such as:

“Generate a new smiling picture of him based on this photo.”

or

“Say ‘Thank you for everything’ in his usual way.”

The server interprets such instructions as prompt sentences to the respective generative AI model and performs image or voice generation accordingly.

The server records each dialogue session in dialogue history information. The server stores user utterance information, generated response sentences, associated emotion states, and pointers to the generated audio files and image or animation data. The server uses this dialogue history information to construct richer context information for subsequent turns, enabling the generative AI model to maintain long-range coherence and consistent persona.

The server also records user evaluation information when available, such as ratings or explicit feedback regarding the quality or authenticity of responses.

The server uses the recorded dialogue history information and user evaluation information to refine the models. The server selects high-scoring response pairs and uses them as additional learning information in periodic fine-tuning sessions. The server adjusts training weights to reduce errors on sequences where the model previously produced less satisfactory results. By doing so, the server improves reproduction accuracy of conversation style, voice style, and expression style over time. This fine-tuning process modifies internal model parameters and thus directly changes the way the computer processes future inputs.

The system achieves technical improvements beyond mere automation of human conversation. The server's use of structured context information and prompt sentences reduces redundant computation by enabling the generative AI model to condition on compressed representations of past dialogue rather than recomputing from raw history. The server's emotion-dependent prosody and expression control allows the voice generation model and image generation model to share a common control signal, which improves synchronization between audio and visual outputs and reduces temporal misalignment artifacts.

The server's internal data structures, including tokenized dialogue histories, emotion-state traces, and subject-specific embeddings, enable efficient indexing and retrieval of relevant context for long-running sessions. This reduces memory footprint and latency compared to naïve approaches that reprocess all previous utterances. The combination of feedback-driven model updating and dynamically generated prompt sentences further improves generation accuracy with fewer training iterations, thereby improving computation efficiency.

The system processes multimodal signals using rules and architectures that are not conventional in manual workflows. The server uses non-linear transformations and learned attention mechanisms to determine which parts of the dialogue history and which aspects of the user's current emotion are most relevant for each response. The server applies explicit weighting schemes in the attention layers to favor recent utterances, emotionally salient moments, or subject-specific key phrases. Such processing strategies are not simple digital reproductions of human heuristic rules but are implemented as numeric operations optimized to minimize explicit loss functions.

In another embodiment, the server distributes processing between central processing units and graphics processing units to further improve throughput. The server assigns model inference operations for the generative AI model, the voice generation model, and the image generation model to the graphics processing units, while the central processing units handle data preprocessing, context assembly, and prompt sentence construction. This division of tasks reduces contention and allows multiple dialogue sessions to be served concurrently with low latency.

In a further embodiment, the server compresses generated audio information and expression information before transmitting them to the terminal. The server applies bandwidth-aware encoding, such as variable bitrate audio codecs and image compression schemes, while preserving synchronization through time stamps and phoneme alignment marks. This reduces communication load without sacrificing temporal accuracy between audio and visual streams.

The terminal uses the timing information to reconstruct synchronized playback.

In a variation, the terminal performs partial emotion analysis locally. The terminal computes coarse emotion indicators based on facial landmarks and voice energy and sends only compact emotion-state codes to the server. The server combines these codes with its own more detailed analysis. This offloading strategy reduces the amount of raw video and audio data transmitted, improving privacy and lowering network bandwidth requirements, while still allowing the server to maintain accurate emotion-conditioned generation.

In yet another embodiment, the system uses different neural network architectures as alternatives. The generative AI model may be implemented as a recurrent network with attention mechanisms instead of a transformer. The voice generation model may use a non-autoregressive architecture that predicts all acoustic frames simultaneously to speed up synthesis. The image generation model may employ a variational autoencoder structure combined with an adversarial discriminator. In each case, the server maintains the same logical operations: constructing prompt sentences, forming context vectors, and conditioning generation on subject attributes and user emotion states.

Through these embodiments, the server, the terminal, and the user interact in a way that configures and controls specific hardware and software components to achieve improved technical performance in multimodal dialogue generation. The system's design, including prompt sentence construction, context-driven model coordination, and feedback-based model refinement, provides concrete improvements in processing speed, generation accuracy, synchronization quality, and resource utilization within computer-based dialogue and media systems.

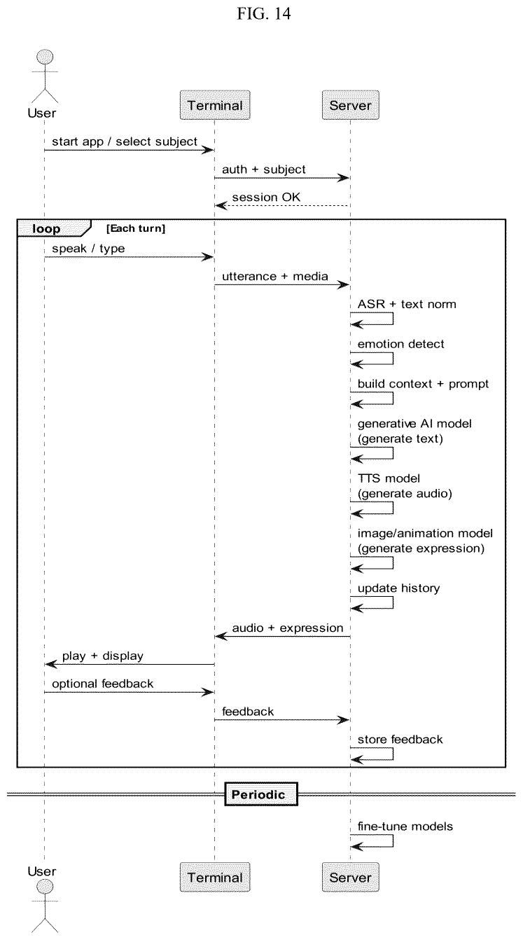

The following describes the processing flow using FIG. 14.

### Step 1:

User initializes a session on the terminal.

User launches an application on the terminal and selects a target subject profile. The input is user credentials and a selection command for the subject profile. The terminal transmits an authentication request and profile selection data to the server. The output is an authenticated session request including user ID and subject ID.

### Step 2:

Server establishes a dialogue session and loads models.

Server receives the authenticated session request as input and accesses a database to retrieve subject attribute information, pre-trained generative AI model parameters, voice generation model parameters, and image generation model parameters associated with the subject ID. Server loads these parameters into memory and allocates GPU resources. Server creates an empty dialogue history structure for the session. The output is an initialized session context containing subject attributes, loaded models, and an empty dialogue history.

### Step 3:

User provides initial utterance through the terminal.

User types or speaks a message addressed to the subject, such as “Grandpa, please tell me about our old trip to Hokkaido.” The input is raw text or audio captured by the terminal. The terminal, in the case of audio, may run local speech recognition to convert audio to text, or may send raw audio. The terminal packages the utterance together with a time stamp and session identifier and transmits it to the server. The output is a user utterance packet containing utterance text (or audio), time stamp, and session ID.

### Step 4:

Server normalizes user utterance and updates dialogue history.

Server receives the user utterance packet as input and, if necessary, performs automatic speech recognition to convert audio to text. Server applies text normalization (encoding normalization, punctuation cleanup, lowercasing while preserving semantic tokens) and tokenization. Server appends the normalized utterance and token sequence to the dialogue history structure in the session context. The output is an updated dialogue history including the new user utterance entry.

### Step 5:

Terminal captures user audio and image data for emotion estimation.

Terminal activates the microphone and camera while the user is speaking and interacting. The input is raw sensor data consisting of audio frames and image frames of the user. The terminal may perform lightweight preprocessing, such as downsampling and cropping, and then transmits the preprocessed frames or derived features (e.g., voice energy, basic facial landmarks) to the server with associated time stamps. The output is a user state packet containing audio and/or image data aligned with the utterance.

### Step 6:

Server estimates user emotion state.

Server receives the user state packet as input and extracts prosodic features (pitch contour, speaking rate, energy) from audio and visual features (facial action-unit intensities, eye openness, mouth curvature) from images. Server feeds these feature vectors into an emotion determination model, such as a neural classifier, which outputs emotion probabilities. Server selects a dominant emotion label (e.g., sadness, joy, calm) and stores this label and confidence score in the session context, associated with the current utterance. The output is an updated session context containing the estimated user emotion state.

### Step 7:

Server constructs context information and a prompt sentence.

Server takes as input the updated dialogue history, subject attribute information, and current user emotion state from the session context. Server selects a subset of recent turns, extracts key phrases, and composes a structured context object (subject role, recent utterances, user emotion). Server converts this context object into a textual prompt sentence. For example, server may generate:

“Act as the deceased grandfather. The user is currently sad. Use his characteristic warm, gentle tone and recall a shared memory from past family trips. User just said: ‘I feel tired today and I miss you.’ Respond in one or two sentences.”

Server tokenizes this prompt sentence for input to the generative AI model. The output is a tokenized prompt sentence and associated context tokens.

### Step 8:

Server generates a response sentence using the generative AI model.

Server supplies the tokenized prompt sentence and dialogue context tokens as input to the generative AI model loaded in GPU memory. The generative AI model performs matrix multiplications, self-attention operations, and non-linear activations layer by layer to compute a probability distribution over next tokens. Server repeatedly samples or selects tokens (e.g., using top-k or nucleus sampling) to construct a response sentence. Server then detokenizes the generated token sequence into human-readable text. The output is a response sentence that impersonates the subject's conversation style and is conditioned on the context.

### Step 9:

Server determines prosody control parameters for voice generation.

Server takes the response sentence and the current user emotion state as input. Server maps the emotion label to a set of prosody control parameters, such as base speaking rate, pitch range, volume level, and pause duration pattern. For example, for sadness the server selects slower rate and lower pitch variability; for joy the server selects faster rate and higher pitch range. Server attaches these parameters to the response sentence as control metadata. The output is a response specification consisting of response text and prosody parameters.

### Step 10:

Server generates audio information with the voice generation model.

Server receives the response specification as input and encodes the response text into phoneme or grapheme embeddings. Server feeds these embeddings and prosody parameters into the voice generation model encoder-decoder network to generate an acoustic representation such as a mel-spectrogram. Server then passes the acoustic representation and subject-specific speaker embedding to a vocoder network running on the GPU, which computes waveform samples through convolutional and non-linear layers. Server normalizes and encodes the waveform into an audio file format. The output is synthesized audio information that imitates the subject's voice and reflects the selected prosody.

### Step 11:

Server determines expression and motion parameters for visual generation.

Server takes the response sentence, user emotion state, and subject identity as input. Server selects an expression type (e.g., gentle smile, thoughtful expression) and computes motion parameters (lip-sync curves, head nod pattern, eye blink timing) based on phoneme timing and emotion. Server packages these parameters as a visual control vector. The output is a visual control vector specifying expression type and motion parameters.

### Step 12:

Server generates image or animation data with the image generation model.

Server supplies the visual control vector and subject identity embedding as input to the image generation model. For static output, server conditions a generator network to produce an aligned facial image that matches the expression type. For animated output, server either generates a sequence of facial frames or supplies motion parameters to a pre-rigged avatar system to compute per-frame blendshape weights. The server encodes the resulting frames as a video stream or as frame-by-frame animation data. The output is expression information in the form of image data or animation data representing the subject's face.

### Step 13:

Server packages multimodal response and updates dialogue history.

Server receives the synthesized audio information and expression information as input and associates them with the response sentence and current time stamp. Server adds a new entry to the dialogue history structure containing the user utterance information, the response sentence, the emotion state, and references to the generated audio and visual data. Server then constructs a response packet including audio data, visual data, timing metadata, and minimal context summary. The output is a multimodal response packet ready for transmission to the terminal.

### Step 14:

Server transmits the multimodal response to the terminal.

Server uses a communication interface to send the multimodal response packet as input data to the network stack. Server may compress audio and image/animation data and attach synchronization markers such as phoneme-to-time alignments. The network stack transmits the packet to the terminal associated with the session ID. The output is a received data stream at the terminal containing the multimodal response.

### Step 15:

Terminal renders synchronized audio and visual output.

Terminal receives the multimodal response packet as input and decodes the audio stream into a playback buffer and the image or animation data into renderable objects. Terminal uses the included timing metadata and phoneme alignment to synchronize avatar lip movements or frame display with the audio playback timeline. Terminal plays the audio through speakers or headphones and displays the static face, video, or avatar animation on the screen or head-mounted display. The output is a user-perceived virtual reply from the subject with coordinated voice and facial expression.

### Step 16:

User evaluates the interaction and optionally provides feedback.

User listens to and watches the rendered reply. Based on perceived quality, user may provide explicit evaluation information, such as pressing a rating button or entering a comment like “This really sounds like him” or “The expression is not accurate.” The input is a feedback signal or text sent from the terminal to the server. The output is an evaluation packet containing feedback data associated with the corresponding dialogue turn.

### Step 17:

Server records feedback and selects training candidates.

Server receives the evaluation packet as input and stores the feedback in association with the dialogue history entry. Server scans dialogue history entries and selects those with high or low evaluation scores as candidates for future fine-tuning. Server compiles a training set consisting of input context (prompt sentences, emotion states) and desired outputs (accepted response sentences, audio/visual patterns). The output is an updated learning information set containing annotated interaction examples.

### Step 18:

Server performs periodic fine-tuning of models.

Server takes the updated learning information set as input during scheduled maintenance intervals. Server constructs training batches that include context tokens, prompt sentences, and target outputs. For the generative AI model, server computes cross-entropy loss between generated and target tokens; for the voice generation model, server computes reconstruction loss on acoustic frames; for the image generation model, server computes reconstruction and adversarial losses on facial images or animation parameters. Server updates model weights using gradient descent until validation metrics improve or converge. The output is a new set of model parameters that refine conversation style, voice style, and expression style for future sessions.

### Step 19:

User continues the dialogue in subsequent turns.

User, after receiving one reply, may decide to ask follow-up questions or change topics. The input is new user utterance information captured by the terminal and sent to the server. The server, using the already enriched dialogue history and updated models, repeats the sequence of processing from context construction through multimodal response generation. The output at each iteration is a new, context-aware, emotion-conditioned multimodal reply, thereby maintaining an ongoing virtual conversation with improved coherence and realism.

The data generation model 58 is a so-called generative artificial intelligence (AI). Examples of the data generation model 58 include generative AIs such as ChatGPT (registered trademark) (Internet search <URL: https://openai.com/blog/chatgpt>) and the like. The data generation model 58 is obtained by performing deep learning with a neural network. The data generation model 58 is input with a prompt including an instruction, and is input with inference data such as audio data representing speech, text data representing text, image data representing images (for example, still image data or video data), and the like. The data generation model 58 takes the input inference data, performs inference according to the instruction indicated in the prompt, and outputs an inference result in one or more data format from out of audio data, text data, image data, or the like. The data generation model 58 includes, for example, a text generative AI, an image generative AI, a multimodal generative AI, or the like. Reference here to inference indicates, for example, analysis, classification, prediction, and/or abstraction etc. The specific processing unit 290 performs the specific processing referred to above while using the data generation model 58. The data generation model 58 may be a model fine-tuned so as to output an inference result from a prompt not including an instruction, and in such cases the data generation model 58 is able to output an inference result from the prompt not including an instruction. There are plural types of the data generation model 58 included in the data processing device 12 or the like, and the data generation models 58 include an AI other than a generative AI. An AI other than a generative AI is, for example, a linear regression, a logistic regression, a decision tree, a random forest, a support vector machine (SVM), a k-means clustering, a convolutional neural network (CNN), a recurrent neural network (RNN), a generative adversarial network (GAN), a naïve Bayes, or the like and is capable of performing various processing, however there is no limitation to such examples. The AI may be an AI agent. Moreover, when the processing of each of the units mentioned above is performed by an AI, this processing is partly or entirely performed by the AI, however there is no limitation to such examples. Moreover, processing executed by an AI including a generative AI may be switched to rule-based processing, and rule-based processing may be switched to processing executed by an AI including a generative AI.

Moreover, although the processing by the data processing system 10 described above was executed by the specific processing unit 290 of the data processing device 12 or by the control unit 46A of the smart device 14, the processing may be executed by a specific processing unit 290 of the data processing device 12 and a control unit 46A of the smart device 14. Moreover, the specific processing unit 290 of the data processing device 12 acquires and collects information needed for processing from the smart device 14 or from an external device or the like, and the smart device 14 acquires and collects information needed for processing from the data processing device 12 or from an external device or the like.

For example, a collection unit is implemented by the control unit 46A of the smart device 14 and/or by the specific processing unit 290 of the data processing device 12. For example, an acquisition unit acquires number-of-steps data using the camera 42 and/or the communication I/F 44 of the smart device 14, and the number-of-steps data is processed by the specific processing unit 290 of the data processing device 12. For example, an analysis unit implemented by the specific processing unit 290 of the data processing device 12 analyzes data from the collection unit and the acquisition unit. For example, a generation unit implemented by the specific processing unit 290 of the data processing device 12 generates a cooking menu using a generative AI. For example, a supply unit implemented by the output device 40 of the smart device 14 and/or the specific processing unit 290 of the data processing device 12 supplies the generated cooking menu to the user. Correspondence relationships of each unit to devices and control units are not limited to the examples described above, and various modifications thereof are possible.

The above exemplary embodiment gives an implementation example in which the specific processing is performed by the data processing device 12, however technology disclosed herein is not limited thereto, and the specific processing may be performed by the smart device 14.

### Second Exemplary Embodiment

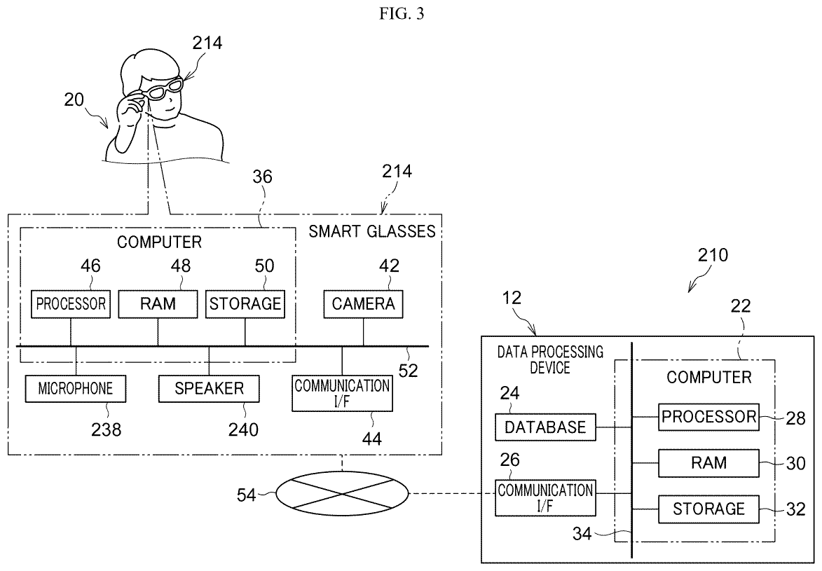

FIG. 3 illustrates an example of a configuration of a data processing system 210 according to a second exemplary embodiment.

As illustrated in FIG. 3, the data processing system 210 includes a data processing device 12 and smart glasses 214. A server is an example of the data processing device 12.

The data processing device 12 includes a computer 22, a database 24, and a communication I/F 26. The computer 22 is an example of a “computer” according to technology disclosed herein. The computer 22 includes a processor 28, RAM 30, and storage 32. The processor 28, the RAM 30, and the storage 32 are connected to a bus 34. The database 24 and the communication I/F 26 are also connected to the bus 34. The communication I/F 26 is connected to a network 54. Examples of the network 54 include a Wide Area Network (WAN) and/or a local area network (LAN).

The smart glasses 214 include a computer 36, a microphone 238, a speaker 240, a camera 42, and a communication I/F 44. The computer 36 includes a processor 46, RAM 48, and storage 50. The processor 46, the RAM 48, and the storage 50 are connected to a bus 52. The microphone 238, the speaker 240, the camera 42, and the communication I/F 44 are also connected to the bus 52.

The microphone 238 receives an instruction or the like from a user 20 by receiving speech uttered by the user 20. The microphone 238 captures the speech uttered by the user 20, converts the captured speech into audio data, and outputs the audio data to the processor 46. The speaker 240 outputs audio under instruction from the processor 46.

The camera 42 is a compact digital camera installed with an optical system such as a lens, an aperture, a shutter, and the like, and with an imaging device such as a complementary metal-oxide semiconductor (CMOS) image sensor or a charge coupled device (CCD) image sensor or the like. The camera 42 images the surroundings of the user 20 (for example, an imaging range defined by an angle of view equivalent to the width of visual field of an ordinary healthy subject).

The communication I/F 44 is connected to the network 54. The communication I/F 44 and the communication I/F 26 perform the role of exchanging various information between the processor 46 and the processor 28 over the network 54. The exchange of various information between the processor 46 and the processor 28 is performed in a secure state using the communication I/F 44 and the communication I/F 26.

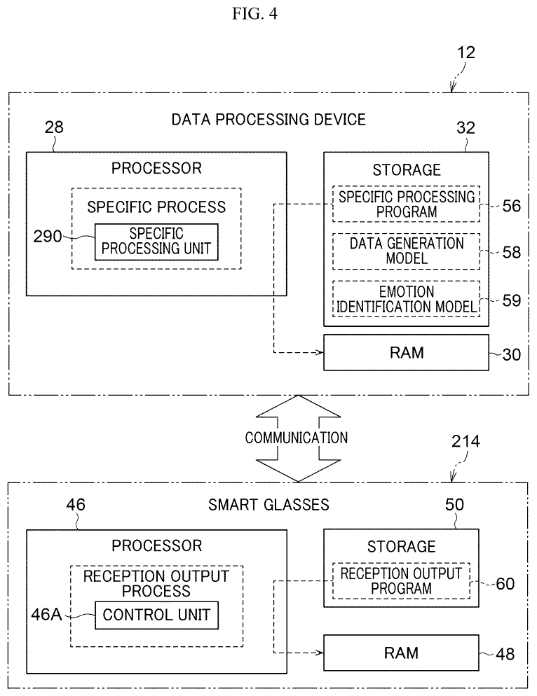

FIG. 4 illustrates an example of relevant functions of the data processing device 12 and the smart glasses 214. As illustrated in FIG. 4, specific processing is performed by the processor 28 in the data processing device 12. A specific processing program 56 is stored in the storage 32.

The specific processing program 56 is an example of a “program” according to technology disclosed herein. The processor 28 reads the specific processing program 56 from the storage 32, and in the RAM 30 executes the read specific processing program 56. The specific processing is implemented by the processor 28 operating as the specific processing unit 290 according to the specific processing program 56 executed in the RAM 30.

The data generation model 58 and the emotion identification model 59 are stored in the storage 32. The data generation model 58 and the emotion identification model 59 are employed by the specific processing unit 290. The specific processing unit 290 uses the emotion identification model 59 to estimate an emotion of a user, and is able to perform the specific processing using the user emotion. In an emotion estimation function (emotion identification function) that uses the emotion identification model 59, various estimations, predictions, and the like are performed related to emotions of the user, include estimating and predicting the emotion of the user, however, there is no limitation to such examples. Moreover, estimation and prediction of emotion also includes, for example, analyzing (parsing) emotions and the like.

Reception and output processing is performed by the processor 46 in the smart glasses 214. A reception and output program 60 is stored in the storage 50. The processor 46 reads the reception and output program 60 from the storage 50 and in the RAM 48 executes the read reception and output program 60. The reception and output processing is implemented by the processor 46 operating as the control unit 46A according to the reception and output program 60 executed in the RAM 48. Note that a configuration may be adopted in which the smart glasses 214 include a data generation model and an emotion identification model similar to the data generation model 58 and the emotion identification model 59, and processing similar to the specific processing unit 290 is performed using these models.

Next, description follows regarding the specific processing by the specific processing unit 290 of the data processing device 12. The units of the system described below are implemented by the data processing device 12 and the smart glasses 214. In the following description the data processing device 12 is called a “server”, and the smart glasses 214 is called a “terminal”.

### Example 1

Explanation of flow will be omitted due to being similar to a flow of the specific processing in Example 1 as described in the first exemplary embodiment above.

### Application Example 1

Explanation of flow will be omitted due to being similar to a flow of the specific processing in Application Example 1 as described in the first exemplary embodiment above.

### Example 2

Explanation of flow will be omitted due to being similar to a flow of the specific processing in Example 2 as described in the first exemplary embodiment above.

### Application Example 2

Explanation of flow will be omitted due to being similar to a flow of the specific processing in Application Example 2 as described in the first exemplary embodiment above.

The specific processing unit 290 transmits a result of the specific processing to the smart glasses 214. The control unit 46A in the smart glasses 214 outputs the specific processing result to the speaker 240. The microphone 238 acquires audio representing user input in response to the specific processing result. The control unit 46A transmits audio data representing the user input as acquired by the microphone 238 to the data processing device 12. The specific processing unit 290 in the data processing device 12 acquires the audio data.

The data generation model 58 is a so-called generative artificial intelligence (AI). Examples of the data generation model 58 include generative AIs such as ChatGPT (registered trademark) (Internet search <URL: https://openai.com/blog/chatgpt>) and the like. The data generation model 58 is obtained by performing deep learning with a neural network. The data generation model 58 is input with a prompt including an instruction, and is input with inference data such as audio data representing speech, text data representing text, image data representing images (for example, still image data or video data), and the like. The data generation model 58 takes the input inference data, performs inference according to the instruction indicated in the prompt, and outputs an inference result in one or more data format from out of audio data, text data, image data, or the like. The data generation model 58 includes, for example, a text generative AI, an image generative AI, a multimodal generative AI, or the like. Reference here to inference indicates, for example, analysis, classification, prediction, and/or abstraction etc. The specific processing unit 290 performs the specific processing referred to above while using the data generation model 58. The data generation model 58 may be a model fine-tuned so as to output an inference result from a prompt not including an instruction, and in such cases the data generation model 58 is able to output an inference result from the prompt not including an instruction. There are plural types of the data generation model 58 included in the data processing device 12 or the like, and the data generation models 58 include an AI other than a generative AI. An AI other than a generative AI is, for example, a linear regression, a logistic regression, a decision tree, a random forest, a support vector machine (SVM), a k-means clustering, a convolutional neural network (CNN), a recurrent neural network (RNN), a generative adversarial network (GAN), a naïve Bayes, or the like and is capable of performing various processing, however there is no limitation to such examples. The AI may be an AI agent. Moreover, when the processing of each of the units mentioned above is performed by an AI, this processing is partly or entirely performed by the AI, however there is no limitation to such examples. Moreover, processing executed by an AI including a generative AI may be switched to rule-based processing, and rule-based processing may be switched to processing executed by an AI including a generative AI.

Although the processing by the data processing system 10 described above is executed by the specific processing unit 290 of the data processing device 12 or by the control unit 46A of the smart glasses 214, the processing may be executed by a specific processing unit 290 of the data processing device 12 and a control unit 46A of the smart glasses 214. Moreover, the specific processing unit 290 of the data processing device 12 acquires and collects information needed for processing from the smart glasses 214 or from an external device or the like, and the smart glasses 214 acquires and collects information needed for processing from the data processing device 12 or from an external device or the like.

For example, the collection unit is implemented by the control unit 46A of the smart glasses 214 and/or by the specific processing unit 290 of the data processing device 12. For example, an acquisition unit acquires number-of-steps data using the camera 42 and/or the communication I/F 44 of the smart glasses 214, and the number-of-steps data is processed by the specific processing unit 290 of the data processing device 12. For example, an analysis unit implemented by the specific processing unit 290 of the data processing device 12 analyzes data from the collection unit and the acquisition unit. For example, a generation unit implemented by the specific processing unit 290 of the data processing device 12 generates a cooking menu using a generative AI. For example, a supply unit implemented by the speaker 240 of the smart glasses 214 and/or the specific processing unit 290 of the data processing device 12 supplies the generated cooking menu to the user. Correspondence relationships of each unit to devices and control units are not limited to the examples described above, and various modifications thereof are possible.

The above exemplary embodiment gives an implementation example in which the specific processing is performed by the data processing device 12, however technology disclosed herein is not limited thereto, and the specific processing may be performed by the smart glasses 214.

### Third Exemplary Embodiment

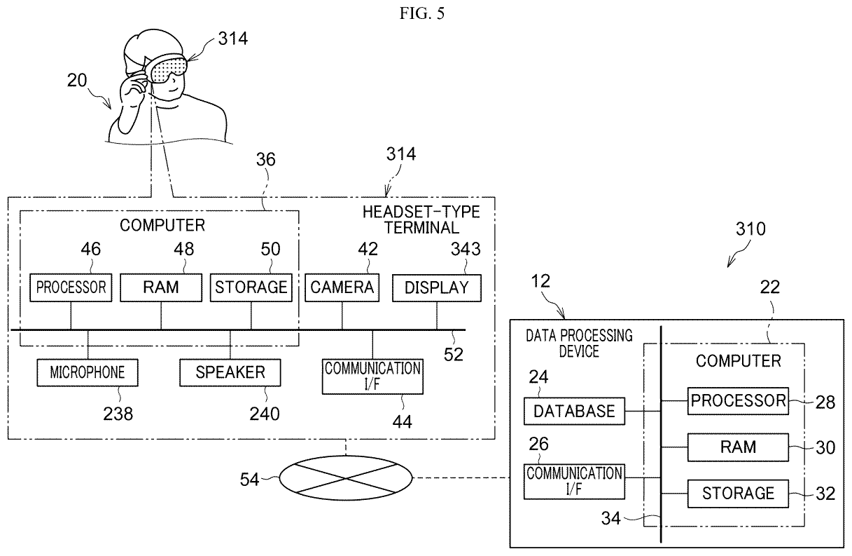

FIG. 5 illustrates an example of a configuration of a data processing system 310 according to a third exemplary embodiment.

As illustrated in FIG. 5, the data processing system 310 includes a data processing device 12 and a headset-type terminal 314. A server is an example of the data processing device 12.

The data processing device 12 includes a computer 22, a database 24, and a communication I/F 26. The computer 22 is an example of a “computer” according to technology disclosed herein. The computer 22 includes a processor 28, RAM 30, and storage 32. The processor 28, the RAM 30, and the storage 32 are connected to a bus 34. The database 24 and the communication I/F 26 are also connected to the bus 34. The communication I/F 26 is connected to a network 54. Examples of the network 54 include a Wide Area Network (WAN) and/or a local area network (LAN).

The headset-type terminal 314 includes a computer 36, a microphone 238, a speaker 240, a camera 42, a communication I/F 44, and a display 343. The computer 36 includes a processor 46, RAM 48, and storage 50. The processor 46, the RAM 48, and the storage 50 are connected to a bus 52. The microphone 238, the speaker 240, the camera 42, the display 343, and the communication I/F 44 are also connected to the bus 52.

The microphone 238 receives an instruction or the like from a user 20 by receiving speech uttered by the user 20. The microphone 238 captures the speech uttered by the user 20, converts the captured speech into audio data, and outputs the audio data to the processor 46. The speaker 240 outputs audio under instruction from the processor 46.

The camera 42 is a compact digital camera installed with an optical system such as a lens, an aperture, a shutter, and the like, and with an imaging device such as a complementary metal-oxide semiconductor (CMOS) image sensor or a charge coupled device (CCD) image sensor or the like. The camera 42 images the surroundings of the user 20 (for example, an imaging range defined by an angle of view equivalent to the width of visual field of an ordinary healthy subject).

The communication I/F 44 is connected to the network 54. The communication I/F 44 and the communication I/F 26 perform the role of exchanging various information between the processor 46 and the processor 28 over the network 54. The exchange of various information between the processor 46 and the processor 28 is performed in a secure state using the communication I/F 44 and the communication I/F 26.

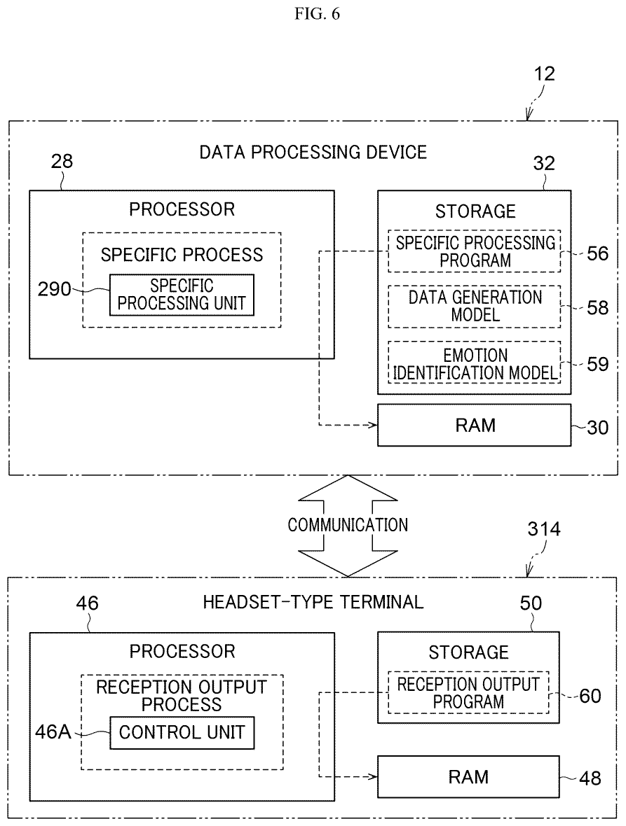

FIG. 6 illustrates an example of relevant functions of the data processing device 12 and the headset-type terminal 314. As illustrated in FIG. 6, specific processing is performed by the processor 28 in the data processing device 12. A specific processing program 56 is stored in the storage 32.

The specific processing program 56 is an example of a “program” according to technology disclosed herein. The processor 28 reads the specific processing program 56 from the storage 32, and in the RAM 30 executes the read specific processing program 56. The specific processing is implemented by the processor 28 operating as the specific processing unit 290 according to the specific processing program 56 executed in the RAM 30.

The data generation model 58 and the emotion identification model 59 are stored in the storage 32. The data generation model 58 and the emotion identification model 59 are employed by the specific processing unit 290.

Reception and output processing is performed by the processor 46 in the headset-type terminal 314. A reception and output program 60 is stored in the storage 50. The processor 46 reads the reception and output program 60 from the storage 50, and in the RAM 48 executes the read reception and output program 60. The reception and output processing is implemented by the processor 46 operating as the control unit 46A according to the reception and output program 60 executed in the RAM 48.

Next, description follows regarding the specific processing by the specific processing unit 290 of the data processing device 12. The units of the system described below are implemented by the data processing device 12 and the headset-type terminal 314. In the following description the data processing device 12 is called a “server”, and the headset-type terminal 314 is called a “terminal”.

### Example 1

Explanation of flow will be omitted due to being similar to a flow of the specific processing in Example 1 as described in the first exemplary embodiment above.

### Application Example 1

Explanation of flow will be omitted due to being similar to a flow of the specific processing in Application Example 1 as described in the first exemplary embodiment above.

### Example 2

Explanation of flow will be omitted due to being similar to a flow of the specific processing in Example 2 as described in the first exemplary embodiment above.

### Application Example 2

Explanation of flow will be omitted due to being similar to a flow of the specific processing in Application Example 2 as described in the first exemplary embodiment above.

The specific processing unit 290 transmits a result of the specific processing to the headset-type terminal 314. In the headset-type terminal 314, the control unit 46A outputs the result of the specific processing to the speaker 240 and the display 343. The microphone 238 acquires audio representing user input in response to the specific processing result. The control unit 46A transmits audio data representing the user input as acquired by the microphone 238 to the data processing device 12. The specific processing unit 290 in the data processing device 12 acquires the audio data.

The data generation model 58 is a so-called generative artificial intelligence (AI). Examples of the data generation model 58 include generative AIs such as ChatGPT (registered trademark) (Internet search <URL: https://openai.com/blog/chatgpt>) and the like. The data generation model 58 is obtained by performing deep learning with a neural network. The data generation model 58 is input with a prompt including an instruction, and is input with inference data such as audio data representing speech, text data representing text, image data representing images (for example, still image data or video data), and the like. The data generation model 58 takes the input inference data, performs inference according to the instruction indicated in the prompt, and outputs an inference result in one or more data format from out of audio data, text data, image data, or the like. The data generation model 58 includes, for example, a text generative AI, an image generative AI, a multimodal generative AI, or the like. Reference here to inference indicates, for example, analysis, classification, prediction, and/or abstraction etc. The specific processing unit 290 performs the specific processing referred to above while using the data generation model 58. The data generation model 58 may be a model fine-tuned so as to output an inference result from a prompt not including an instruction, and in such cases the data generation model 58 is able to output an inference result from the prompt not including an instruction. There are plural types of the data generation model 58 included in the data processing device 12 or the like, and the data generation models 58 include an AI other than a generative AI. An AI other than a generative AI is, for example, a linear regression, a logistic regression, a decision tree, a a naïve Bayes, or the like and is capable of performing various processing, however there is no limitation to such examples. The AI may be an AI agent. Moreover, when the processing of each of the units mentioned above is performed by an AI, this processing is partly or entirely performed by the AI, however there is no limitation to such examples. Moreover, processing executed by an AI including a generative AI may be switched to rule-based processing, and rule-based processing may be switched to processing executed by an AI including a generative AI.

Although the processing by the data processing system 10 described above is executed by the specific processing unit 290 of the data processing device 12 or by the control unit 46A of the headset-type terminal 314, the processing may be executed by a specific processing unit 290 of the data processing device 12 and a control unit 46A of the headset-type terminal 314. Moreover, the specific processing unit 290 of the data processing device 12 acquires and collects information needed for processing from the headset-type terminal 314 or from an external device or the like, and the headset-type terminal 314 acquires and collects information needed for processing from the data processing device 12 or from an external device or the like.

For example, the collection unit is implemented by the control unit 46A of the headset-type terminal 314 and/or by the specific processing unit 290 of the data processing device 12. For example, an acquisition unit acquires number-of-steps data using the camera 42 and/or the communication I/F 44 of the headset-type terminal 314, and the number-of-steps data is processed by the specific processing unit 290 of the data processing device 12. For example, an analysis unit implemented by the specific processing unit 290 of the data processing device 12 analyzes data from the collection unit and the acquisition unit. For example, a generation unit implemented by the specific processing unit 290 of the data processing device 12 generates a cooking menu using a generative AI. For example, a supply unit implemented by the speaker 240 and the display 343 of the headset-type terminal 314 and/or the specific processing unit 290 of the data processing device 12 supplies the generated cooking menu to the user. Correspondence relationships of each unit to devices and control units are not limited to the examples described above, and various modifications thereof are possible.

The above exemplary embodiment gives an implementation example in which the specific processing is performed by the data processing device 12, however technology disclosed herein is not limited thereto, and the specific processing may be performed by the headset-type terminal 314.

### Fourth Exemplary Embodiment

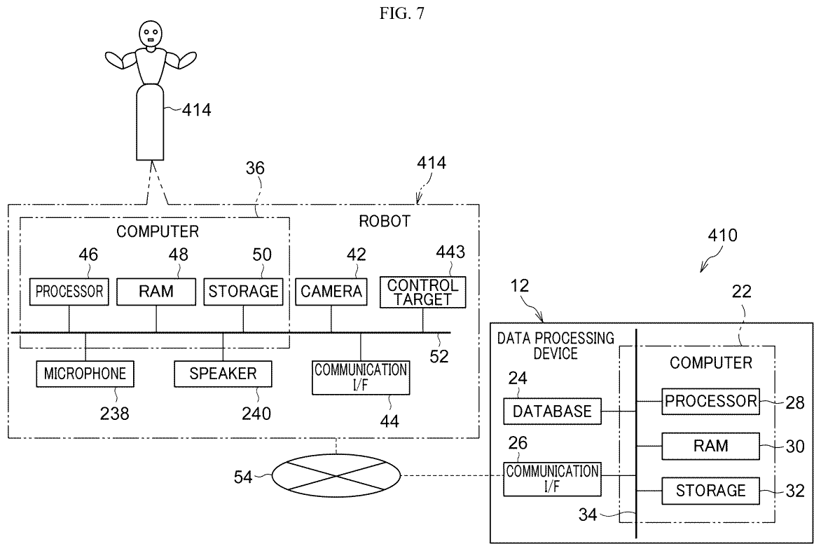

FIG. 7 illustrates an example of a configuration of a data processing system 410 according to a fourth exemplary embodiment

As illustrated in FIG. 7, the data processing system 410 includes a data processing device 12 and a robot 414. A server is an example of the data processing device 12.

The data processing device 12 includes a computer 22, a database 24, and a communication I/F 26. The computer 22 is an example of a “computer” according to technology disclosed herein. The computer 22 includes a processor 28, RAM 30, and storage 32. The processor 28, the RAM 30, and the storage 32 are connected to a bus 34. The database 24 and the communication I/F 26 are also connected to the bus 34. The communication I/F 26 is connected to a network 54. Examples of the network 54 include a Wide Area Network (WAN) and/or a local area network (LAN).

The robot 414 includes a computer 36, a microphone 238, a speaker 240, a camera 42, a communication I/F 44, and a control target 443. The computer 36 includes a processor 46, RAM 48, and storage 50. The processor 46, the RAM 48, and the storage 50 are connected to a bus 52. The microphone 238, the speaker 240, the camera 42, the control target 443, and the communication I/F 44 are also connected to the bus 52.

The microphone 238 receives an instruction or the like from a user 20 by receiving speech uttered by the user 20. The microphone 238 captures the speech uttered by the user 20, converts the captured speech into audio data, and outputs the audio data to the processor 46. The speaker 240 outputs audio under instruction from the processor 46.

The camera 42 is a compact digital camera installed with an optical system such as a lens, an aperture, a shutter, and the like, and with an imaging device such as a complementary metal-oxide semiconductor (CMOS) image sensor or a charge coupled device (CCD) image sensor or the like. The camera 42 images the surroundings of the robot 414 (for example, with an imaging range defined by an angle of view equivalent to the width of visual field of an ordinary healthy subject).

The communication I/F 44 is connected to the network 54. The communication I/F 44 and the communication I/F 26 perform the role of exchanging various information between the processor 46 and the processor 28 over the network 54. The exchange of various information between the processor 46 and the processor 28 is performed in a secure state using the communication I/F 44 and the communication I/F 26.

The control target 443 includes a display device, eye LEDs, and motors to drive arms, hands, feet, and the like. The posture and gesture of the robot 414 are controlled by controlling the motors of the arms, hands, feet, and the like. Part of an emotion of the robot 414 can be expressed by controlling these motors. Moreover, a facial expression of the robot 414 can be represented by controlling an illumination state of the eye LEDs of the robot 414.

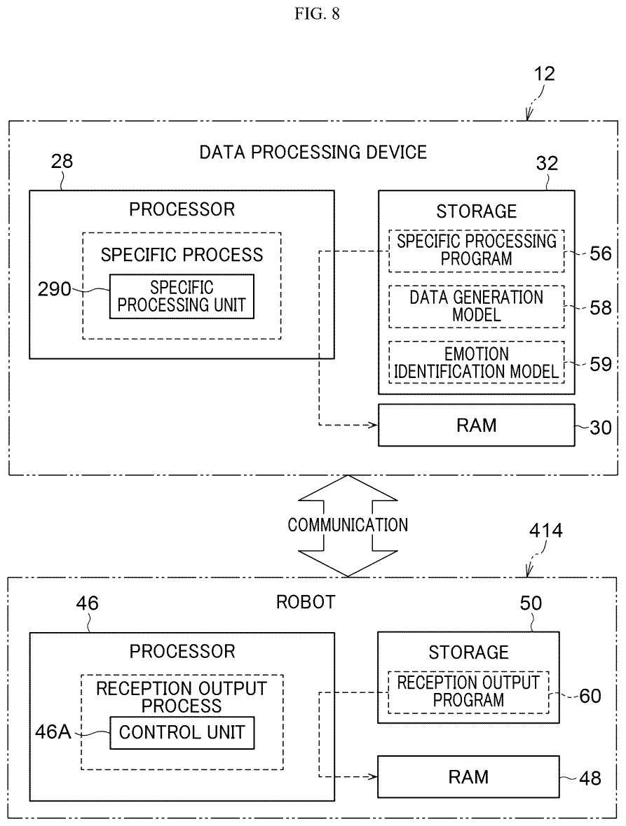

FIG. 8 illustrates an example of relevant functions of the data processing device 12 and the robot 414. As illustrated in FIG. 8, specific processing is performed by the processor 28 in the data processing device 12. A specific processing program 56 is stored in the storage 32.

The specific processing program 56 is an example of a “program” according to technology disclosed herein. The processor 28 reads the specific processing program 56 from the storage 32, and in the RAM 30 executes the read specific processing program 56. The specific processing is implemented by the processor 28 operating as the specific processing unit 290 according to the specific processing program 56 executed in the RAM 30.

The data generation model 58 and the emotion identification model 59 are stored in the storage 32. The data generation model 58 and the emotion identification model 59 are employed by the specific processing unit 290.

Reception and output processing is performed by the processor 46 in the robot 414. A reception and output program 60 is stored in the storage 50. The processor 46 reads the reception and output program 60 from the storage 50, and in the RAM 48 executes the read reception and output program 60. The reception and output processing is implemented by the processor 46 operating as the control unit 46A according to the reception and output program 60 executed in the RAM 48.

Next, description follows regarding the specific processing by the specific processing unit 290 of the data processing device 12. The units of the system described below are implemented by the data processing device 12 and the robot 414. In the following description the data processing device 12 is called a “server”, and the robot 414 is called a “terminal”.

### Example 1

Explanation of flow will be omitted due to being similar to a flow of the specific processing in Example 1 as described in the first exemplary embodiment above.

### Application Example 1

Explanation of flow will be omitted due to being similar to a flow of the specific processing in Application Example 1 as described in the first exemplary embodiment above.

### Example 2

Explanation of flow will be omitted due to being similar to a flow of the specific processing in Example 2 as described in the first exemplary embodiment above.

### Application Example 2

Explanation of flow will be omitted due to being similar to a flow of the specific processing in Application Example 2 as described in the first exemplary embodiment above.

The specific processing unit 290 transmits a result of the specific processing to the robot 414. In the robot 414, the control unit 46A outputs the result of the specific processing to the speaker 240 and the control target 443. The microphone 238 acquires audio representing user input in response to the specific processing result. The control unit 46A transmits audio data representing the user input as acquired by the microphone 238 to the data processing device 12. The specific processing unit 290 in the data processing device 12 acquires the audio data.

The data generation model 58 is a so-called generative artificial intelligence (AI). Examples of the data generation model 58 include generative AIs such as ChatGPT (registered trademark) (Internet search <URL: https://openai.com/blog/chatgpt>) and the like. The data generation model 58 is obtained by performing deep learning with a neural network. The data generation model 58 is input with a prompt including an instruction, and is input with inference data such as audio data representing speech, text data representing text, image data representing images (for example, still image data or video data), and the like. The data generation model 58 takes the input inference data, performs inference according to the instruction indicated in the prompt, and outputs an inference result in one or more data format from out of audio data, text data, image data, or the like. The data generation model 58 includes, for example, a text generative AI, an image generative AI, a multimodal generative AI, or the like. Reference here to inference indicates, for example, analysis, classification, prediction, and/or abstraction etc. The specific processing unit 290 performs the specific processing referred to above while using the data generation model 58. The data generation model 58 may be a model fine-tuned so as to output an inference result from a prompt not including an instruction, and in such cases the data generation model 58 is able to output an inference result from the prompt not including an instruction. There are plural types of the data generation model 58 included in the data processing device 12 or the like, and the data generation models 58 include an AI other than a generative AI. An AI other than a generative AI is, for example, a linear regression, a logistic regression, a decision tree, a a naïve Bayes, or the like and is capable of performing various processing, however there is no limitation to such examples. The AI may be an AI agent. Moreover, when the processing of each of the units mentioned above is performed by an AI, this processing is partly or entirely performed by the AI, however there is no limitation to such examples. Moreover, processing executed by an AI including a generative AI may be switched to rule-based processing, and rule-based processing may be switched to processing executed by an AI including a generative AI.

Although the processing by the data processing system 10 described above is executed by the specific processing unit 290 of the data processing device 12 or by the control unit 46A of the robot 414, the processing may be executed by a specific processing unit 290 of the data processing device 12 and a control unit 46A of the robot 414. Moreover, the specific processing unit 290 of the data processing device 12 acquires and collects information needed for processing from the robot 414 or from an external device or the like, and the robot 414 acquires and collects information needed for processing from the data processing device 12 or from an external device or the like.

For example, the collection unit is implemented by the control unit 46A of the robot 414 and/or by the specific processing unit 290 of the data processing device 12. For example, an acquisition unit acquires number-of-steps data using the camera 42 and/or the communication I/F 44 of the robot 414, and the number-of-steps data is processed by the specific processing unit 290 of the data processing device 12. For example, an analysis unit implemented by the specific processing unit 290 of the data processing device 12 analyzes data from the collection unit and the acquisition unit. For example, a generation unit implemented by the specific processing unit 290 of the data processing device 12 generates a cooking menu using a generative AI. For example, a supply unit implemented by the speaker 240 and the control target 443 of the robot 414 and/or the specific processing unit 290 of the data processing device 12 supplies the generated cooking menu to the user. Correspondence relationships of each unit to devices and control units are not limited to the examples described above, and various modifications thereof are possible.

The above exemplary embodiment gives an implementation example in which the specific processing is performed by the data processing device 12, however technology disclosed herein is not limited thereto, and the specific processing may be performed by the robot 414.

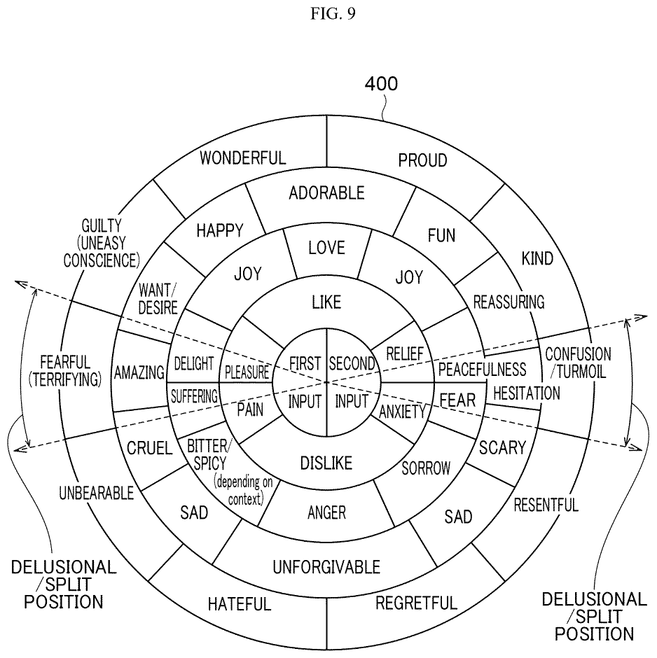

Note that the emotion identification model 59 serves as an emotion engine, and may decide the emotion of a user according to a specific mapping. Specifically, the emotion identification model 59 may decide the emotion of a user according to an emotion map (see FIG. 9) that is a specific mapping. Moreover, the emotion identification model 59 may also decide the emotion of the robot similarly, and the specific processing unit 290 may be configured so as to perform the specific processing using the emotion of the robot.

FIG. 9 is a diagram illustrating an emotion map 400 mapping plural emotions. In the emotion map 400, emotions are arranged in concentric circles that radiate out from the center. Primitive states of emotion are arranged nearer to the center of the concentric circles. Emotions expressing states and actions generated from states of mind are arranged further toward the outside of the concentric circles. Emotions are defined as including both affect and mental states. Emotions generated from reactions occurring in the brain are generally arranged at the left side of the concentric circles. Emotions induced by situational assessment are generally arranged at the right side of the concentric circles. Emotions generated from reactions occurring in the brain that are also emotions induced by situational assessment are generally arranged toward the top and toward the bottom of the concentric circles. Moreover, emotions of “euphoria” are arranged at the upper side of the concentric circles, and emotions of “dysphoria” are arranged at the lower side of the concentric circles. Plural emotions are accordingly mapped in this manner in the emotion map 400 based on a structure giving rise to emotions, and emotions that readily occur at the same time are mapped close to each other.

An example of such emotions is a distribution of emotions in the direction of 3 o'clock on the emotion map 400, generally around a boundary between relief and anxiety. Situational awareness dominates over internal sensations in the right half of the emotion map 400, with an impression of calm.

The inside of the emotion map 400 represents feelings, and the outside of the emotion map 400 represents actions, and so emotions further toward the outside of the emotion map 400 are more visible (are expressed by actions).

Human emotions are based on various balances, such as posture and blood sugar value balances, with a state of dysphoria being exhibited when these balances are far from ideal and a state of euphoria being exhibited when these balances are near to ideal. Even in a robot, a car, a motorbike, or the like, emotions can be thought of as being based on various balances such as orientation and remaining battery balances, with a state called dysphoria being exhibited when these balances are far from ideal and a state called euphoria being exhibited when these balances are near to ideal. An emotion map may, for example, be generated based on the emotion map of Dr. Mitsuyoshi (PhD Dissertation https://ci.nii.ac.jp/naid/500000375379: “Research on the phonetic recognition of feelings and a system for emotional physiological brain signal analysis”, Tokushima University). Emotions belonging to an area called “reaction” where feeling dominates are arranged in the left half of the emotion map. Moreover, emotions belonging to an area called “situation” where situational awareness dominates are arranged in the right half of the emotion map.

There are two types of emotion that facilitate leaning in an emotion map. One is an emotion in the vicinity of the center of negative “penitence” and “reflection” on the situational side. In other words, sometimes a negative “emotion” such as “I don't want to feel this way ever again” and “I don't want to be chided again” is experienced in a robot. Another is a positive emotion in the area of “desire” on the reaction side. In other words, there are times when a positive feeling such as “desire more” and “want to know more” is experienced.

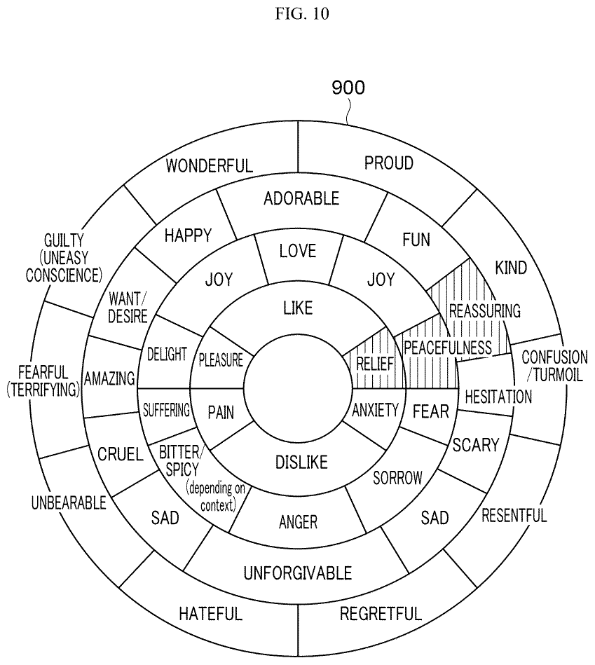

In the emotion identification model 59, user input is input to a pre-trained neural network, and emotion values indicating emotions shown on the emotion map 400 are acquired and the emotions of the user are decided. This neural network is pre-trained based on plural training data sets that each combine a user input with an emotion value indicating an emotion shown on the emotion map 400. The neural network is also trained such that emotions arranged close to each other have values that are close to each other, as in an emotion map 900 illustrated in FIG. 10. In FIG. 10 the plural emotions of “relief”, “peaceful”, and “reassured” are indicated as an example of close emotion values.

Although the system according to the present disclosure has been described mainly as functions of the data processing device 12, the system according to the present disclosure is not limited to being implemented in a server. The system according to the present disclosure may be implemented as a general information processing system. The present disclosure may, for example, be implemented by a software program operating on a personal computer, and may be implemented by an application operating on a smartphone or the like. The method according to the present disclosure may also be supplied to a user in the form of Software as a Service (SaaS).

Although in the exemplary embodiments described above examples are given of embodiments in which the specific processing is performed by a single computer 22, technology disclosed herein is not limited thereto, and distributed processing may be performed for the specific processing, with the specific processing distributed across plural computers including the computer 22. For example, the data generation model 58 may be provided in a device external to the data processing device 12, such that data generation in response to input data is performed in the external device.

Although in the exemplary embodiments described above examples are described of embodiments in which the specific processing program 56 is stored in the storage 32, the technology disclosed herein is not limited thereto. For example, the specific processing program 56 may be stored on a portable, non-transitory, computer readable, storage medium, such as universal serial bus (USB) memory or the like. The specific processing program 56 stored on the non-transitory storage medium is then installed on the computer 22 of the data processing device 12. The processor 28 then executes the specific processing according to the specific processing program 56.

Moreover, the specific processing program 56 may be stored on a storage device, such as a server connected to the data processing device 12 over the network 54, with the specific processing program 56 then being downloaded in response to a request from the data processing device 12 and installed on the computer 22.

Note that there is no need to store the entire specific processing program 56 on the storage device, such as a server connected to the data processing device 12 over the network 54, or to store the entire specific processing program 56 on the storage 32, and part of the specific processing program 56 may be stored thereon.

Hardware resources for executing the specific processing may use various processors as listed below. Examples of processors include, for example, a CPU that is a general-purpose processor that functions as a hardware resource to execute the specific processing by executing software, namely a program. Moreover, the processor may, for example, be a dedicated electronic circuit that is a processor having a circuit configuration custom designed for executing the specific processing, such as a field-programmable gate array (FPGA), a programmable logic device (PLD), or an application specific integrated circuit (ASIC). Memory is inbuilt or connected to each of these processors, and the specific processing is executed by each of these processors using the memory.

The hardware resource that executes the specific processing may be configured from one of these various processors, or may be configured from a combination of two or more processors of the same or different type (for example, a combination of plural FPGAs, or a combination of a CPU and a FPGA). The hardware resource executing the specific processing may be a single processor.

Examples of configurations of a single processor include, firstly, a configuration of a single processor resulting from combining one or more CPU and software, in an embodiment in which this processor functions as the hardware resource for executing the specific processing. Secondly, as typified by a System-on-chip (SOC) or the like, there is also an embodiment that uses a processor realized by a single IC chip to function as an overall system including plural hardware resources for executing the specific processing. Adopting such an approach means that the specific processing is realized using one or more of the various processors described above as hardware resource.

Furthermore, more specifically, an electrical circuit that combines circuit elements such as semiconductor elements or the like may be employed as a hardware structure of these various processors. The specific processing is merely an example thereof. This means that obviously redundant steps may be omitted, new steps may be added, and the processing sequence may be swapped around within a range not departing from the spirit of the present disclosure.

The described content and drawing content illustrated above are a detailed description of parts according to the present disclosure, and are merely examples of the present disclosure. For example, description related to the above configuration, function, operation, and advantageous effects is a description related to examples of the configuration, function, operation, and advantageous effects of parts according to the present disclosure. This means that obviously redundant parts may be eliminated, new elements may be added, and switching around may be performed on the described content and drawing content illustrated above within a range not departing from the spirit of the present disclosure. Moreover, to avoid misunderstanding and to facilitate understanding of parts according to the present disclosure, description related to common knowledge in the art and the like not particularly needing description to enable implementation of the present disclosure is omitted in the described content and drawing content illustrated as described above.

All publications, patent applications and technical standards mentioned in the present specification are incorporated by reference in the present specification to the same extent as if each individual publication, patent application, or technical standard was specifically and individually indicated to be incorporated by reference.

Note that, regarding the above description, the following supplementary notes are further disclosed.

### Example 1

### (Supplementary 1)

A system comprising a processor,
wherein the processor is configured to
store personal-related information in an internal storage of an information processing environment, manage the personal-related information in an encrypted form, and construct a training dataset for generative use based on the personal-related information,
extract speech segments of a subject from acoustic information and video information included in the personal-related information, convert the speech segments into acoustic feature data, learn or adapt a speech synthesis generative model based on the acoustic feature data and corresponding character data, and store the speech synthesis generative model in association with the subject,
extract utterance history of the subject from character string information included in the personal-related information, convert the utterance history into token sequences, generate a training dataset in which an input sequence including dialog history is associated with a response sequence by the subject, and learn or adapt a language generation generative model that imitates a conversational style of the subject based on the training dataset,
construct an input sequence to the language generation generative model based on dialog history including a prompt sentence input from a terminal, and execute the language generation generative model so as to generate utterance text of the subject in response to the prompt sentence,
normalize the utterance text generated by the language generation generative model into a speech synthesis input sequence, generate audio waveform data based on speech characteristics of the subject by using the speech synthesis generative model, compress the audio waveform data, and transmit the compressed audio waveform data to the terminal, extract phoneme timing information and intensity information from the audio waveform data in order to generate mouth-shape information and facial-expression information corresponding to the audio waveform data, and generate a display motion parameter sequence based on the phoneme timing information and the intensity information, and
generate and transmit response data to provide a dialog experience with the subject to a user, by causing the terminal to reproduce the audio waveform data and the display motion parameter sequence.

### (Supplementary 2)

The system according to supplementary 1,
wherein the processor is configured to
store the dialog history based on a conversation session identification information, sequentially generate additional responses of the subject for each prompt sentence while updating context information to be input to the language generation generative model by reusing the dialog history, and perform continuous dialog for a plurality of prompt sentences from the user.

### (Supplementary 3)

The system according to supplementary 1,
wherein the processor is configured to
exclude information of speakers other than the subject by performing speaker separation processing on the acoustic information, the video information, and the character string information acquired as the personal-related information, and learn or adapt the speech synthesis generative model and the language generation generative model using only the acoustic feature data and the utterance history corresponding to the subject.

### Application Example 1

### (Supplementary 1)

A system comprising a processor,
wherein the processor is configured to
construct, by using data processing resources within an information processing apparatus, a generative information processing environment including a generative AI model as a generative information generation mechanism, input a training information set including personal-related information and a control prompt sentence into the generative AI model so as to generate personal-related information associated with a deceased person, store the generated personal-related information in a storage apparatus for recorded information, and use the stored personal-related information as reference information for dialogue generation processing,
analyze, by using a voice synthesis mechanism as an audio information processing mechanism, audio information associated with the deceased person and extracted from visual information, generate speaker characteristic information of the deceased person based on an analysis result, and generate audio data that reproduces speech of the deceased person on the basis of dialogue text data output from the generative AI model and the speaker characteristic information,
analyze, by using an image processing mechanism as an image information processing mechanism, image information associated with the deceased person, calculate contour point information of a face region based on phoneme information or viseme information associated with the audio data, and generate motion image information in which an expression change corresponding to the contour point information is applied,
manage a dialogue by using a dialogue management mechanism to analyze instruction text data received from a user terminal as a prompt sentence, retrieve, from a storage apparatus for personal-related information, past dialogue content information semantically related to the prompt sentence, integrate the retrieved dialogue content information as context information for input to the generative AI model together with the prompt sentence, and cause generation of response text data that imitates a conversation style of the deceased person, and execute communication processing by using a communication processing mechanism to transmit the audio data and the motion image information generated based on the response text data to the user terminal and to cause the user terminal to present a virtual dialogue with the deceased person as visual information and auditory information.

### (Supplementary 2)

The system according to supplementary 1,
wherein the processor is configured to cause the dialogue management mechanism to generate embedding vectors that map past dialogue content information associated with the deceased person and obtained from visual information or a communication application into a semantic representation space, register the embedding vectors in a similarity search mechanism as indices, select dialogue history information based on similarity between the embedding vectors and an embedding vector associated with the prompt sentence, and append the selected dialogue history information as context information to be input to the generative AI model so as to cause learning of conversation patterns of the deceased person.

### (Supplementary 3)

The system according to supplementary 1,
wherein the processor is configured to cause the communication processing mechanism to perform network communication with the user terminal as a mobile information processing apparatus or a head-mounted display apparatus, input the prompt sentence received from the user terminal into the generative AI model, and sequentially or collectively transmit, to the user terminal, the response text data output from the generative AI model, the audio data generated by the voice synthesis mechanism, and the motion image information generated by the image processing mechanism, thereby realizing continuous virtual dialogue in accordance with multiple prompt sentence inputs.

### Example 2

### (Supplementary 1)

A system comprising a processor,
wherein the processor is configured to
acquire individual information of a subject individual in an internal storage, construct a generative artificial intelligence environment based on the individual information, and execute a natural language processing program to generate a text information set from the individual information,
perform word segmentation processing, irrelevant term removal processing, and word form normalization processing on the text information set by using a language processing library, and generate a training text information set as preprocessed text information, input the training text information set to a generative AI model, fine-tune the generative AI model so as to reproduce a phrase pattern and a writing style pattern specific to the subject individual, and store the fine-tuned generative AI model and corresponding encoding information in a storage unit,
acquire audio data of the subject individual from video information or audio information, execute an audio processing program to extract acoustic feature data from the audio data, generate speaker feature data representing a speaker characteristic of the subject individual, and construct a speech synthesis model that is configured to generate an audio waveform from text information by using the speaker feature data,
acquire face image data of the subject individual from image information or moving image information, execute an image processing program to extract facial feature position data from the face image data, generate expression feature data indicating an expression state, and construct an expression reproduction model that is configured to control an expression state of a face image or a virtual image by using the expression feature data,
receive, from a user terminal, a prompt sentence including an instruction sentence input by a user, generate model input information by combining the prompt sentence with dialogue history information, and input the model input information to the generative AI model to generate response text information that imitates a conversation style of the subject individual, input the response text information and the speaker feature data to the speech synthesis model to generate response audio data that imitates an audio style of the subject individual, control the expression reproduction model based on an emotional state or a content type of the response text information to generate expression control information or virtual image data that imitates an expression style of the subject individual, and
transmit the response text information, the response audio data, and the expression control information or the virtual image data to the user terminal so that the user terminal reproduces a dialogue with the subject individual.

### (Supplementary 2)

The system according to supplementary 1,
wherein the processor is configured to
include conversation information acquired from video information, communication history information, or a communication application in the text information set, generate learning control information for learning a conversation pattern and a response tendency of the subject individual by using the conversation information, and execute a learning process on the generative AI model by setting learning conditions of the generative AI model based on the learning control information.

### (Supplementary 3)

The system according to supplementary 1,
wherein the processor is configured to
input the instruction sentence input by the user as the prompt sentence to the generative AI model, generate a dialogue response by adding the dialogue history information and characteristic phrase information of the subject individual when generating the response text information, and sequentially generate the response audio data and the expression control information based on the generated dialogue response.

### Application Example 2

### (Supplementary 1)

A system comprising a processor,
wherein the processor is configured to
store person-related information in an internal generative processing environment, control storage and reference of learning information generated or updated by a generative AI model, and input a prompt sentence to the generative AI model to instruct generation or update of the learning information based on the person-related information,
analyze subject voice information included in recorded media by using audio processing technology, generate feature information and character-string information corresponding to the subject voice information, generate a prompt sentence for causing a generative AI model or a voice generation model to learn a correspondence between the feature information and the character-string information, and control the generative AI model or the voice generation model to generate audio information that imitates a voice style of the subject based on the prompt sentence,
analyze subject image information included in recorded media by using image processing technology, extract feature information and expression-state information relating to a face portion of the subject, generate a prompt sentence for instructing an image generation process to reproduce the expression-state information by a generative AI model or an image generation model, and control the generative AI model or the image generation model to generate image information or video information in which an expression of the subject is reproduced based on the prompt sentence,
in a dialogue process, receive user utterance information from a user terminal, generate context information including attribute information of the subject, dialogue history information, and user emotion-state information based on the user utterance information and the dialogue history information, generate a prompt sentence including the context information, input the prompt sentence to the generative AI model to cause generation of a response sentence in which the subject is impersonated, and control output of audio information and expression information by associating the generated response sentence with the voice generation model and the image generation model,
acquire user audio information and user image information, estimate a user emotion state by using an emotion determination model, and dynamically adjust prosody, speed, and volume in the voice generation model and expression type and motion parameters in the image generation model according to the estimated user emotion state, and
record, for each dialogue session, the user utterance information, the response sentence, the emotion state, and the generated audio information and expression information as dialogue history information, and perform generation of the prompt sentence and learning or fine-tuning of the generative AI model, the voice generation model, and the image generation model by using the dialogue history information.

### (Supplementary 2)

The system according to supplementary 1,
wherein the processor is configured to
obtain user input information and user state information from a portable information terminal or a head-mounted display via communication processing, control real-time distribution of a virtual dialogue presentation based on the generated audio information and the expression information to the portable information terminal or the head-mounted display, and cause the portable information terminal or the head-mounted display to function as a user interface that presents the audio information and the expression information in a synchronized manner.

### (Supplementary 3)

The system according to supplementary 1,
wherein the processor is configured to
obtain evaluation information and additional learning information from a user, select output results of the generative AI model, the voice generation model, and the image generation model based on the evaluation information, and update parameters of the models by using the selected output results and the additional learning information so as to continuously improve reproduction accuracy of a conversation style, a voice style, and an expression style of the subject.

What is claimed is:

1. A system comprising:
circuitry configured to:
store personal-related data in an internal information processing environment, encrypt and manage the personal-related data, and construct training datasets for generative model learning based on the personal-related data;
extract subject-specific speech segments from acoustic data and video data included in the personal-related data, convert the speech segments into acoustic feature data, and train or adapt a speech synthesis model based on the acoustic feature data so that the speech synthesis model is associated with a subject;
extract an utterance history of the subject from character string data included in the personal-related data, convert the utterance history into token sequences, generate training data associating dialog-history-inclusive input sequences with subject response sequences, and train or adapt a language generation model to imitate a conversational style of the subject based on the training data;
receive, via a communication interface coupled to a packet-switched network, a prompt sentence from a terminal device, construct an input sequence for the language generation model based on dialog history data including the prompt sentence and session identification data, and execute the language generation model to generate utterance text; and
normalize the utterance text into a speech synthesis input sequence, generate audio waveform data based on speech characteristics of the subject using the speech synthesis model, extract phoneme timing data and intensity data from the audio waveform data, generate display motion parameter sequences comprising mouth-shape data and facial expression data synchronized with the audio waveform data, and transmit response data comprising the audio waveform data and the display motion parameter sequences to the terminal device.

2. The system according to claim 1, wherein the circuitry is configured to apply a speaker separation algorithm to the acoustic data, the video data, and the character string data to isolate subject-specific acoustic segments and utterance records, and exclude data associated with speakers other than the subject prior to training or adapting the speech synthesis model and the language generation model.

3. The system according to claim 2, wherein the circuitry is configured to apply a mel-frequency cepstral coefficient extraction algorithm to the subject-specific acoustic segments to generate acoustic feature vectors, apply a voice conversion model to the acoustic feature vectors to generate normalized acoustic feature data, and use the normalized acoustic feature data as training input for the speech synthesis model.

4. The system according to claim 3, wherein the circuitry is configured to apply a subword tokenizer to the utterance history to generate the token sequences, construct dialog-history-inclusive input sequences by concatenating a dialog history prefix with a current utterance token sequence, associate each dialog-history-inclusive input sequence with a corresponding subject response sequence, and train the language generation model using the constructed training data pairs.

5. The system according to claim 4, wherein the circuitry is configured to construct the input sequence for the language generation model by prepending a dialog history comprising prior prompt sentences and prior utterance texts to a current prompt sentence, truncate the dialog history to a maximum context length, and encode the input sequence using the subword tokenizer prior to executing the language generation model.

6. The system according to claim 1, wherein the circuitry is configured to apply an image analysis algorithm to image data included in the personal-related data to extract facial landmark data and expression parameter data of the subject, generate facial motion profile data from the extracted facial landmark data and expression parameter data, and use the facial motion profile data to generate the display motion parameter sequences synchronized with the audio waveform data.

7. The system according to claim 6, wherein the circuitry is configured to generate a prompt sentence specifying instructions for a generative neural network model to reproduce facial expression data based on the facial motion profile data, input the prompt sentence to the generative neural network model, and receive facial expression animation data from the generative neural network model for incorporation into the display motion parameter sequences.

8. The system according to claim 7, wherein the circuitry is configured to apply a face synthesis model to the facial expression animation data to generate a frame sequence depicting the facial expression of the subject, encode the frame sequence into a video data format, and transmit the video data together with the audio waveform data to the terminal device for synchronized playback.

9. The system according to claim 1, wherein the circuitry is configured to generate a first prompt sentence specifying instructions for a generative neural network model to analyze conversation content data of the subject acquired from the personal-related data, input the first prompt sentence to the generative neural network model to identify conversation pattern data, and use the conversation pattern data as additional training input for the language generation model.

10. The system according to claim 9, wherein the circuitry is configured to generate a second prompt sentence specifying instructions for the generative neural network model to generate a response in a conversational style consistent with the identified conversation pattern data, input the second prompt sentence together with a received prompt sentence from the terminal device to the generative neural network model, and receive a generated response for transmission to the terminal device.

11. The system according to claim 1, wherein the circuitry is configured to compress the audio waveform data using an audio compression algorithm prior to transmission to the terminal device, and decompress the audio waveform data at the terminal device prior to playback.

12. The system according to claim 11, wherein the circuitry is configured to apply a perceptual audio codec to the audio waveform data to generate a compressed audio stream, embed synchronization markers aligned with phoneme boundary data into the compressed audio stream, and transmit the compressed audio stream with the embedded synchronization markers to the terminal device.

13. The system according to claim 1, wherein the circuitry is configured to encrypt the personal-related data using a symmetric encryption algorithm and store an encryption key in a key management module isolated from the storage device, and apply the encryption key to decrypt the personal-related data only during execution of model training or inference processes.

14. The system according to claim 13, wherein the circuitry is configured to log access events to the personal-related data in an audit log stored in the storage device, and generate an access report from the audit log for transmission to a designated management terminal upon request.

15. The system according to claim 1, wherein the circuitry is configured to receive session identification data from the terminal device, associate the session identification data with dialog history data comprising prior prompt sentences and prior utterance texts, store the dialog history data in the storage device, and use the stored dialog history data as context in constructing the input sequence for the language generation model.

16. The system according to claim 15, wherein the circuitry is configured to detect a dialog termination signal from the terminal device, archive the dialog history data associated with the session identification data in the storage device, and apply an anomaly detection algorithm to the archived dialog history data to identify interaction patterns deviating from the conversational style of the subject.

17. The system according to claim 1, wherein the circuitry is configured to receive updated personal-related data from the terminal device, apply the speaker separation algorithm to the updated personal-related data to extract updated subject-specific segments, generate updated training data from the updated subject-specific segments, and perform incremental training of at least one of the speech synthesis model or the language generation model using the updated training data.

18. A system comprising:
circuitry configured to:
store personal-related data in an internal information processing environment, extract subject-specific speech segments from acoustic data and video data included in the personal-related data, convert the speech segments into acoustic feature data, and train a speech synthesis model based on the acoustic feature data;
extract an utterance history from character string data included in the personal-related data, generate dialog-history-inclusive training data pairs from the utterance history, and train a language generation model to imitate a conversational style of a subject based on the training data pairs;
receive, via a communication interface coupled to a packet-switched network, a prompt sentence from a terminal device, construct an input sequence incorporating dialog history data and the prompt sentence, execute the language generation model to generate utterance text, and generate audio waveform data from the utterance text using the speech synthesis model; and
extract phoneme timing data and intensity data from the audio waveform data, generate display motion parameter sequences comprising mouth-shape data and facial expression data synchronized with the audio waveform data, and transmit response data comprising the audio waveform data and the display motion parameter sequences to the terminal device.

19. The system according to claim 18, wherein the circuitry is configured to apply a speaker separation algorithm to the acoustic data, the video data, and the character string data to isolate subject-specific data prior to training the speech synthesis model and the language generation model, and exclude data associated with speakers other than the subject.

20. A method performed by circuitry, the method comprising:
storing personal-related data in an internal information processing environment, encrypting and managing the personal-related data, and constructing training datasets for generative model learning based on the personal-related data;
extracting subject-specific speech segments from acoustic data and video data included in the personal-related data, converting the speech segments into acoustic feature data, and training or adapting a speech synthesis model based on the acoustic feature data so that the speech synthesis model is associated with a subject;
extracting an utterance history of the subject from character string data included in the personal-related data, converting the utterance history into token sequences, generating training data associating dialog-history-inclusive input sequences with subject response sequences, and training or adapting a language generation model to imitate a conversational style of the subject based on the training data;
receiving, via a communication interface coupled to a packet-switched network, a prompt sentence from a terminal device, constructing an input sequence for the language generation model based on dialog history data including the prompt sentence and session identification data, and executing the language generation model to generate utterance text; and
normalizing the utterance text into a speech synthesis input sequence, generating audio waveform data based on speech characteristics of the subject using the speech synthesis model, extracting phoneme timing data and intensity data from the audio waveform data, generating display motion parameter sequences comprising mouth-shape data and facial expression data synchronized with the audio waveform data, and transmitting response data comprising the audio waveform data and the display motion parameter sequences to the terminal device.
